(19) United States
(12) Patent Application Publication
(10) Pub. No.: US 2017/0199631 A1
(43) Pub. Date: Jul. 13, 2017

(54) Devices, Methods, and Graphical User Interfaces for Enabling Display Management of Participant Devices

(71) Applicant: Apple Inc., Cupertino, CA (US)

(72) Inventors: Patrick Lee Coffman, San Francisco, CA (US); Andreas W. Wendker, Woodside, CA (US); Todd Robert Fernandez, Mountain View, CA (US); Mark William Whittemore, Los Altos, CA (US); Maxwell Oliver Drukman, San Francisco, CA (US)

(21) Appl. No.: 15/273,345

(22) Filed: Sep. 22, 2016

Related U.S. Application Data
(60) Provisional application No. 62/276,856, filed on Jan. 9, 2016.

(51) Int. Cl. G06F 3/0482; G09B 5/06; G06F 3/0488; G06F 3/14; G06F 3/0484

(52) U.S. Cl. CPC G06F 3/0482; G06F 3/1423; G06F 3/0484; G06F 3/04883; G09B 5/065

(57) ABSTRACT

A method includes receiving a request to display device status information for participant devices corresponding to participants in a group included on a roster, wherein a participant in the group is associated with a participant device. In response to receiving the request to display the device status information for the participant devices, displaying, respective graphical representations that include respective device status indicators for a respective set of the participants in the group, including concurrently displaying, on the display, a first graphical representation of a first participant in the group including a first device status indicator providing a status of a first participant device, associated with the first participant and a second graphical representation of a second participant in the group including a second device status indicator providing a status of a second participant device, associated with the second participant, that is different from the first device status indicator.

### TECHNICAL FIELD

This relates generally to electronic devices, including but not limited to electronic devices provided with user interfaces that facilitate the management of displays of other electronic devices.

### BACKGROUND

The use of touch-sensitive surfaces as input devices for computers and other electronic computing devices has increased significantly in recent years. Examples of touch-sensitive surfaces include touch pads and touch screen displays. Such surfaces are widely used to manipulate user interface objects on a display.

Some examples of actions involving management of the displays of other devices include displaying a particular content item, launching a particular application, and locking the displays of the other devices, enabled with one or more user interface objects or by manipulating user interfaces. Examples of user interface objects include digital images, video, text, icons, control elements such as buttons and other graphics. A user will, in some circumstances, need to perform such actions enabling management of the displays of other devices in association with a file management program (e.g., Finder from Apple Inc. of Cupertino, Calif.), an image management application (e.g., Aperture or iPhoto from Apple Inc. of Cupertino, Calif.), a digital content (e.g., videos and music) management application (e.g., iTunes from Apple Inc. of Cupertino, Calif.), a drawing application, a presentation application (e.g., Keynote from Apple Inc. of Cupertino, Calif.), a word processing application (e.g., Pages from Apple Inc. of Cupertino, Calif.), a website creation application (e.g., iWeb from Apple Inc. of Cupertino, Calif.), a disk authoring application (e.g., iDVD from Apple Inc. of Cupertino, Calif.), or a spreadsheet application (e.g., Numbers from Apple Inc. of Cupertino, Calif.).

Computing devices are increasingly used in group settings to access and share content (e.g., webpages, textbooks, images). However, in some circumstances users are unfamiliar with navigating electronic devices and/or not paying attention when instructions for navigating to content on a device are provided. This can make it more difficult to use computing devices to share content rather than simply using a common text book or shared display.

### SUMMARY

While there are many advantages to using computing devices to access and share content (e.g., a richer, individualized experience of interacting with content), some methods of managing the displays of multiple devices are cumbersome, inefficient, and characteristically involve the independent manual operation of each of the multiple devices by respective users. For example, requesting users of other devices to launch a particular application and navigate to a particular content item is tedious and unreliable, as the users may misunderstand, miss and/or ignore instructions. In addition, these methods take longer than necessary, thereby wasting energy. This latter consideration is particularly important in battery-operated devices.

Accordingly, there is a need for electronic devices with faster, more efficient methods and interfaces for enabling management of the displays of other devices. Such methods and interfaces optionally complement or replace conventional methods for enabling management of the displays of other devices. Such methods and interfaces reduce the cognitive burden on a user and produce a more efficient human-machine interface. For battery-operated devices, such methods and interfaces conserve power and increase the time between battery charges.

The above deficiencies and other problems associated with enabling management of displays are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions are, optionally, included in a non-transitory computer readable storage medium or other computer program product configured for execution by one or more processors.

In accordance with some embodiments, a method is performed at an electronic device with a display, an optional touch-sensitive surface, one or more processors, and a non-transitory memory. The method includes receiving a request to display device status information for participant devices corresponding to participants in a group included on a roster, wherein a participant in the group is associated with a participant device. In response to receiving the request to display the device status information for the participant devices, the method includes displaying, based on the roster, respective graphical representations that include respective device status indicators for a respective set of the participants in the group, including concurrently displaying, on the display, a first graphical representation of a first participant in the group including a first device status indicator providing a status of a first participant device of the participant devices, associated with the first participant, and a second graphical representation of a second participant in the group including a second device status indicator providing a status of a second participant device of the participant devices, associated with the second participant, that is different from the first device status indicator.

In accordance with some embodiments, an electronic device includes a display unit configured to display one or more user interface objects and a processing unit coupled with the display unit. The processing unit is configured to: receive a request to display device status information for participant devices corresponding to participants in a group included on a roster, wherein a participant in the group is associated with a participant device. In response to receiving the request to display the device status information for the participant devices, the processing unit is configured to provide for display, based on the roster, respective graphical representations that include respective device status indicators for a respective set of the participants in the group, including providing for concurrent display, on the display a first graphical representation of a first participant in the group including a first device status indicator providing a status of a first participant device of the participant devices, associated with the first participant, and a second graphical representation of a second participant in the group including a second device status indicator providing a status of a second participant device of the participant devices, associated with the second participant, that is different from the first device status indicator.

In accordance with some embodiments, a method is performed at an electronic device with a display, an optional touch-sensitive surface, one or more input devices, one or more processors, and a non-transitory memory. The method includes while the electronic device is authorized to trigger performance of one or more navigation actions at participant devices that are associated with participants in a group, displaying a user interface that includes a content display affordance for transmitting instructions for causing a content item to be displayed in a respective application on a set of the participant devices. The method includes, while displaying the user interface, receiving, via the one or more input devices of the electronic device, a request to display a respective portion of a content item available through the respective application on the set of the participant devices, and in response to receiving the request, transmitting to the set of the participant devices, instructions which, when received by a respective participant device will trigger a first navigation action on the respective participant device that when executed will cause the respective participant device to display the respective portion of the content item in the respective application.

In accordance with some embodiments, an electronic device includes a display unit configured to display one or more user interface objects, one or more input devices configured to receive user inputs and a processing unit coupled with the display unit and the one or more input devices. The processing unit is configured to, while the electronic device is authorized to trigger performance of one or more navigation actions at participant devices that are associated with participants in a group, provide for display a user interface that includes a content display affordance for transmitting instructions for causing a content item to be displayed in a respective application on a set of the participant devices. The processing unit is configured to, while providing for display the user interface, receive, via the one or more input devices of the electronic device, a request to display a respective portion of a content item available through the respective application on the set of the participant devices. In response to receiving the request, the processing unit is configured to transmit to the set of the participant devices, instructions which, when received by a respective participant device will trigger a first navigation action on the respective participant device that when executed will cause the respective participant device to display the respective portion of the content item in the respective application.

In accordance with some embodiments, a method is performed at an electronic device with a display, an optional touch-sensitive surface, one or more processors, and a non-transitory memory. The method includes displaying on the display, a user interface of a second application that includes a content item, while the electronic device is associated with a user profile authenticated to participate with a first group of participants and a second group of participants through a first application, and while displaying the user interface of the second application that includes the content item, receiving a request to initiate a content sharing operation with at least one of the first group and the second group facilitated by the first application. In response to receiving the request to initiate the content sharing operation, the method includes displaying a plurality of sharing options for sharing the content item of the second application, including in accordance with a determination that the electronic device is in a first context when the request to initiate the content sharing operation is received, displaying in the plurality of sharing options a first sharing option that, when selected will initiate sharing of the content item with participants in the first group without initiating sharing of the content item with the second group, and in accordance with a determination that the electronic device is in a second context when the request to initiate the content sharing operation is received, displaying in the plurality of sharing options a second sharing option that, when selected will initiate sharing of the content item with participants in the second group without initiating sharing of the content item with the first group.

In accordance with some embodiments, an electronic device includes a display unit configured to display one or more user interface objects, and a processing unit coupled with the display unit. The processing unit is configured to provide for display, a user interface of a second application that includes a content item, while the electronic device is associated with a user profile authenticated to participate with a first group of participants and a second group of participants through a first application, and while providing for display the user interface of the second application that includes the content item, receive a request to initiate a content sharing operation with at least one of the first group and the second group facilitated by the first application. In response to receiving the request to initiate the content sharing operation, the processing unit is configured to provide for display a plurality of sharing options for sharing the content item of the second application, including in accordance with a determination that the electronic device is in a first context when the request to initiate the content sharing operation is received, provide for display in the plurality of sharing options a first sharing option that, when selected will initiate sharing of the content item with participants in the first group without initiating sharing of the content item with the second group, and in accordance with a determination that the electronic device is in a second context when the request to initiate the content sharing operation is received, provide for display in the plurality of sharing options a second sharing option that, when selected will initiate sharing of the content item with participants in the second group without initiating sharing of the content item with the first group.

In accordance with some embodiments, an electronic device includes a display, optionally a touch-sensitive surface, one or more processors, memory, and one or more programs; the one or more programs are stored in the memory and configured to be executed by the one or more processors and the one or more programs include instructions for performing or causing performance of the operations of any of the methods described herein. In accordance with some embodiments, a computer readable storage medium has stored therein instructions which when executed by an electronic device with a display, and an optional touch-sensitive surface, cause the device to perform or cause performance of the operations of any of the methods described herein. In accordance with some embodiments, a graphical user interface on an electronic device with a display, optionally a touch-sensitive surface, a memory, and one or more processors to execute one or more programs stored in the memory includes one or more of the elements displayed in any of the methods described above, which are updated in response to inputs, as described in any of the methods described herein. In accordance with some embodiments, an electronic device includes: a display, optionally a touch-sensitive surface, and means for performing or causing performance of the operations of any of the methods described herein. In accordance with some embodiments, an information processing apparatus, for use in an electronic device with a display and a touch-sensitive surface, and optionally one or more sensors to detect intensity of contacts with the touch-sensitive surface, includes means for performing or causing performance of the operations of any of the methods described herein.

Thus, electronic devices with displays, and optionally touch-sensitive surfaces are provided with faster, more efficient methods and interfaces for enabling management of the displays of other devices, thereby increasing the effectiveness, efficiency, and user satisfaction with such electronic devices. Such methods and interfaces may complement or replace conventional methods for enabling management of the displays of other devices.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating components for event handling in accordance with some embodiments.

FIG. 2 illustrates a portable multifunction device having a touch screen in accordance with some embodiments.

FIG. 3 is a block diagram of a multifunction device with a display and a touch-sensitive surface in accordance with some embodiments.

FIG. 4A illustrates a user interface for a menu of applications on a portable multifunction device in accordance with some embodiments.

FIG. 4B illustrates a user interface for a multifunction device with a touch-sensitive surface that is separate from the display in accordance with some embodiments.

FIGS. 5A-5YY illustrate user interfaces for enabling management of displays of participant devices in accordance with some embodiments.

FIGS. 6A-6C are flow diagrams illustrating a method of displaying graphical representations of participants and device status information for participant devices corresponding to the participants in accordance with some embodiments.

FIGS. 7A-7D are flow diagrams illustrating a method of transmitting instructions to perform a navigation action at a participant device, in accordance with some embodiments.

FIGS. 8A-8C are flow diagrams illustrating a method of enabling sharing of a content item in one application, with participants associated with another application in accordance with some embodiments.

FIG. 9 is a functional block diagram of an electronic device in accordance with some embodiments.

FIG. 10 is a functional block diagram of an electronic device in accordance with some embodiments.

FIG. 11 is a functional block diagram of an electronic device in accordance with some embodiments.

### DESCRIPTION OF EMBODIMENTS

The use of electronic devices with touch-based user interfaces (e.g., devices such as the iPhone®, iPod Touch®, and iPad® devices from Apple Inc. of Cupertino, Calif.) has increased significantly in recent years. These devices use touch-sensitive surfaces, such as a touch screen display or a touch pad, as the main input for manipulating user interface objects on a display and/or controlling the device. These devices also have contact intensity sensor for determining a force or pressure of contacts with the touch-sensitive surfaces.

Described below are devices and methods that enable users of a supervisory electronic device to manage the displays of particular participant devices, without requiring independent manual operation of the particular participant devices. In some embodiments described below, a supervisory electronic device obtains a roster of participants and displays a user interface with representations of participants of the roster. In some embodiments described below, the supervisory electronic device provides a user interface for transmitting instructions to participant devices for performing one or more navigation actions at the participant devices. For example, the supervisory electronic device displays a content display affordance in a user interface, which transmits instructions for causing a content item to be displayed at a respective participant device, upon selection of the affordance. The supervisory device also enables sharing of a content item with participant devices associated with a first application, while displaying a user interface of a second application.

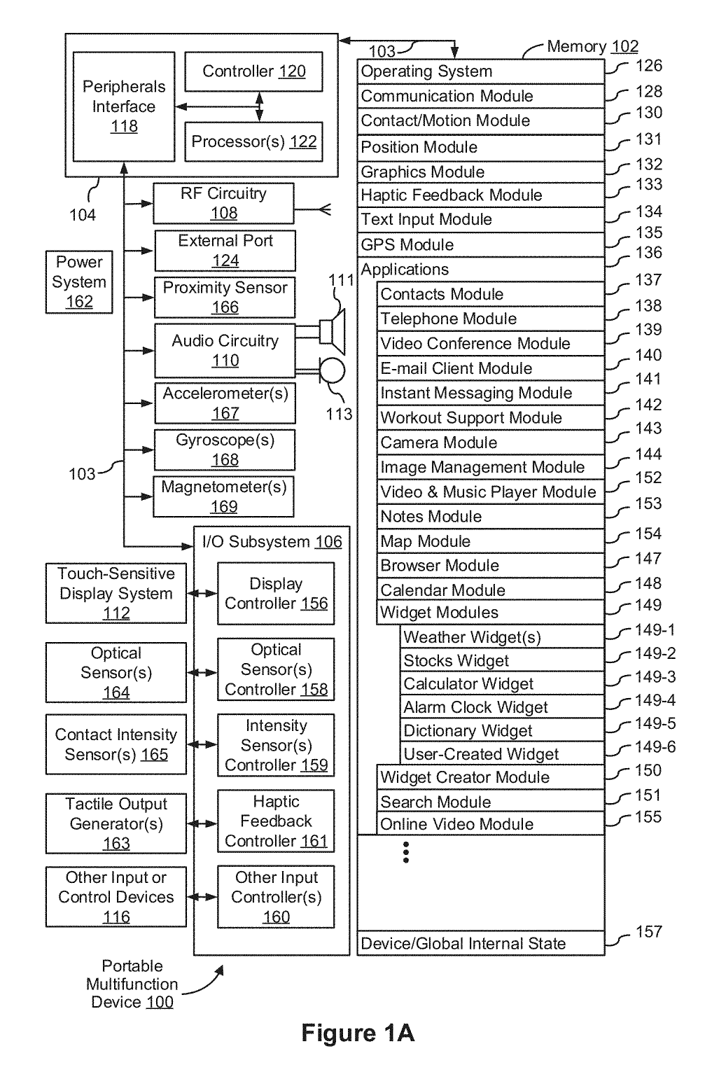

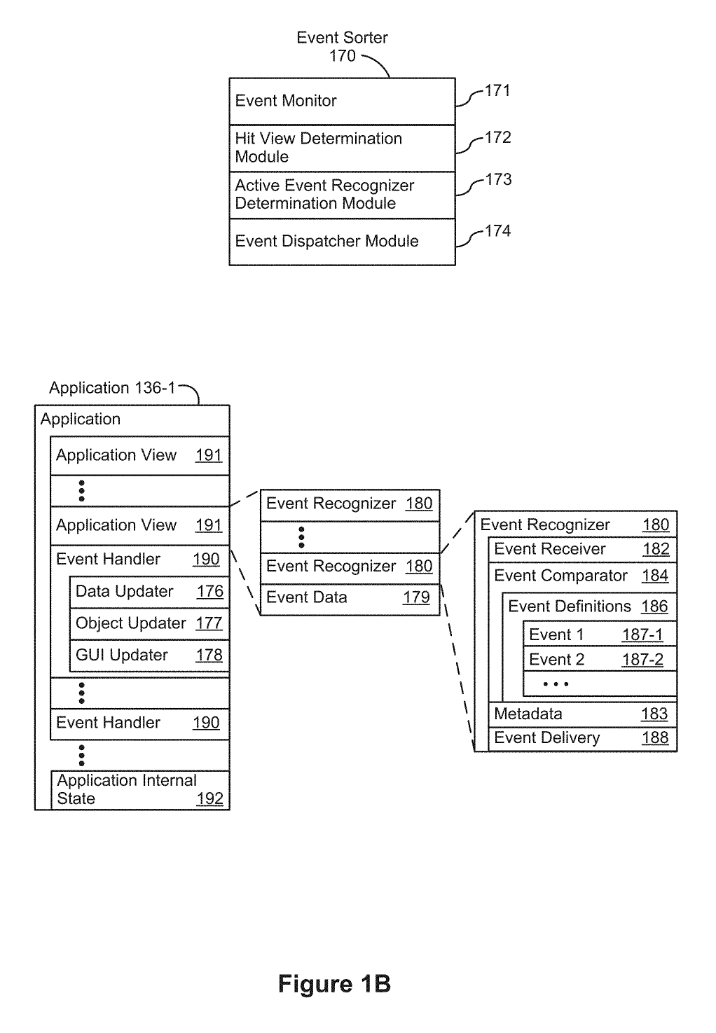

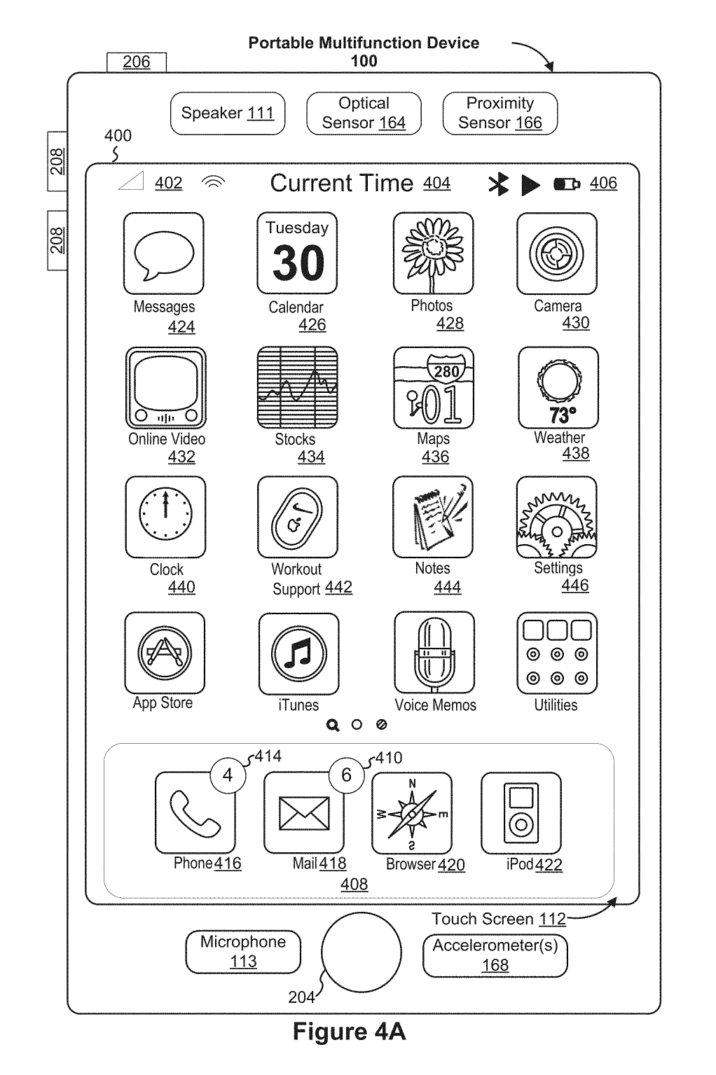

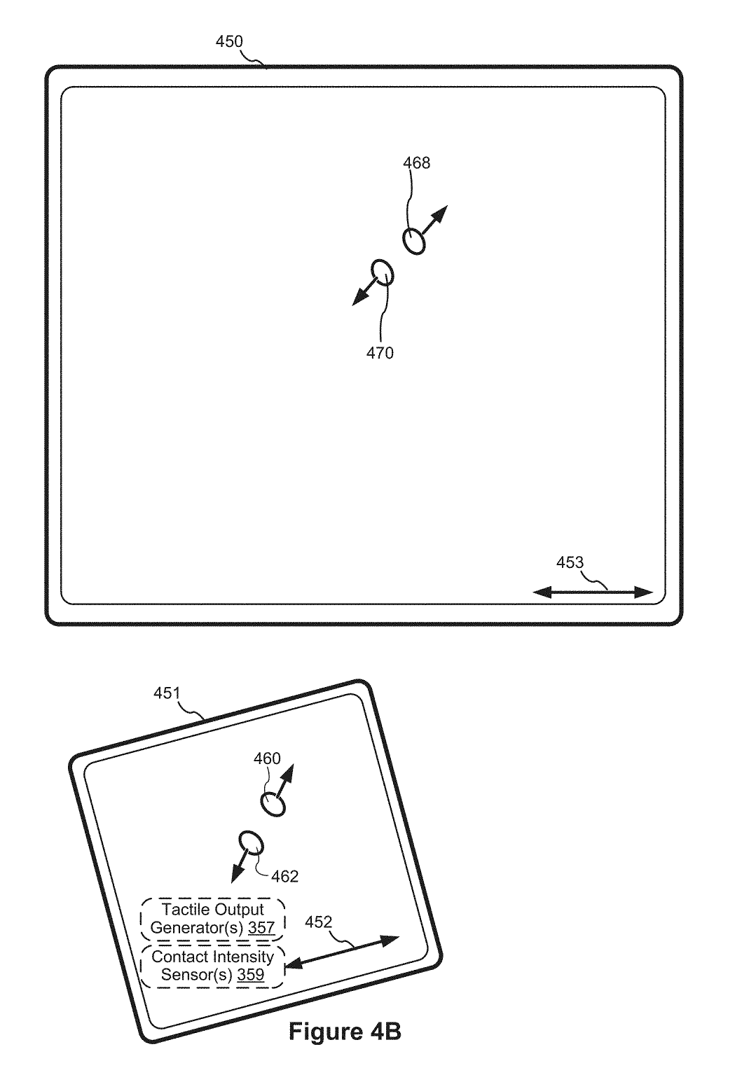

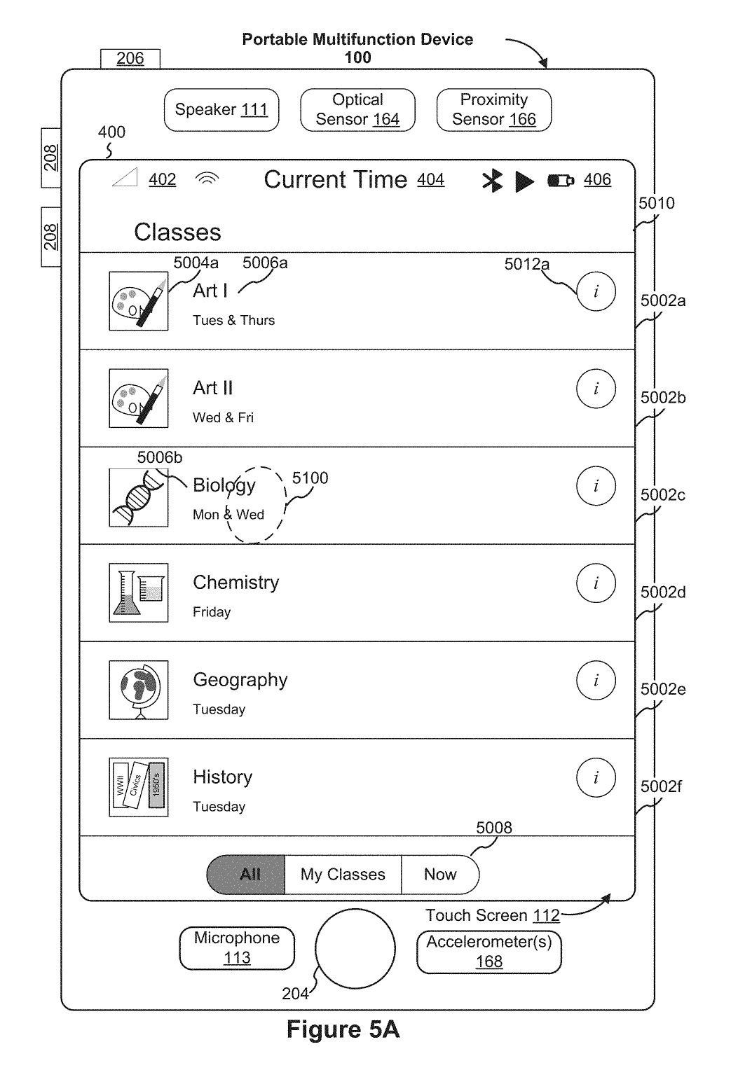

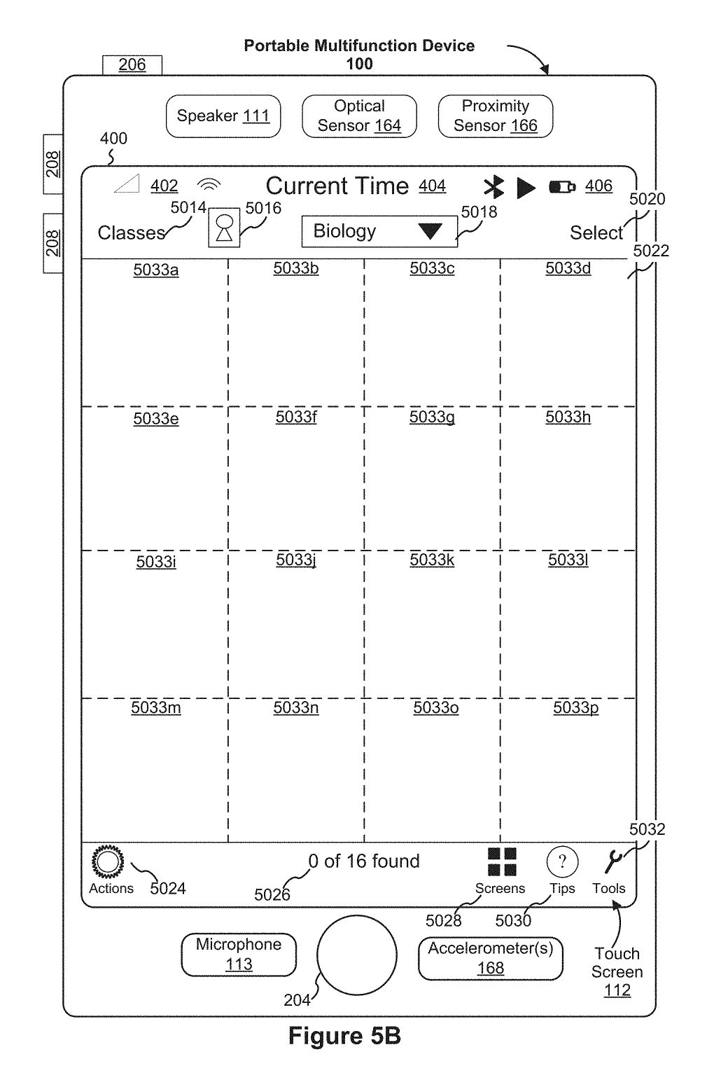

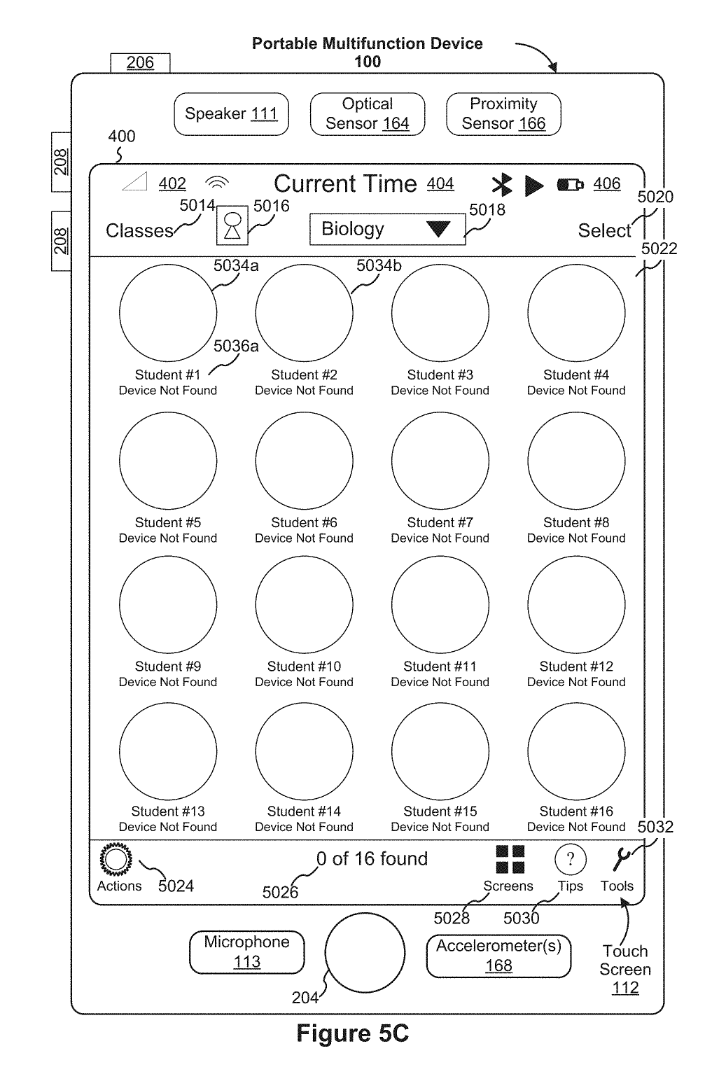

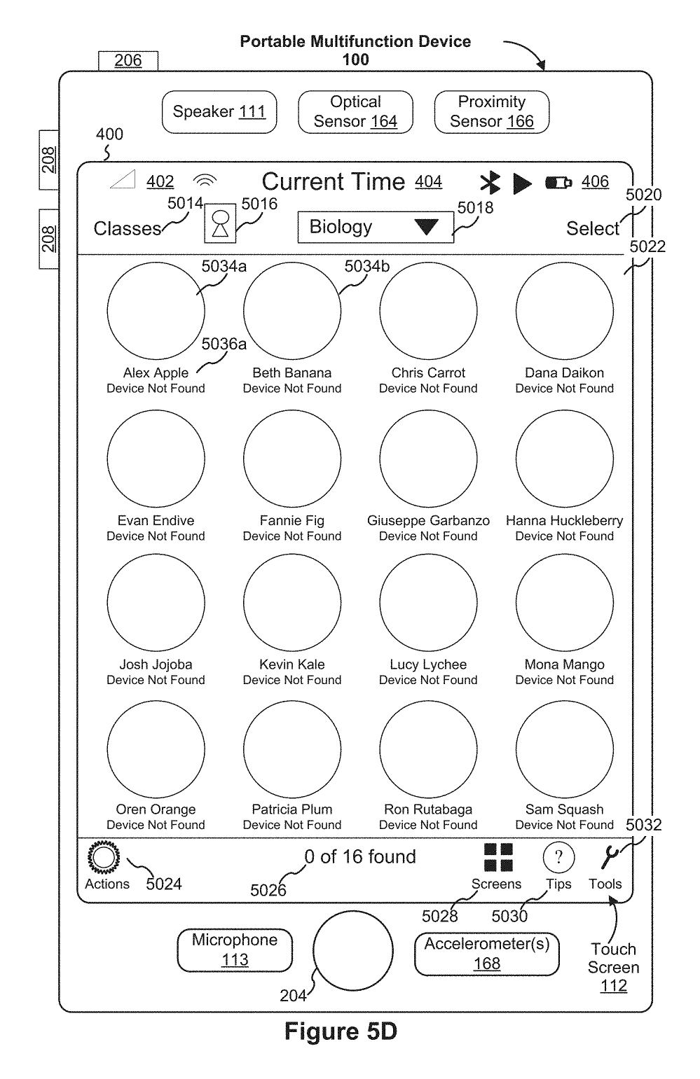

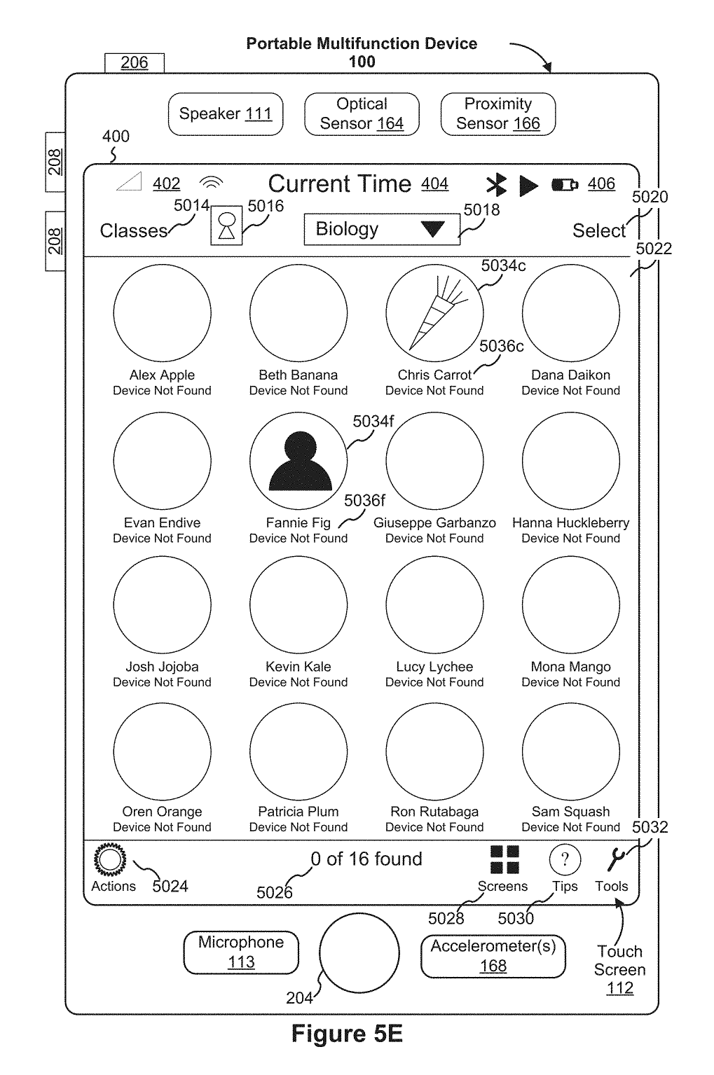

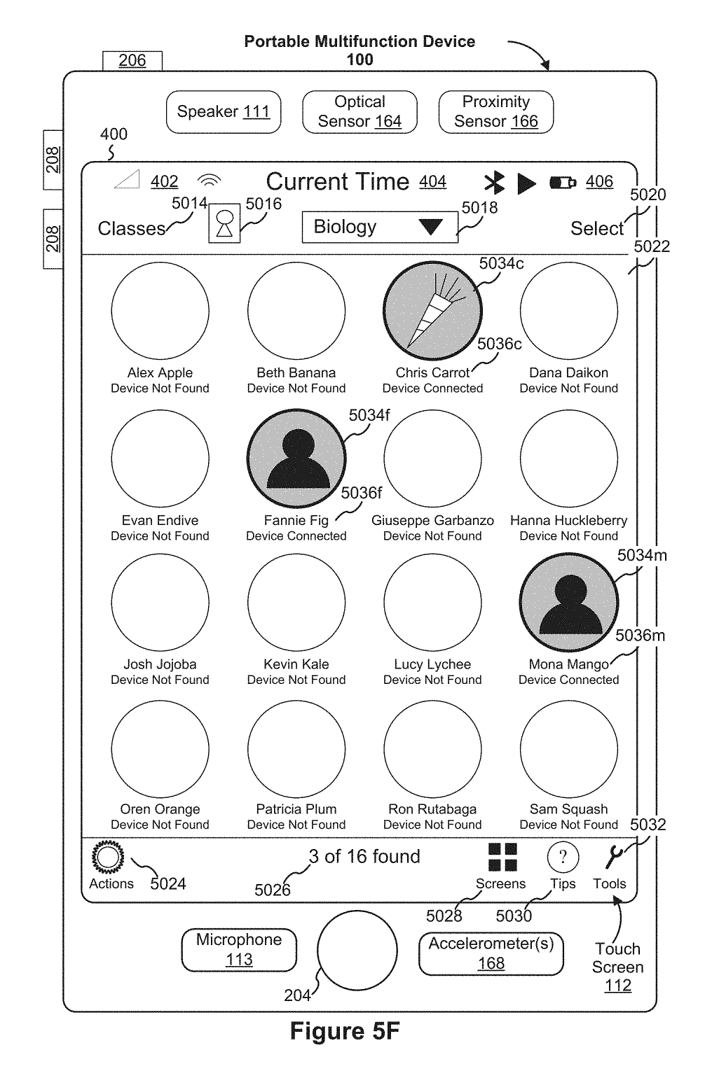

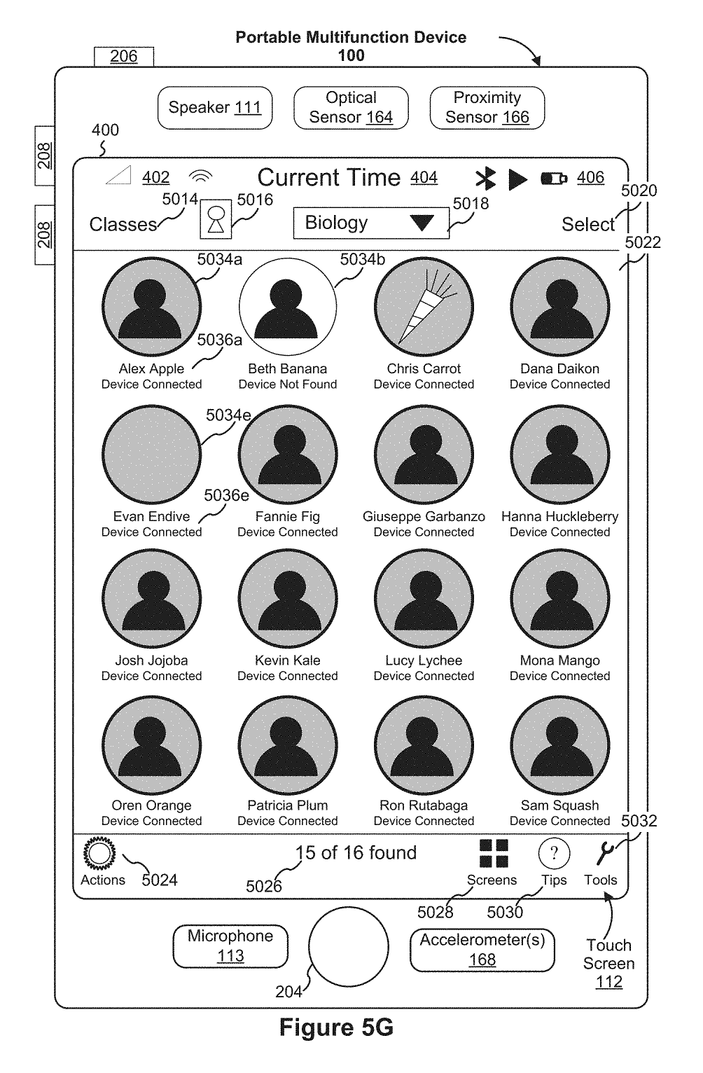

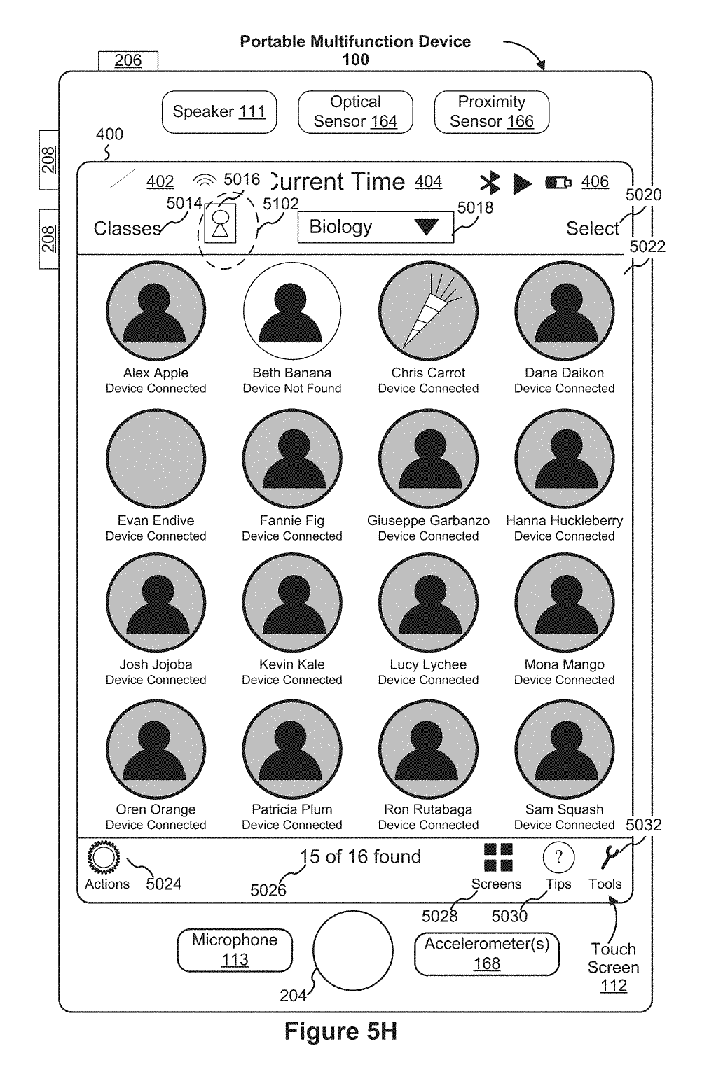

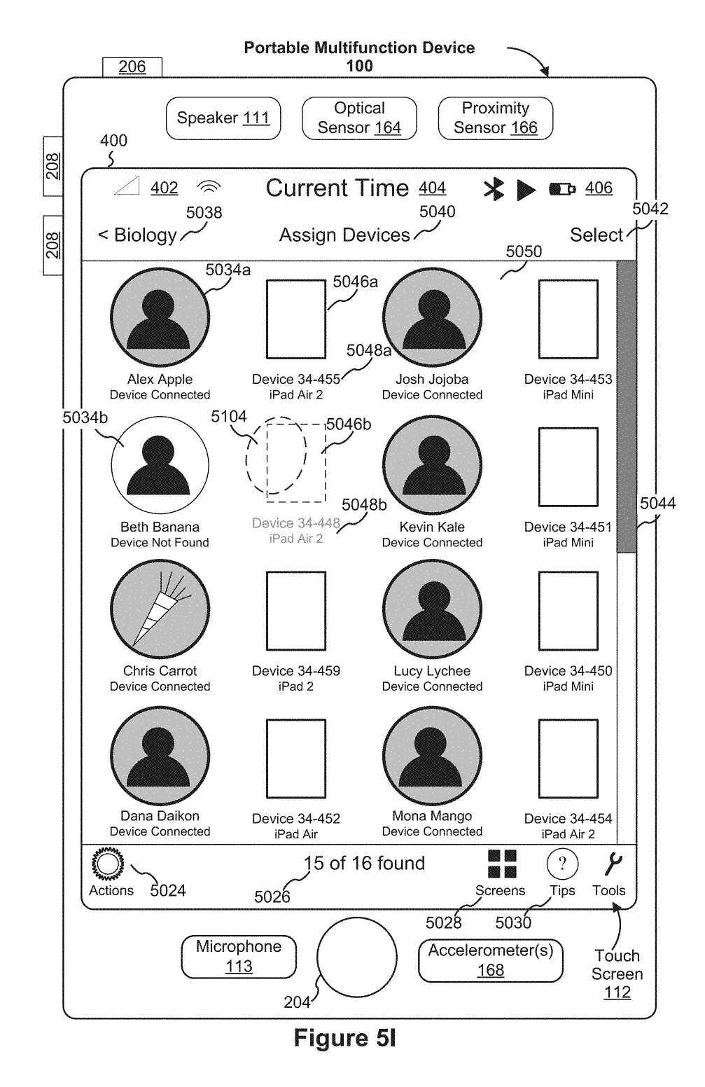

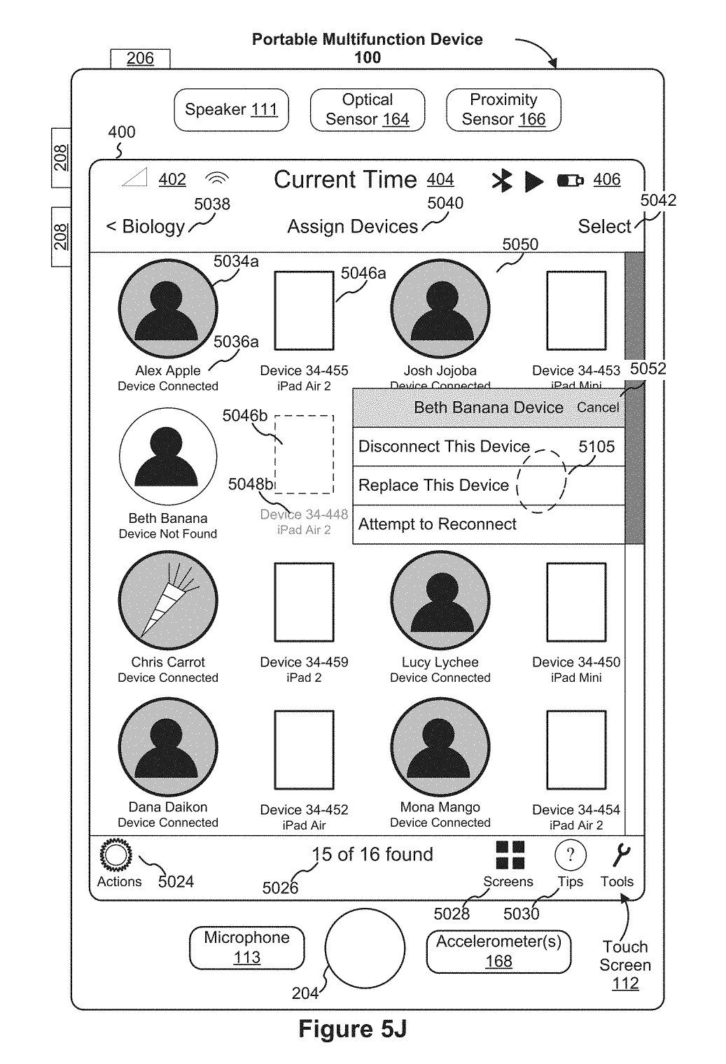

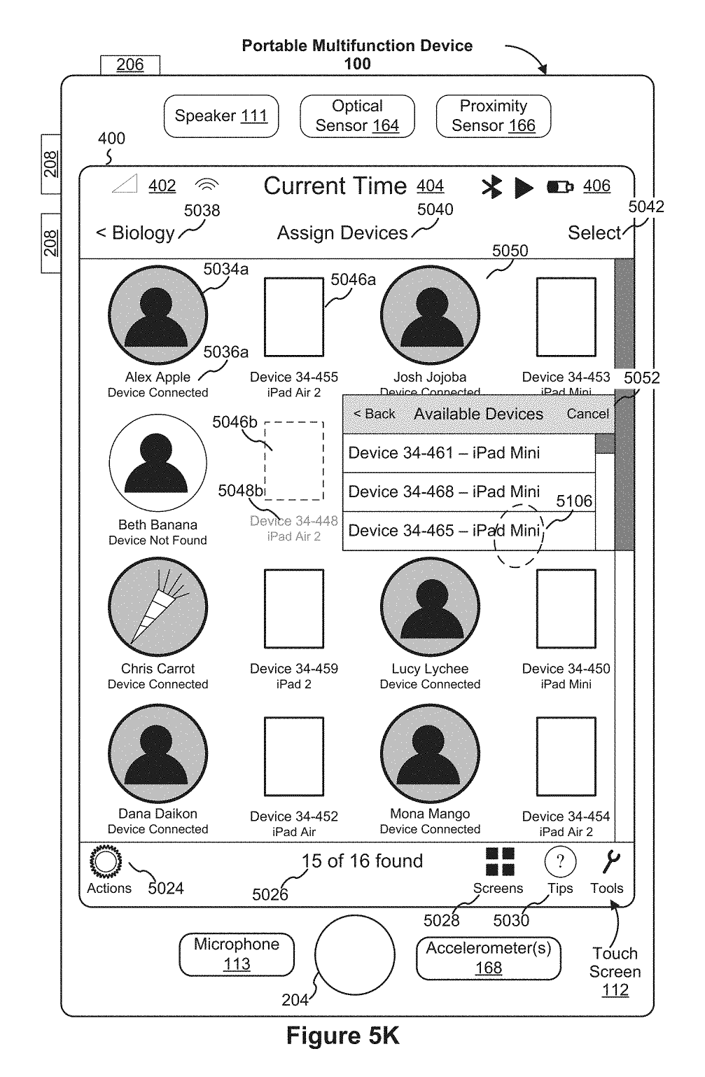

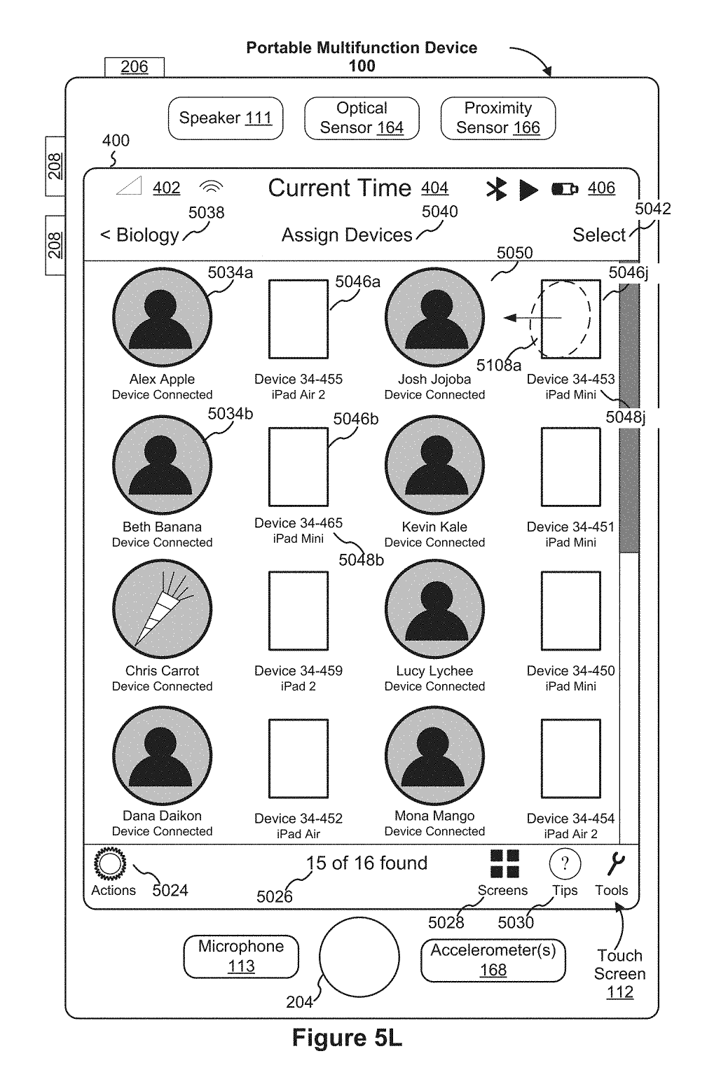

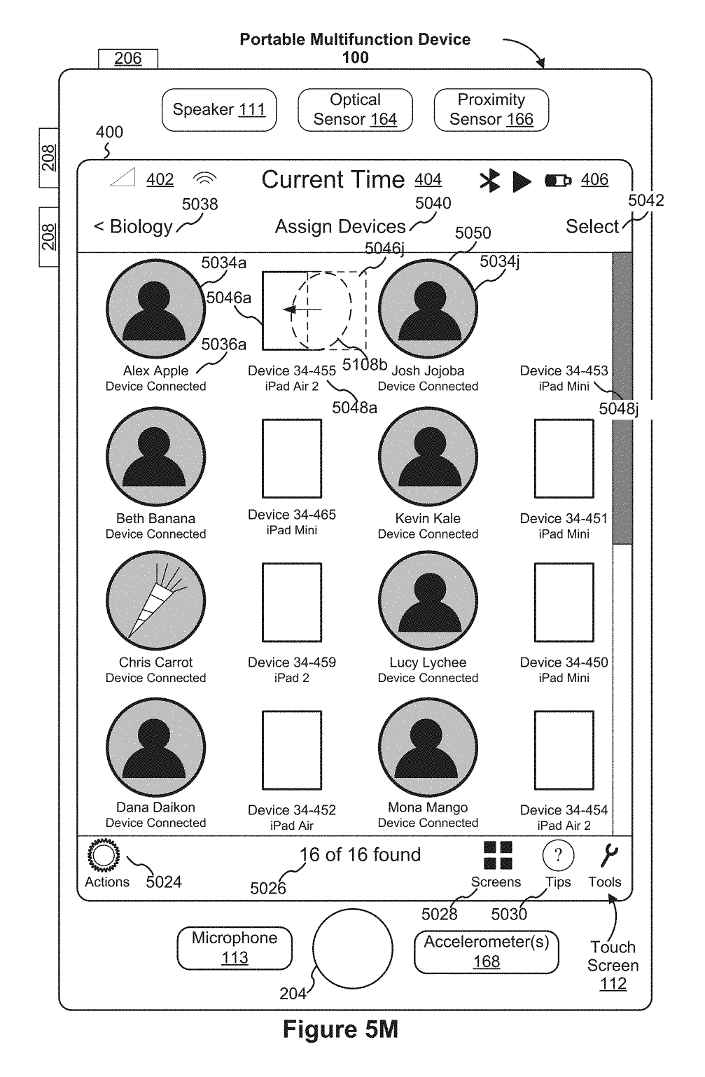

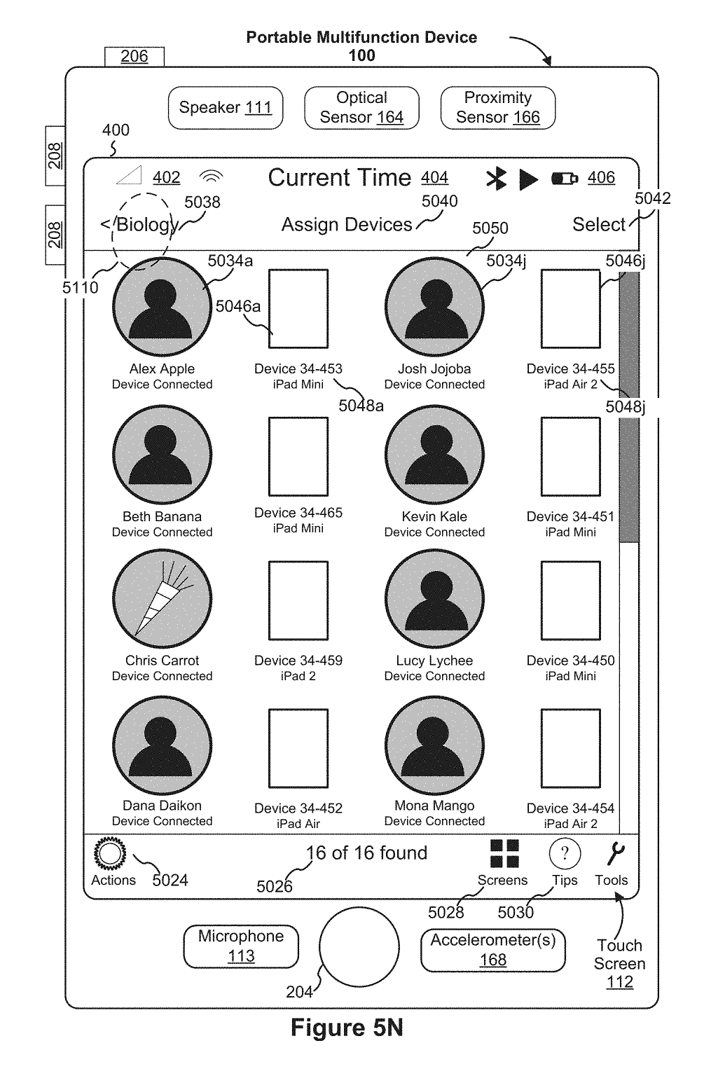

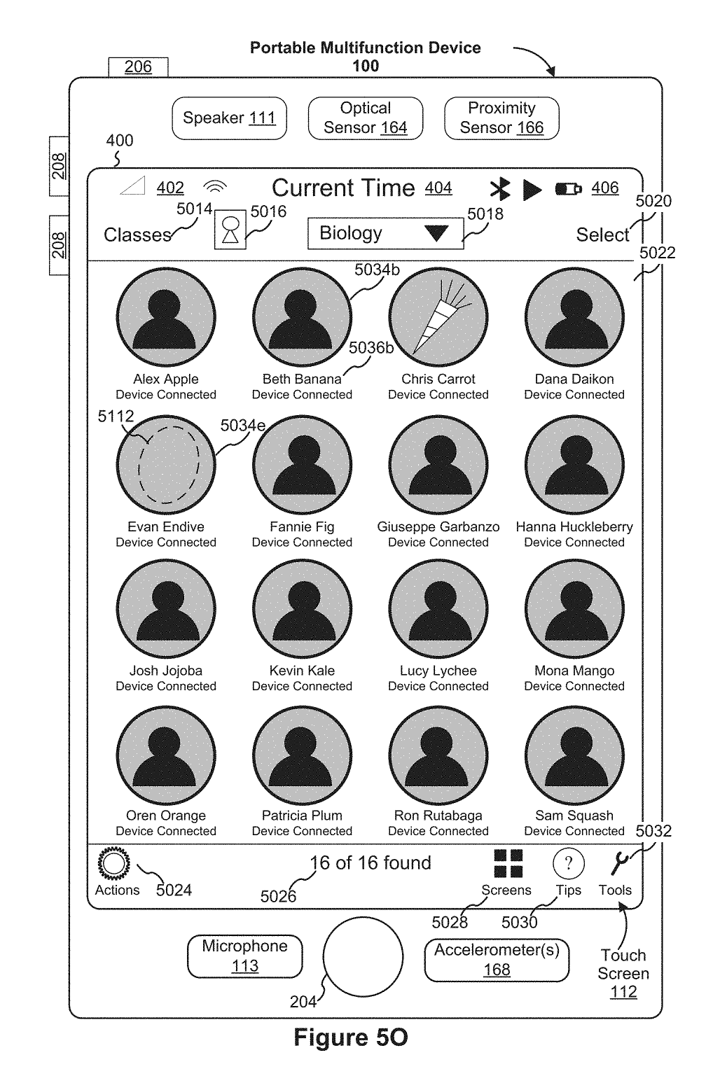

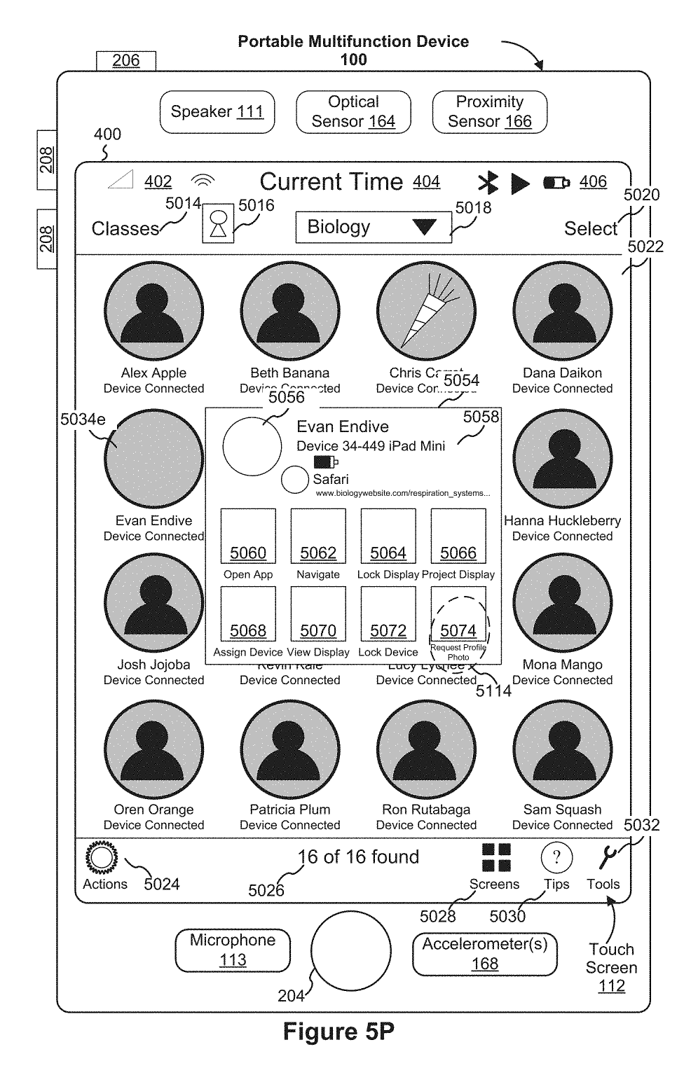

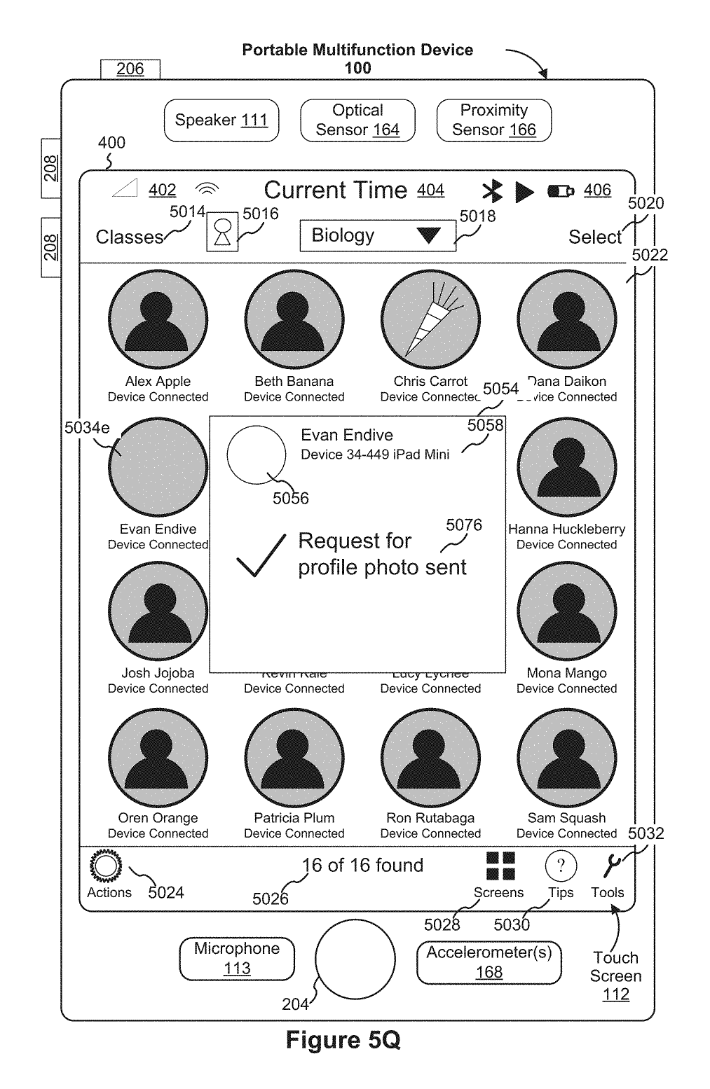

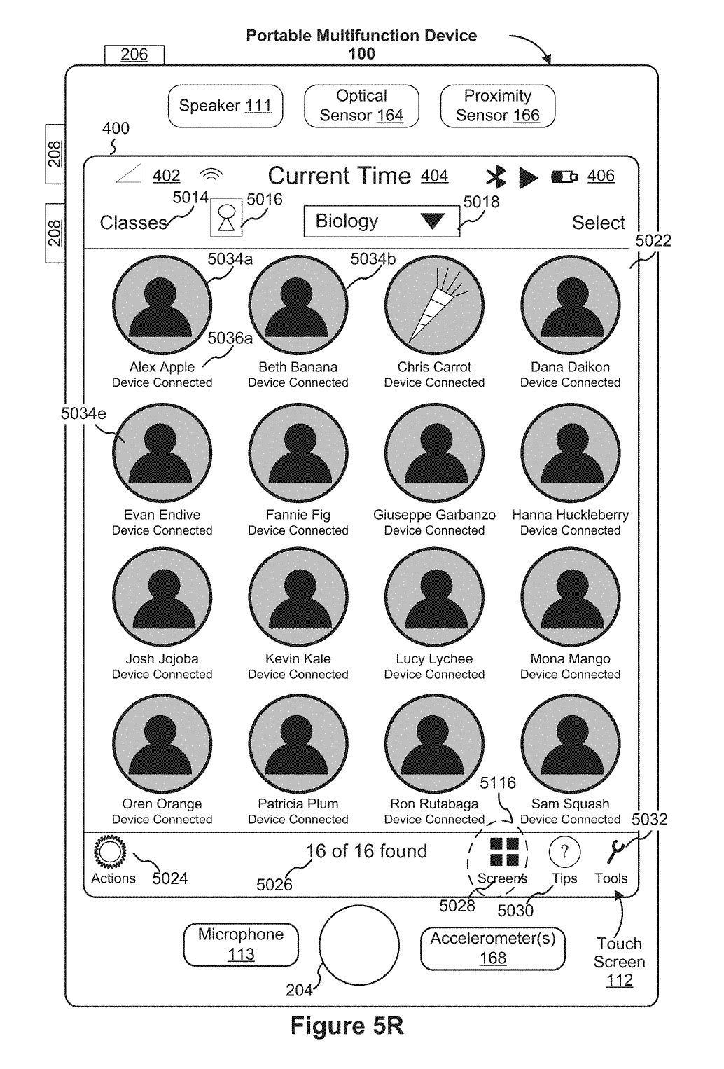

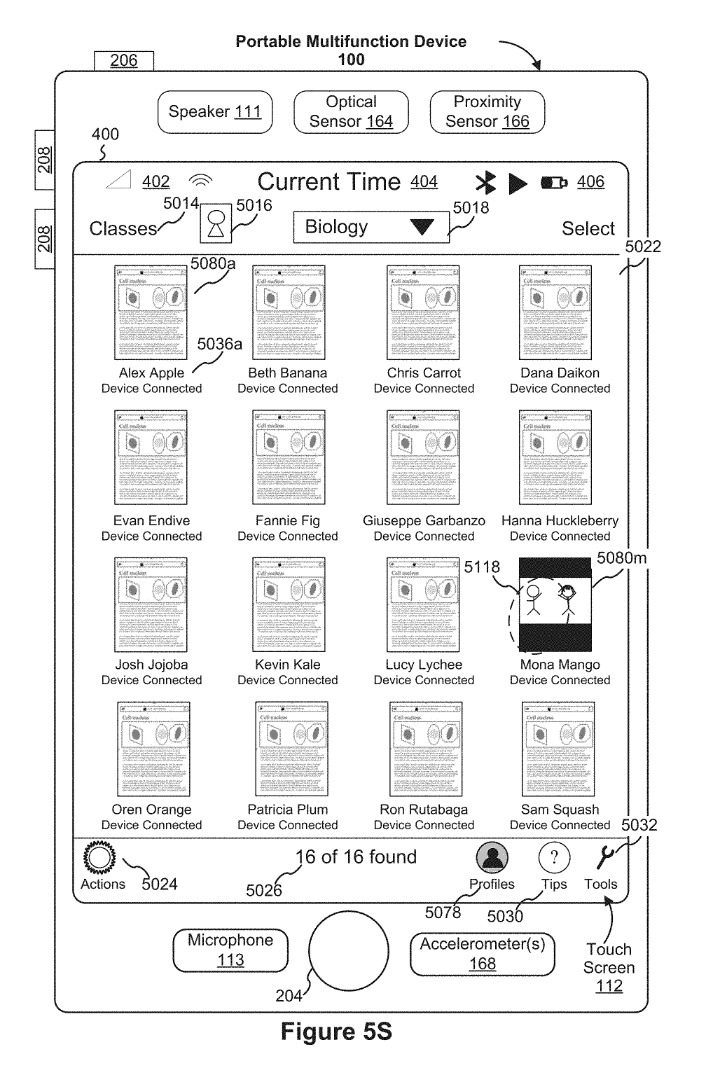

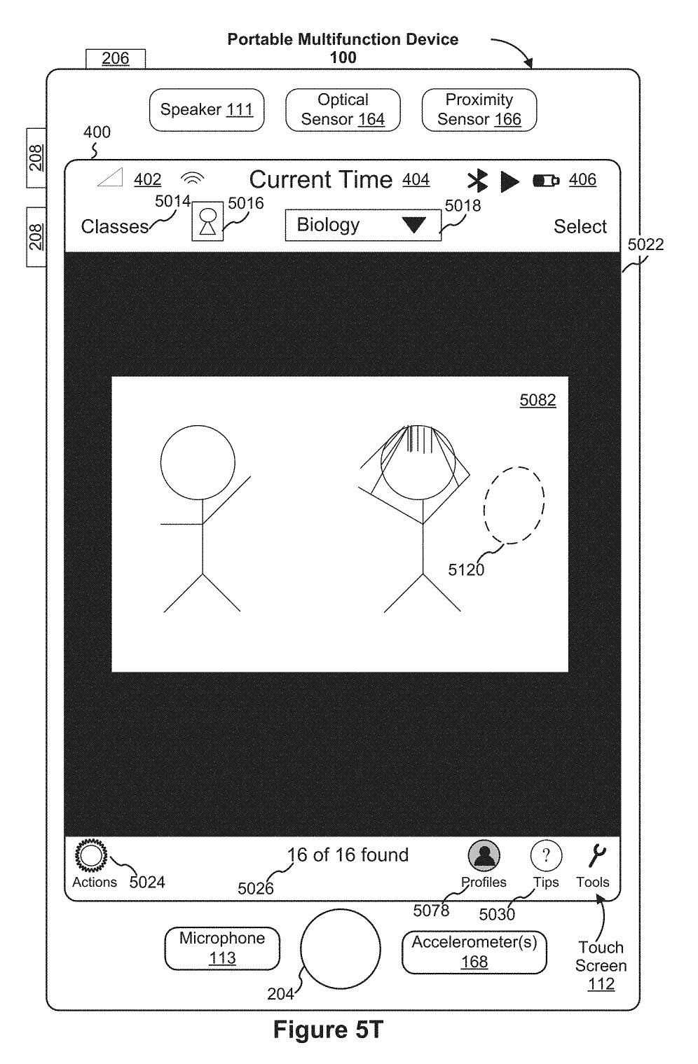

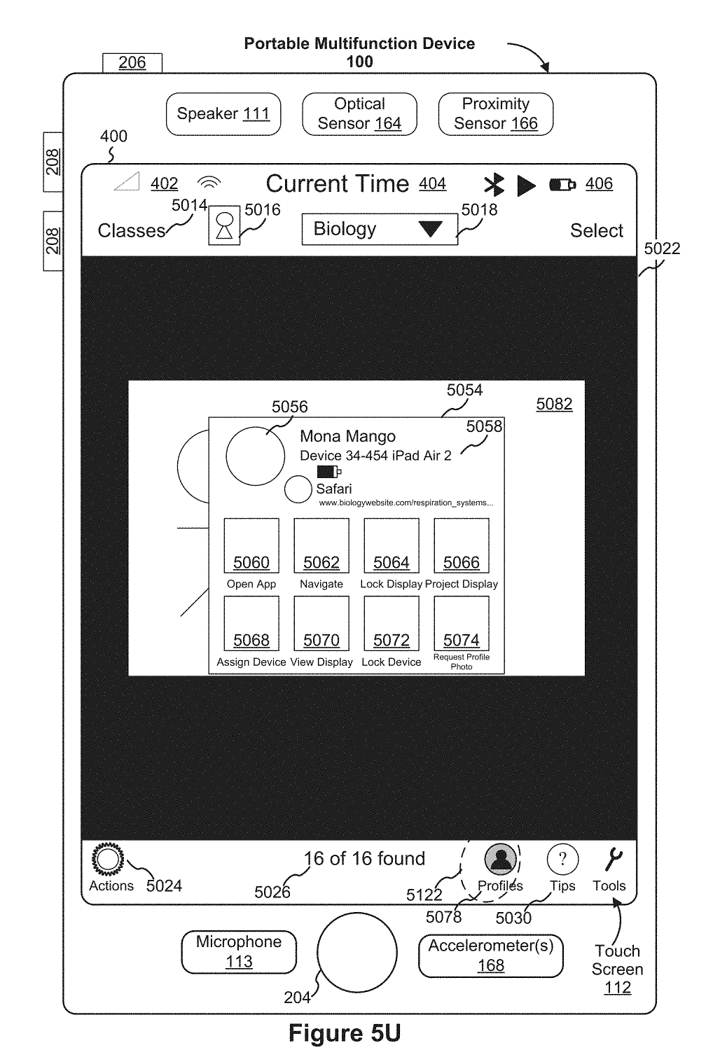

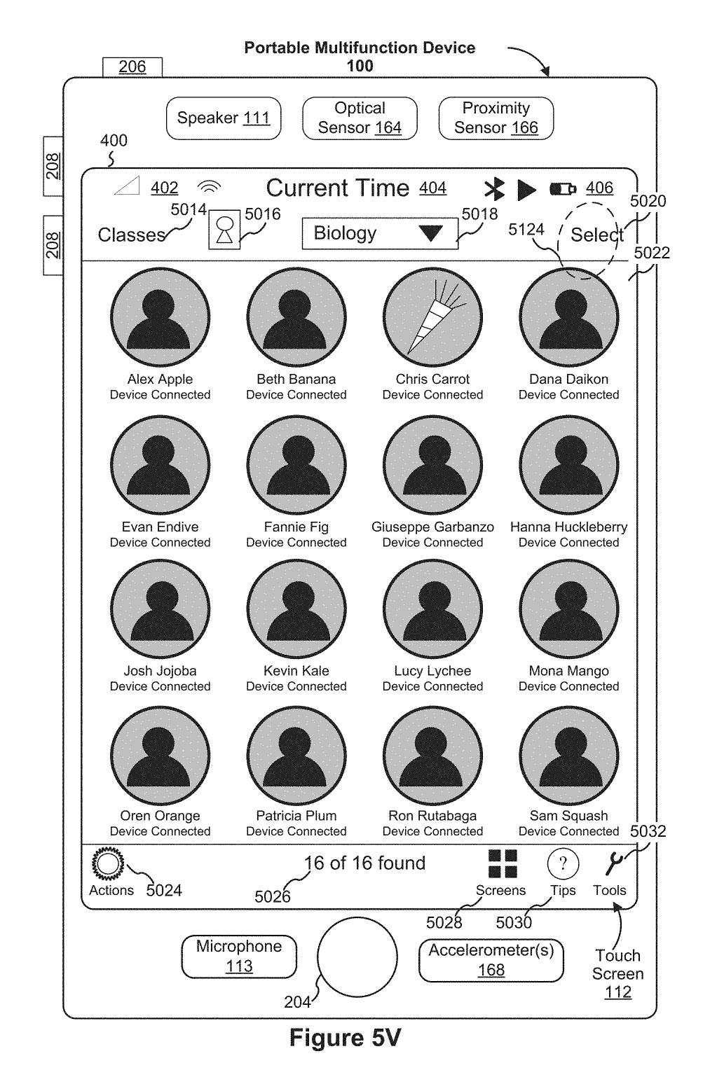

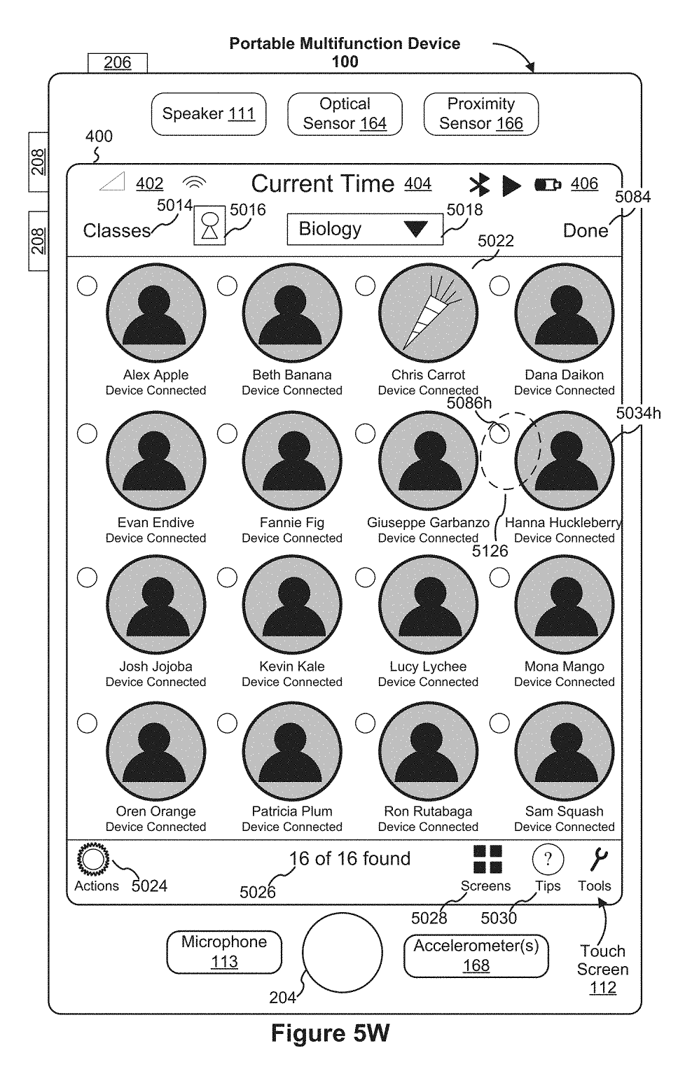

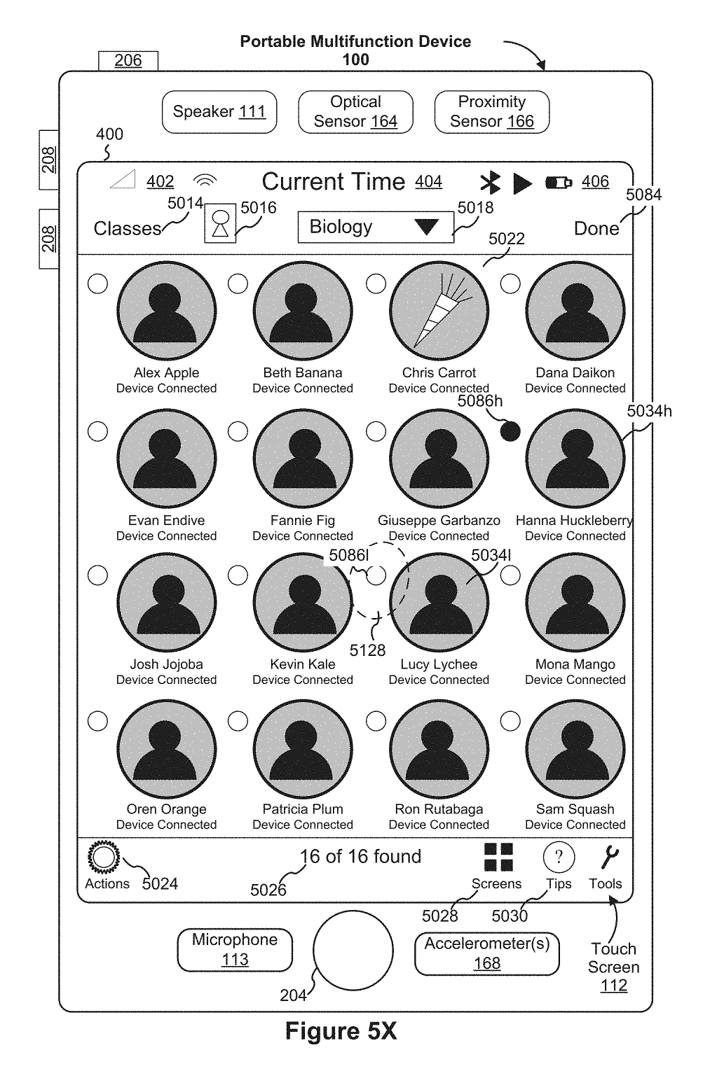

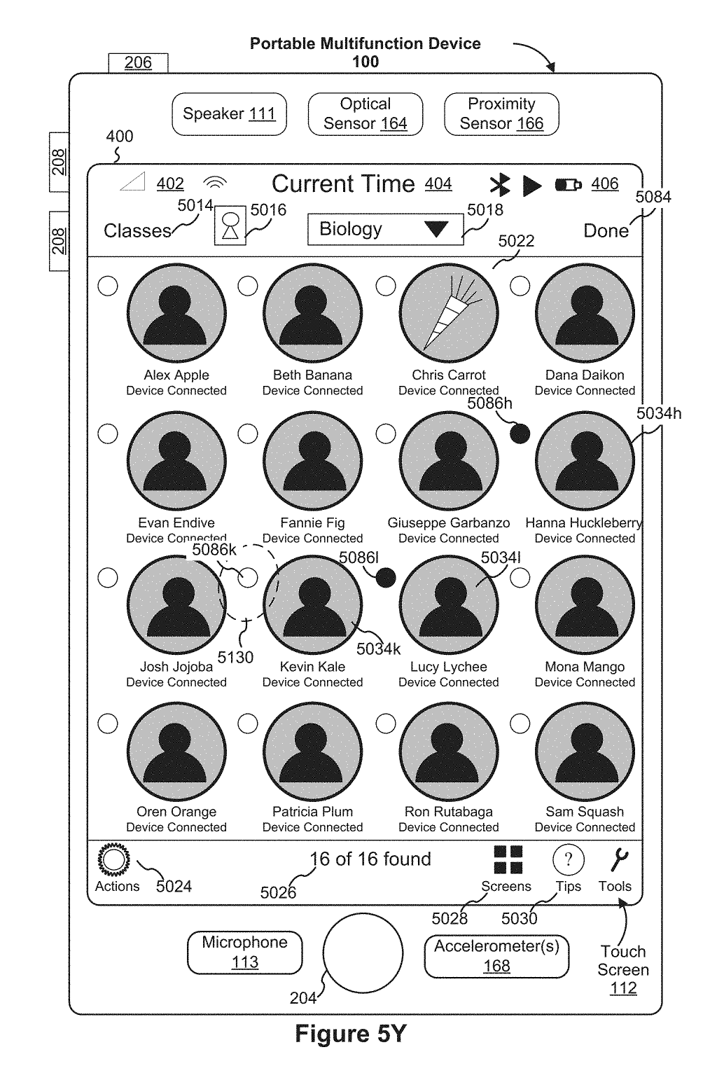

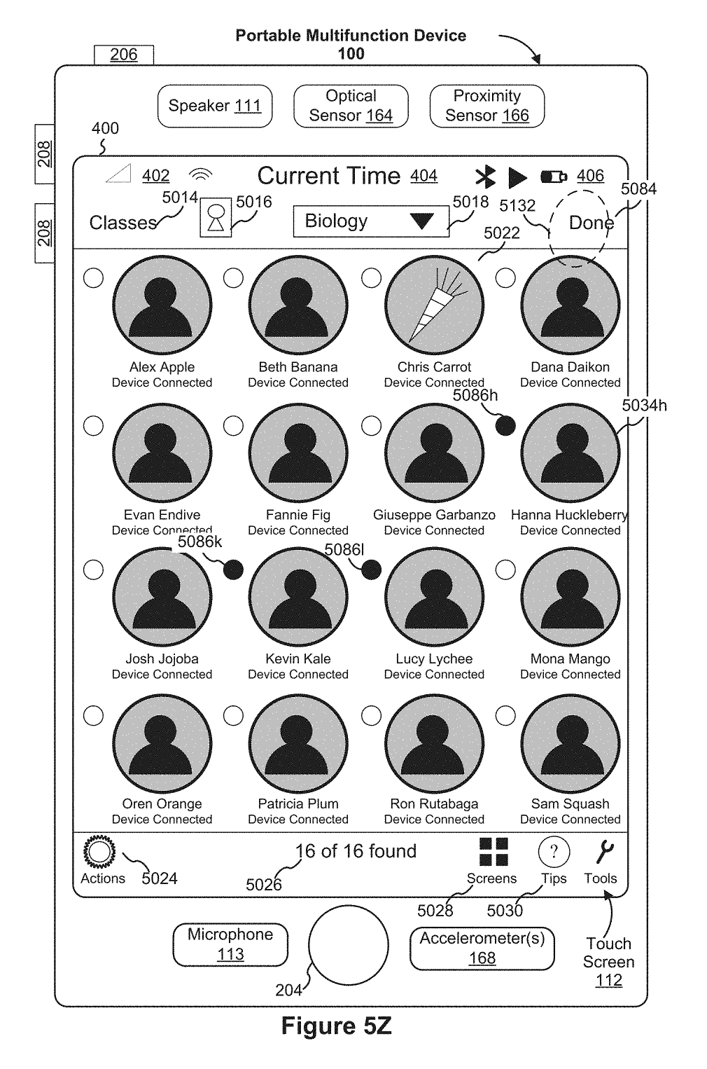

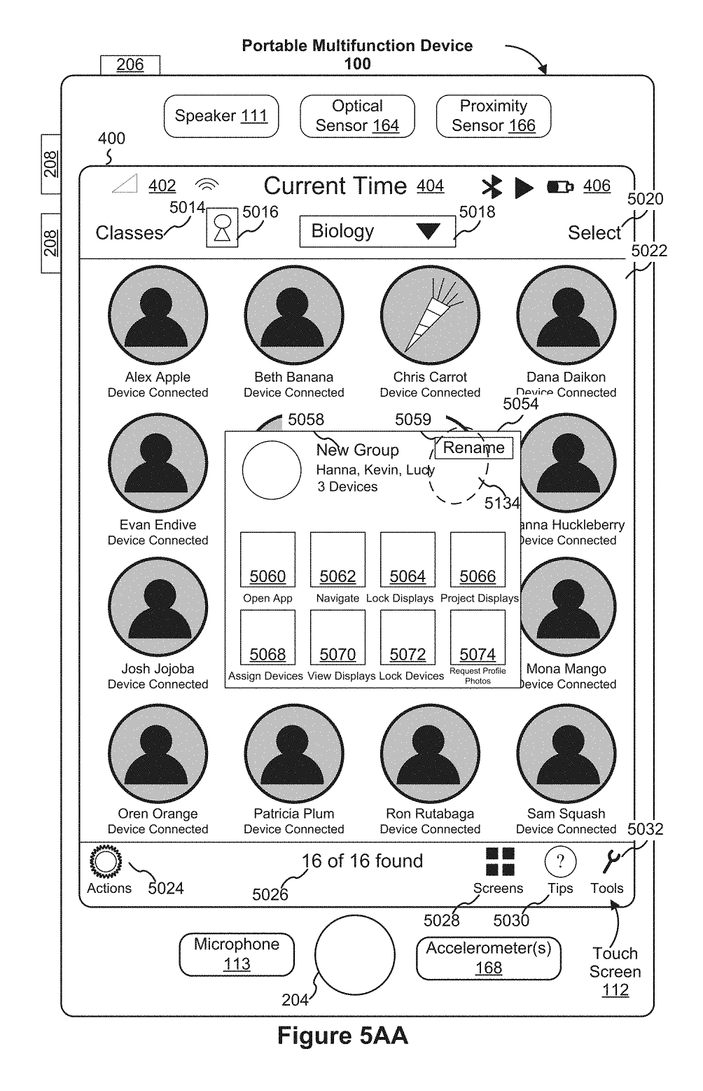

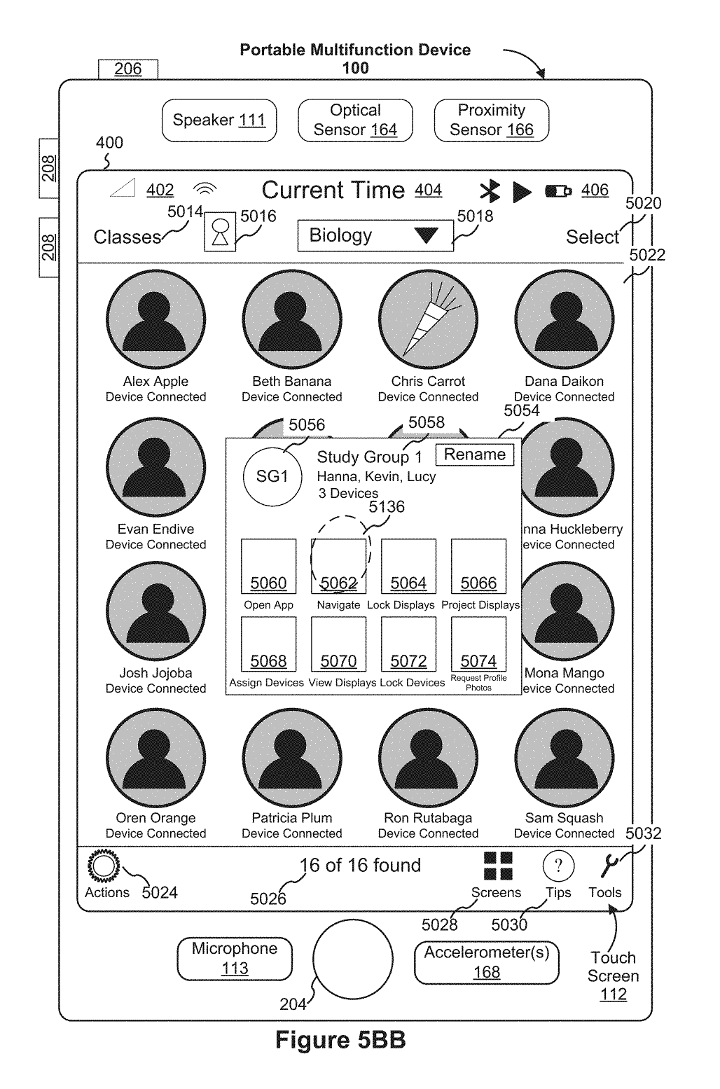

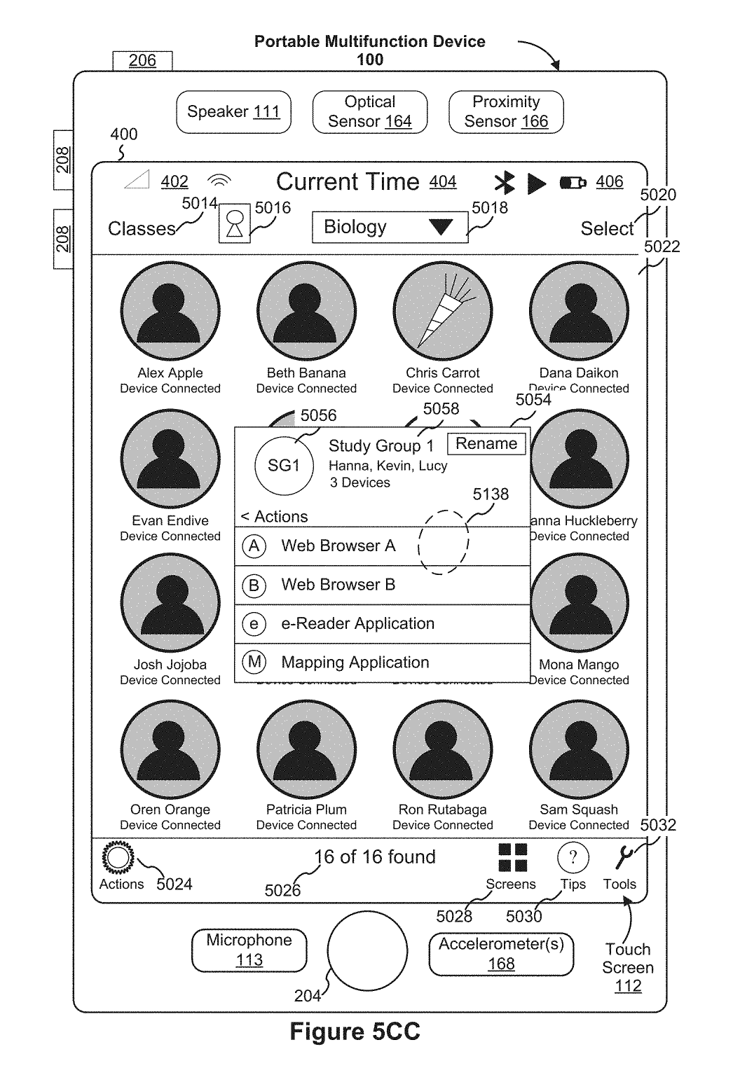

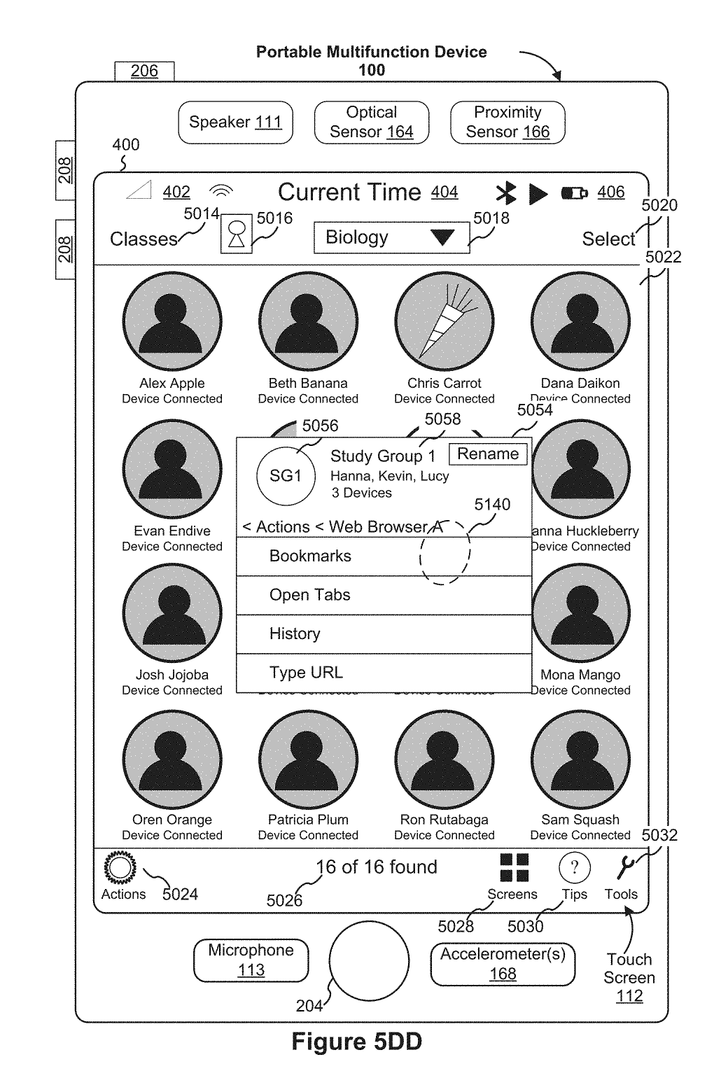

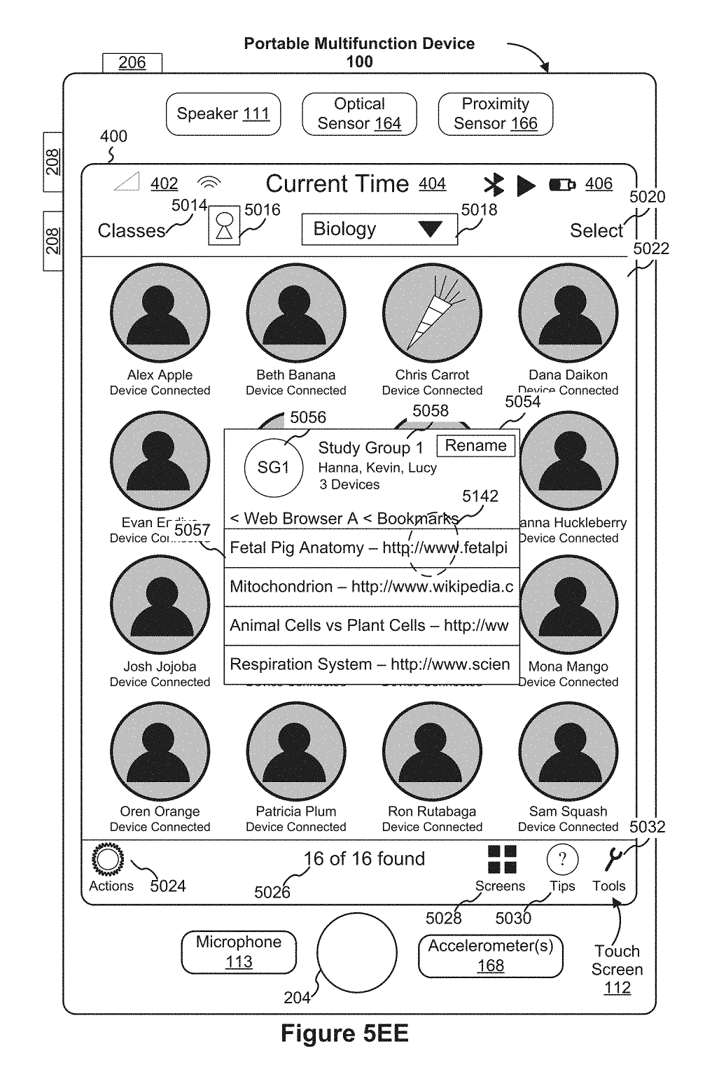

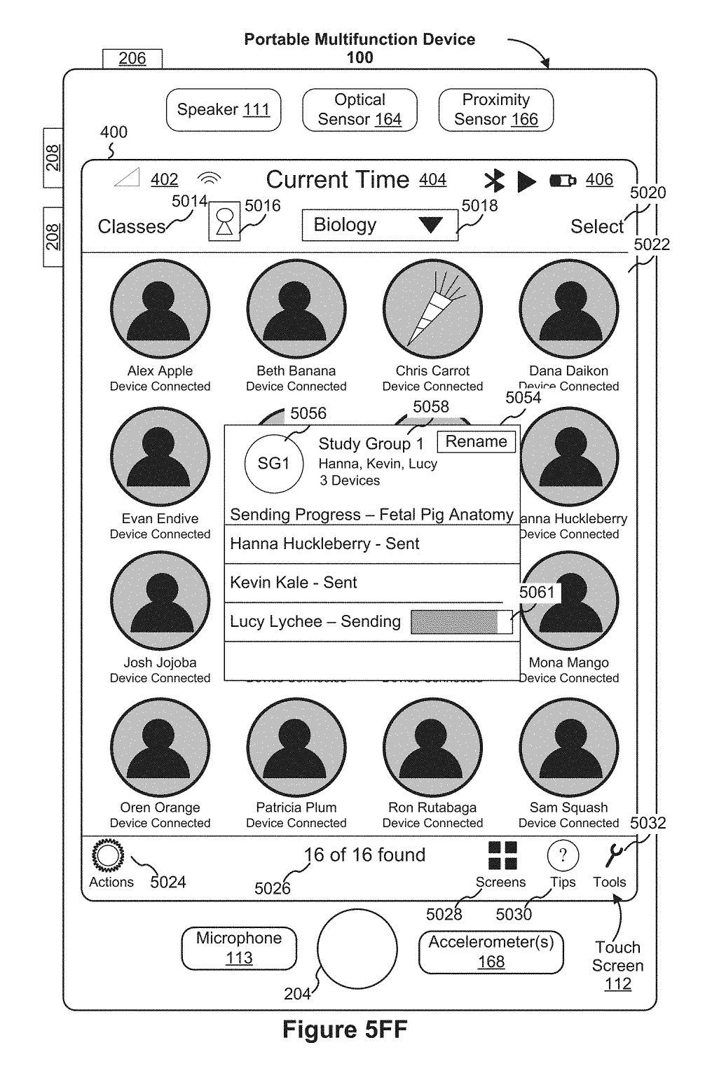

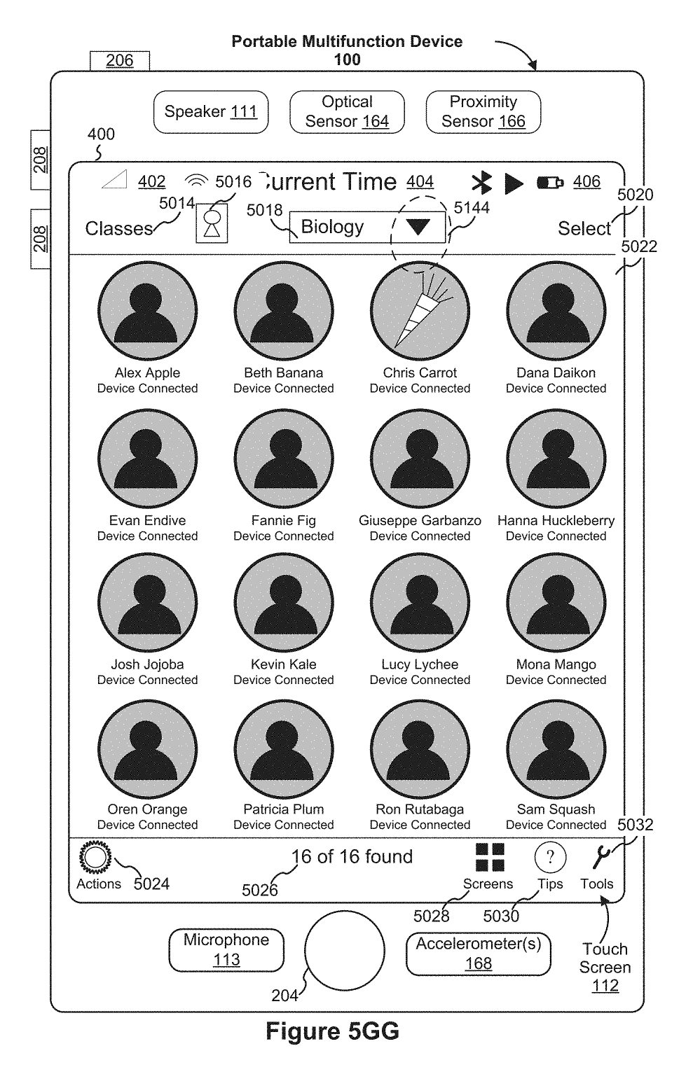

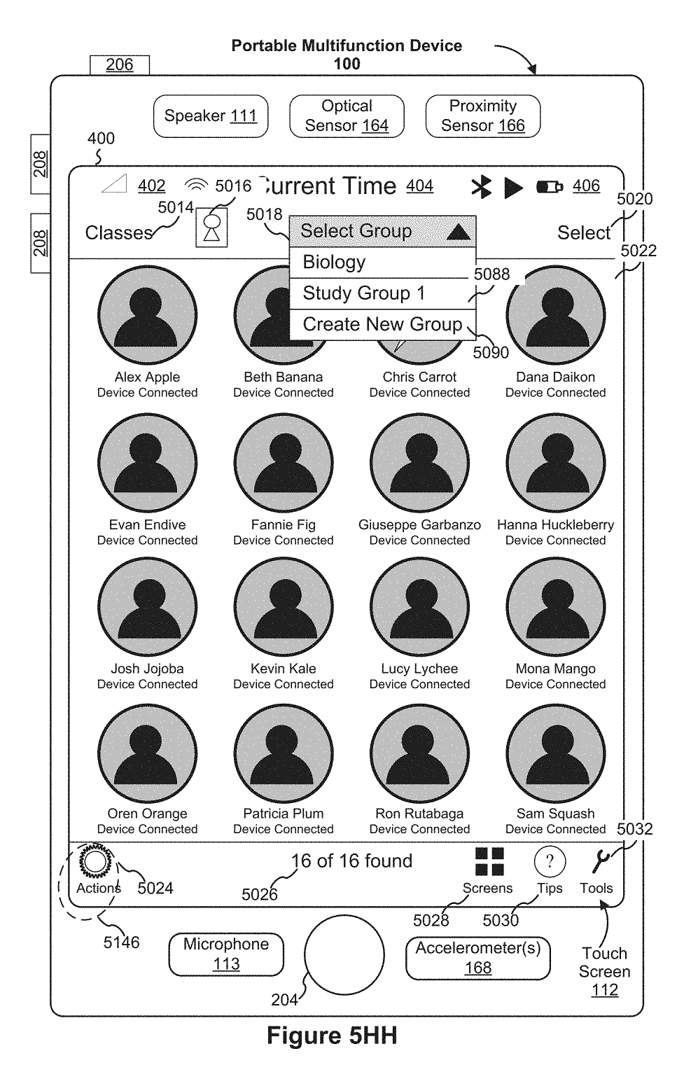

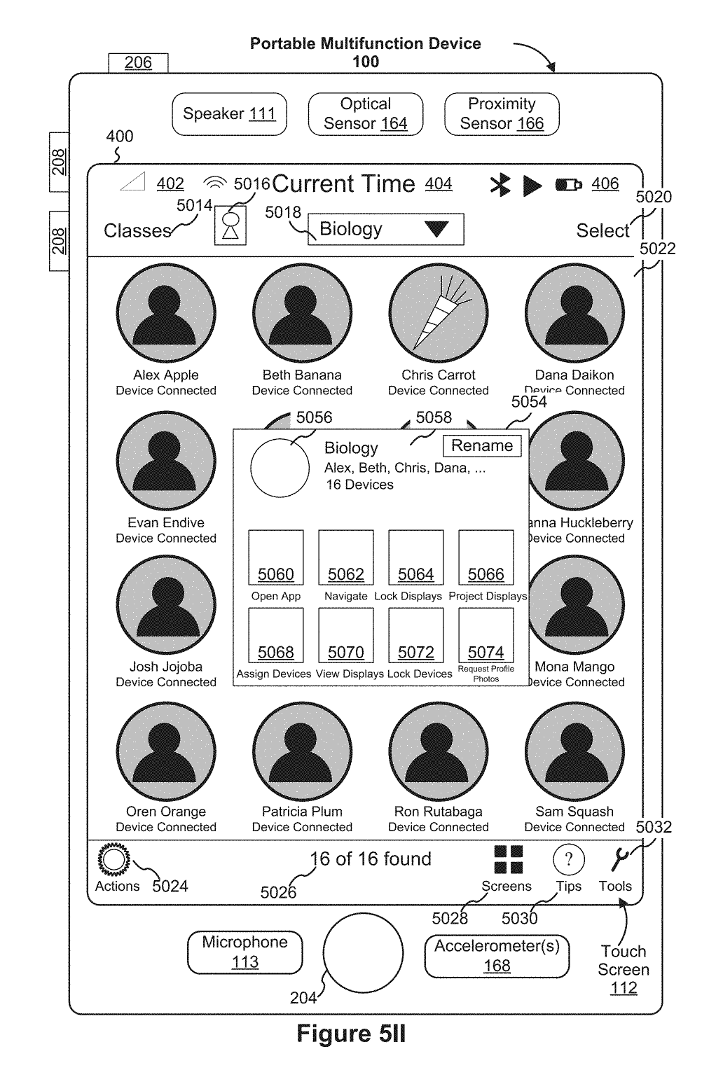

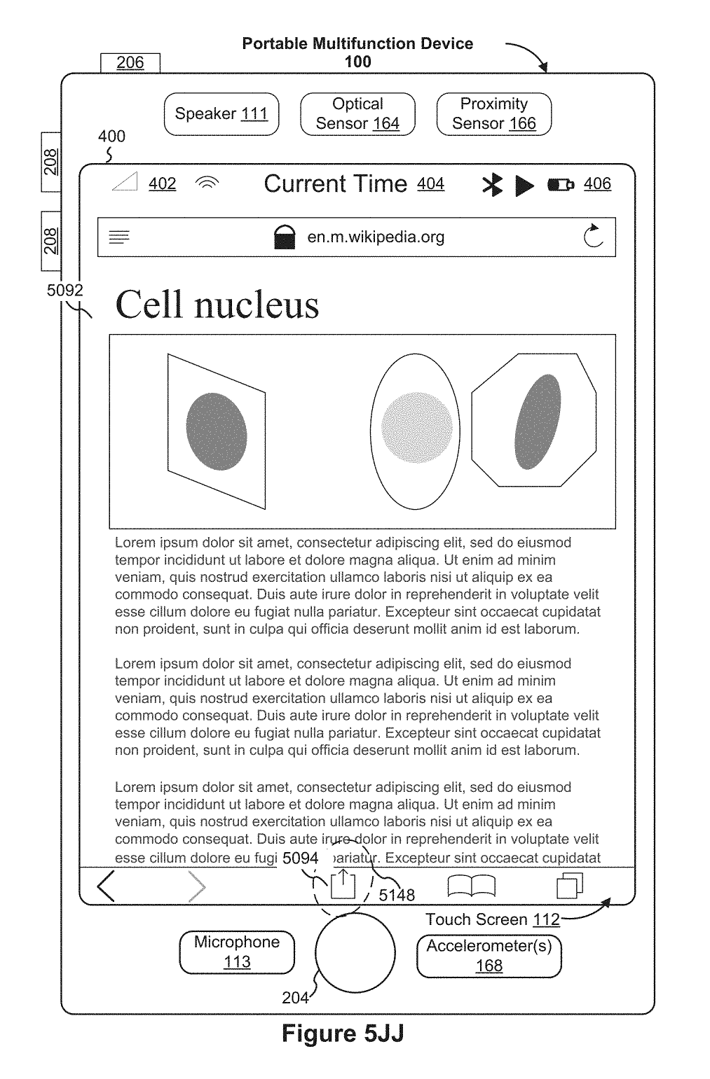

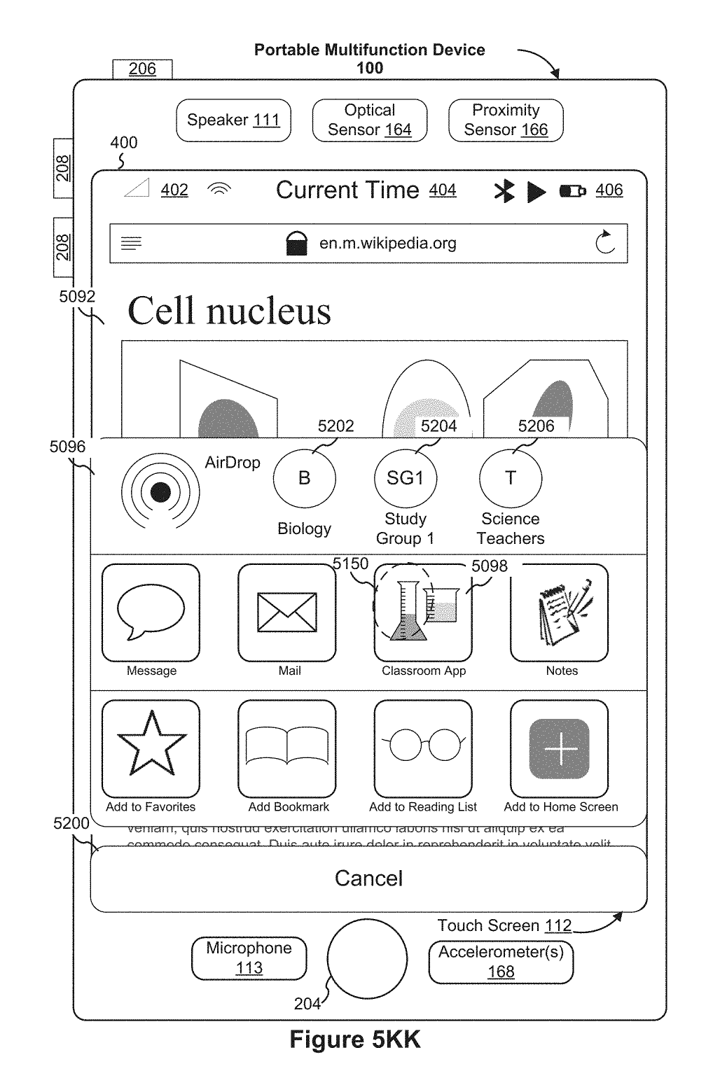

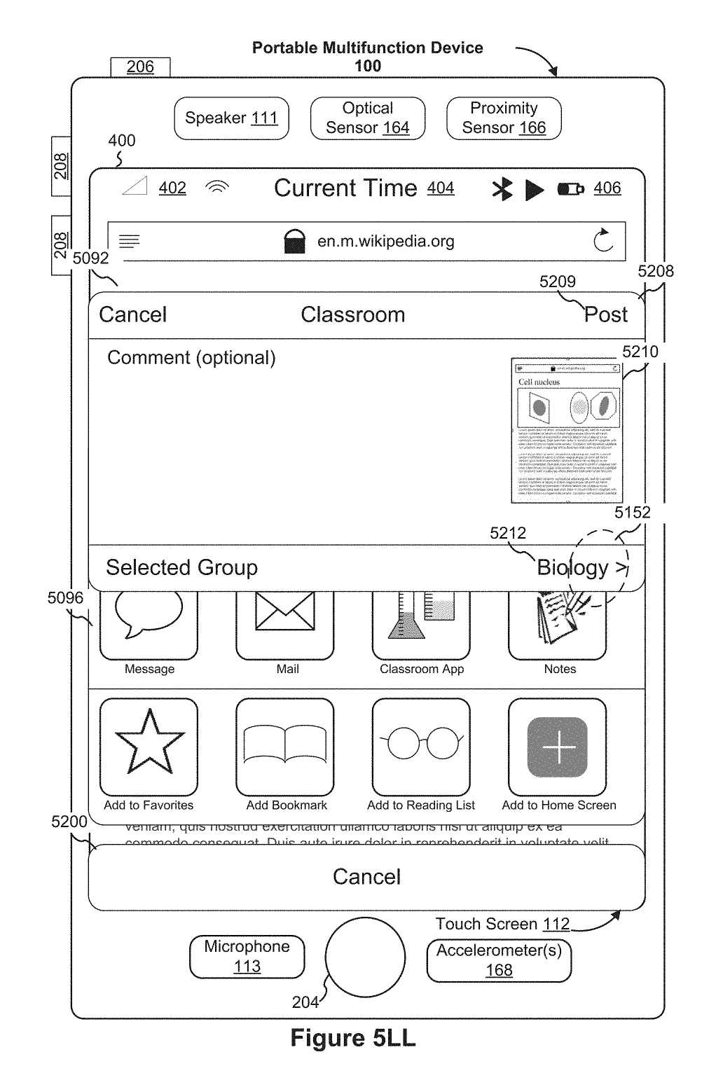

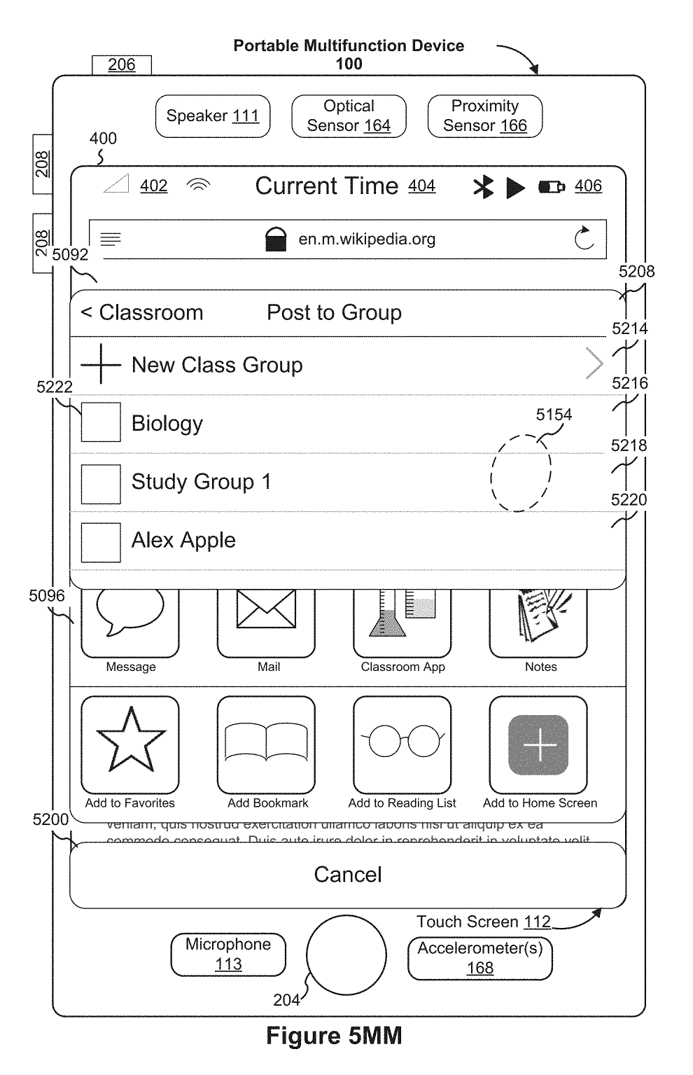

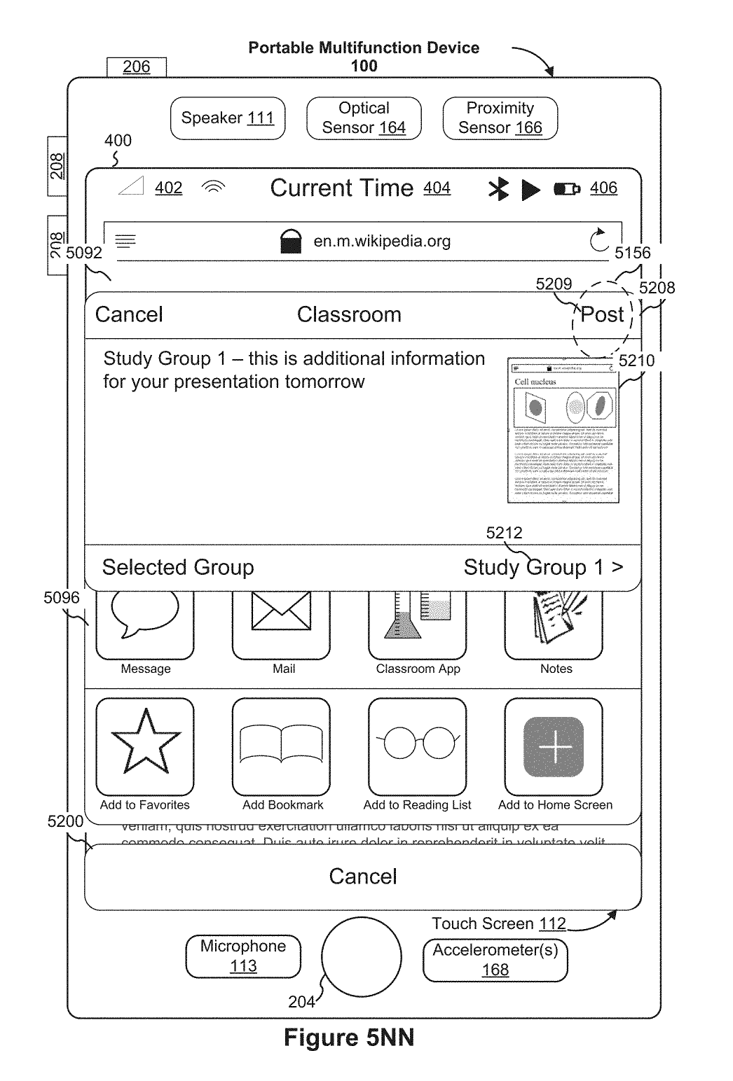

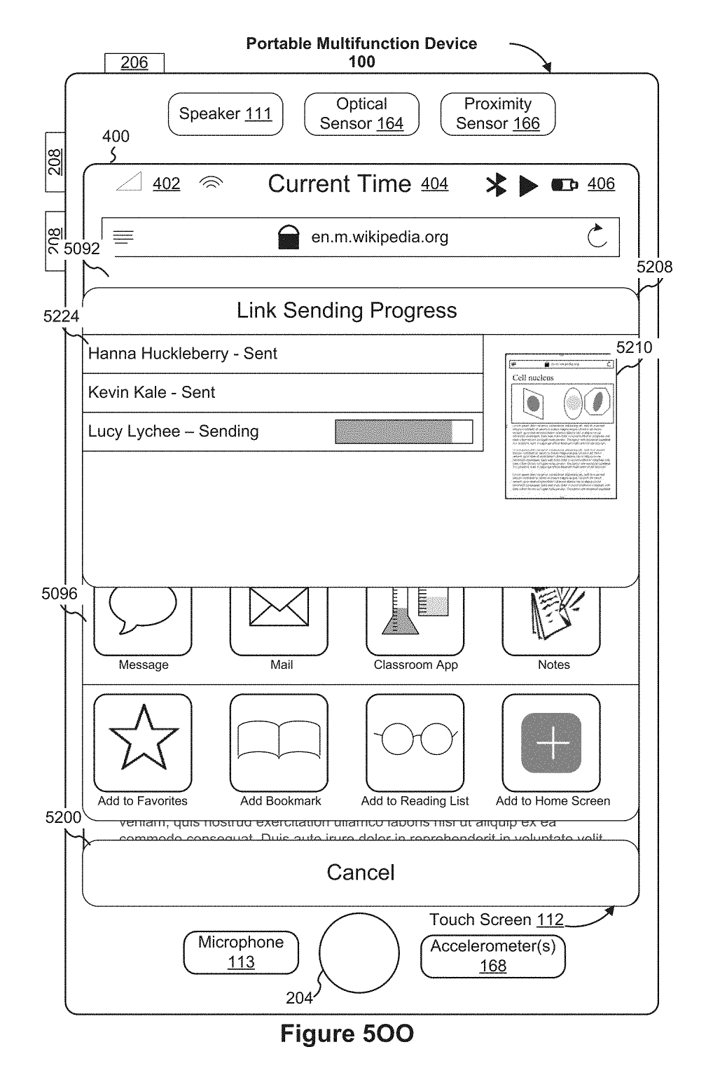

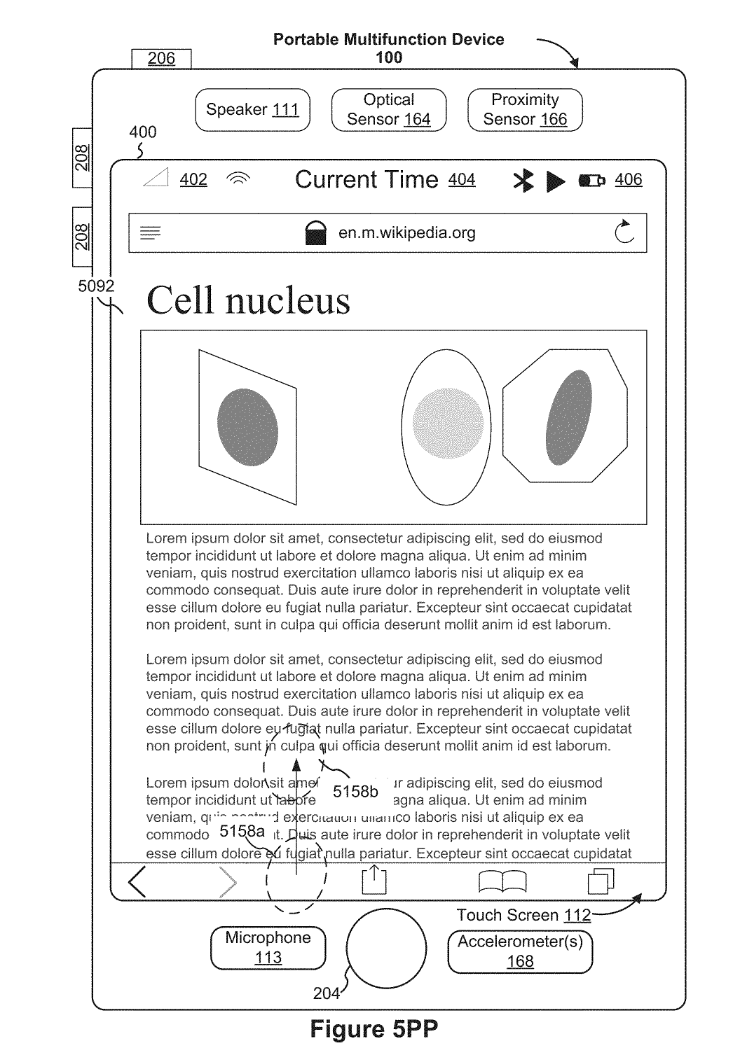

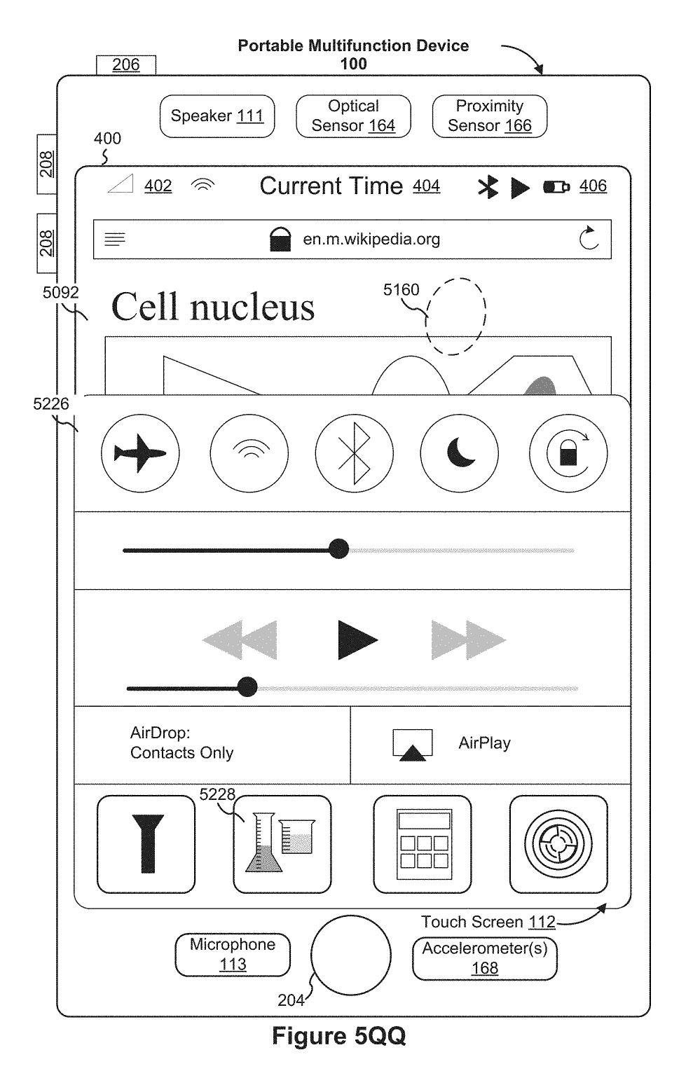

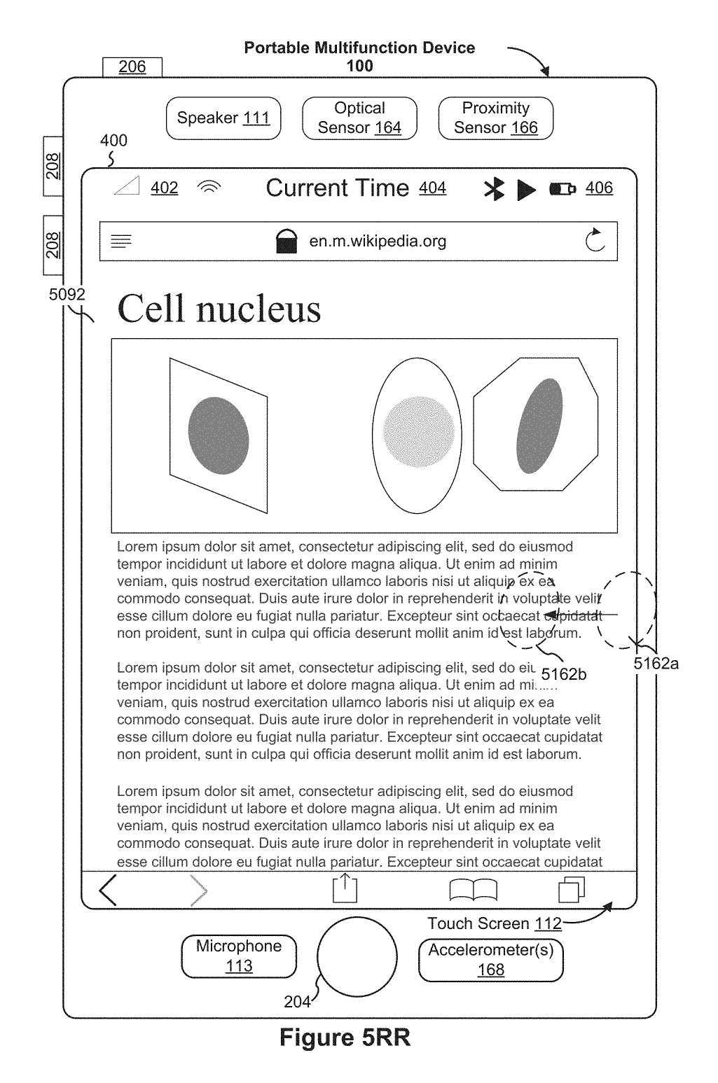

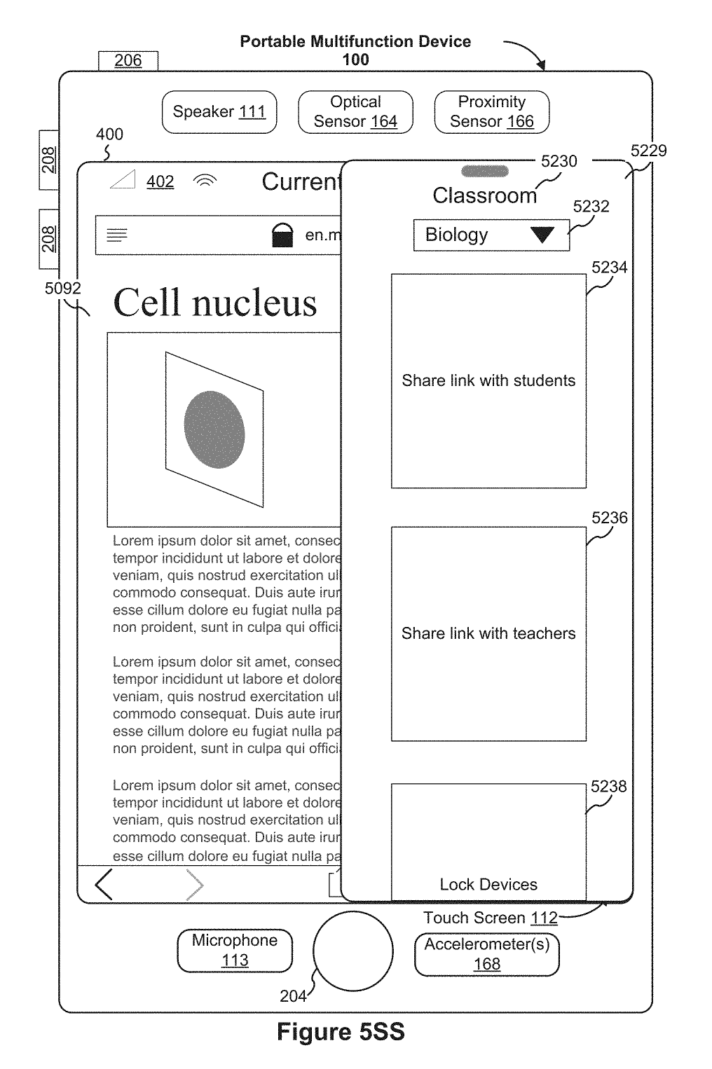

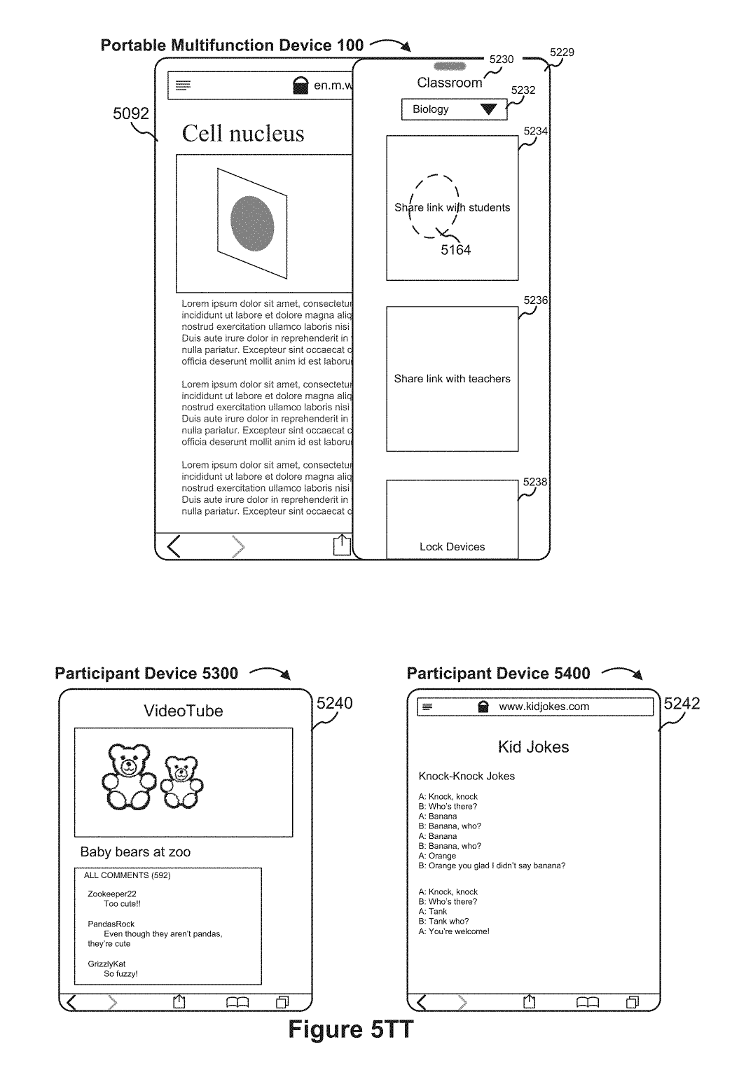

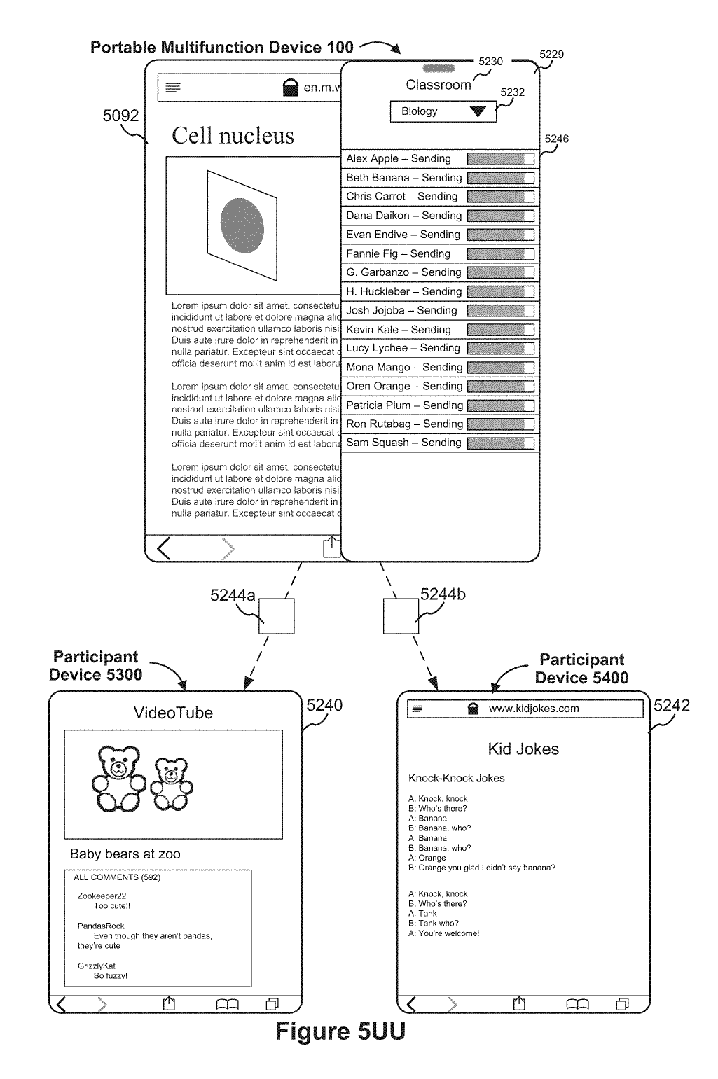

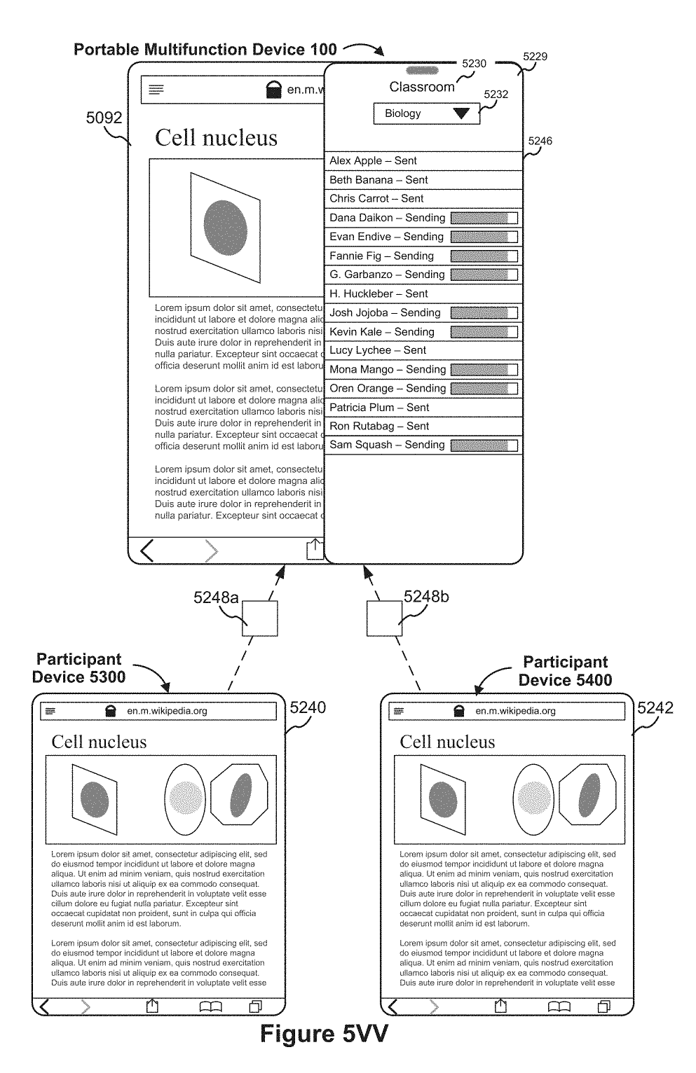

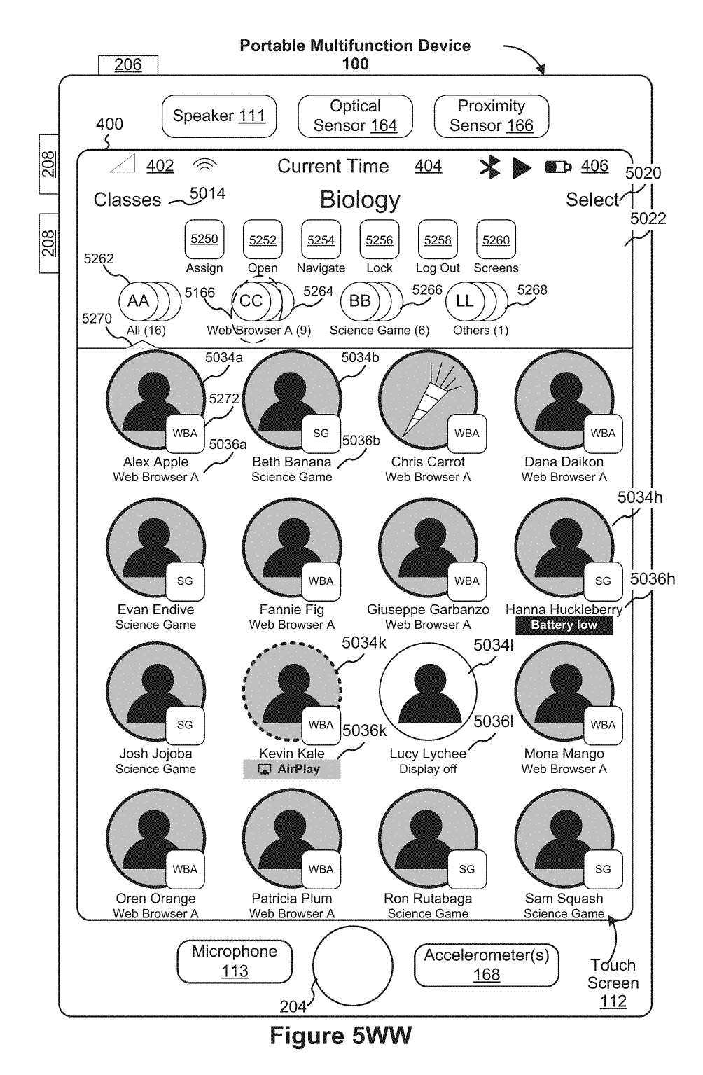

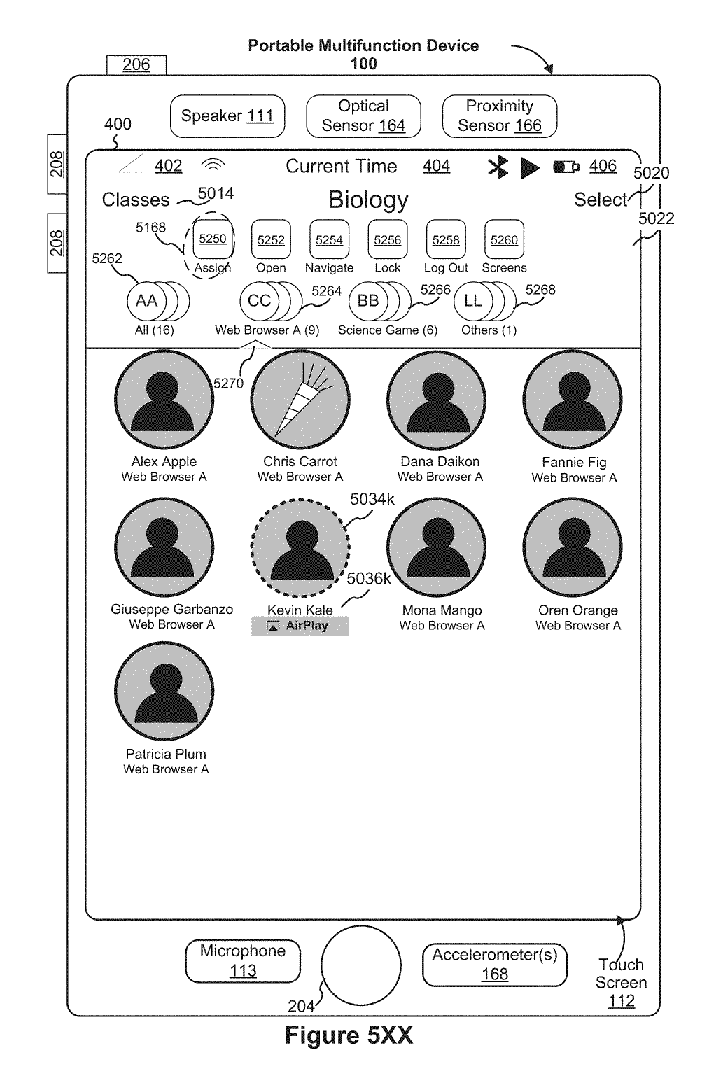

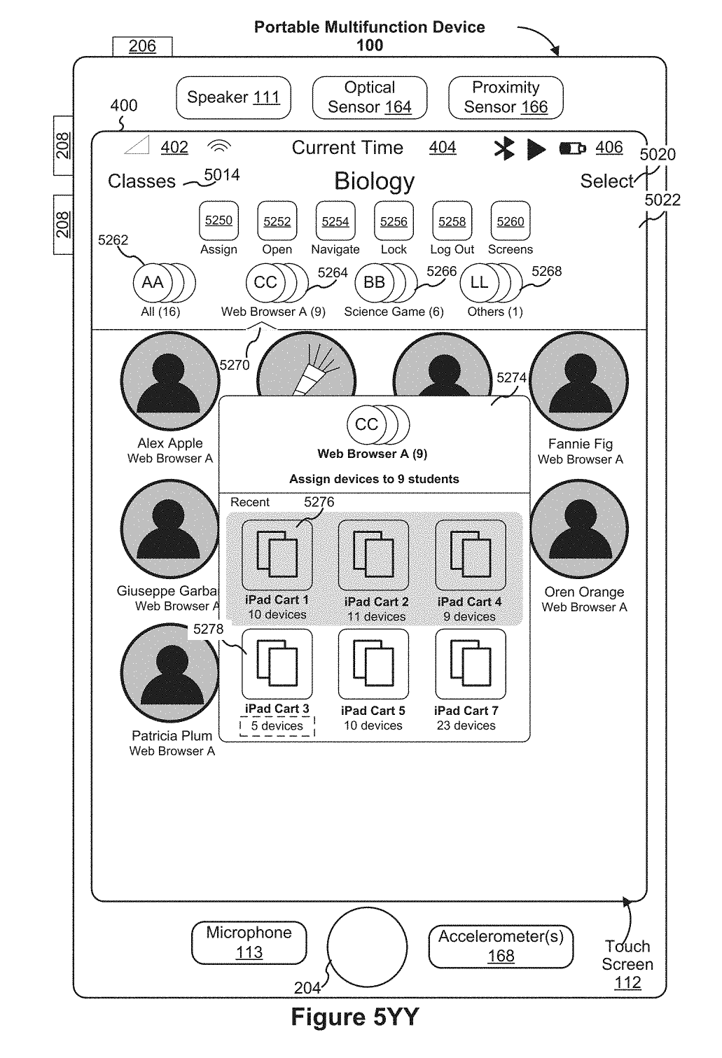

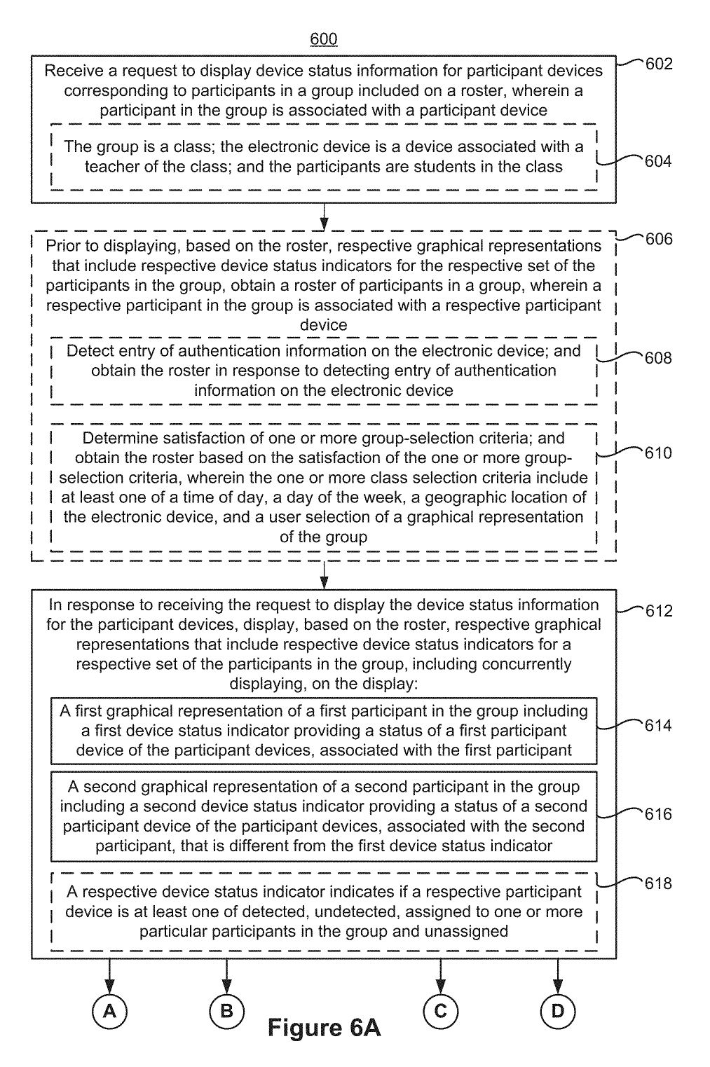

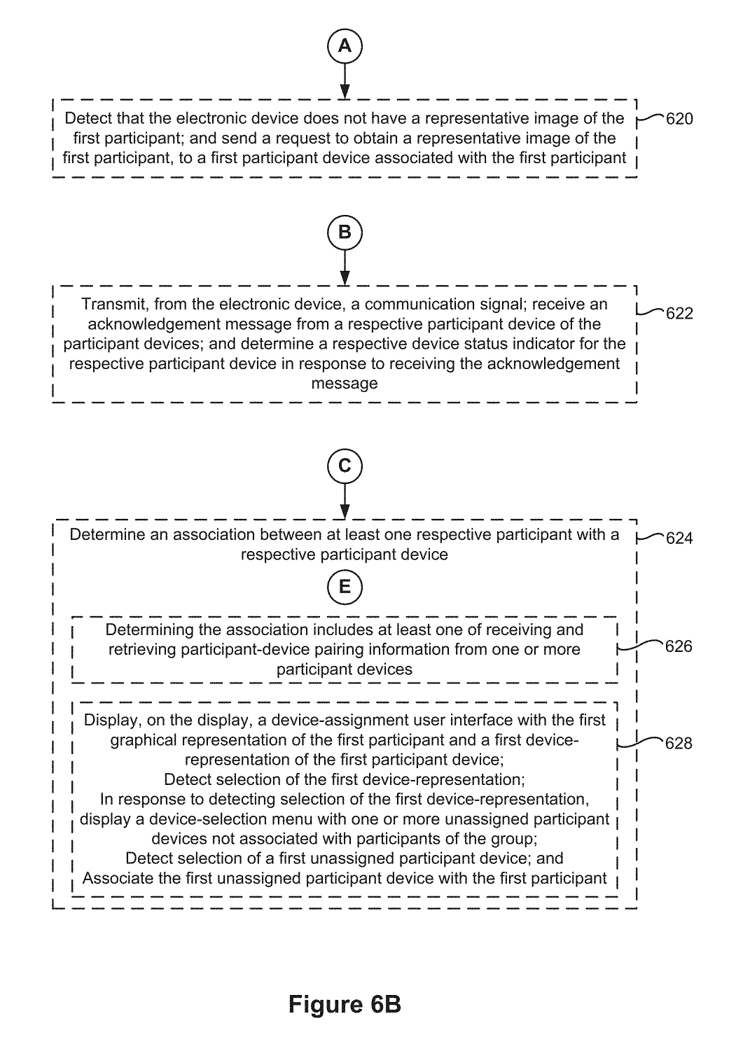

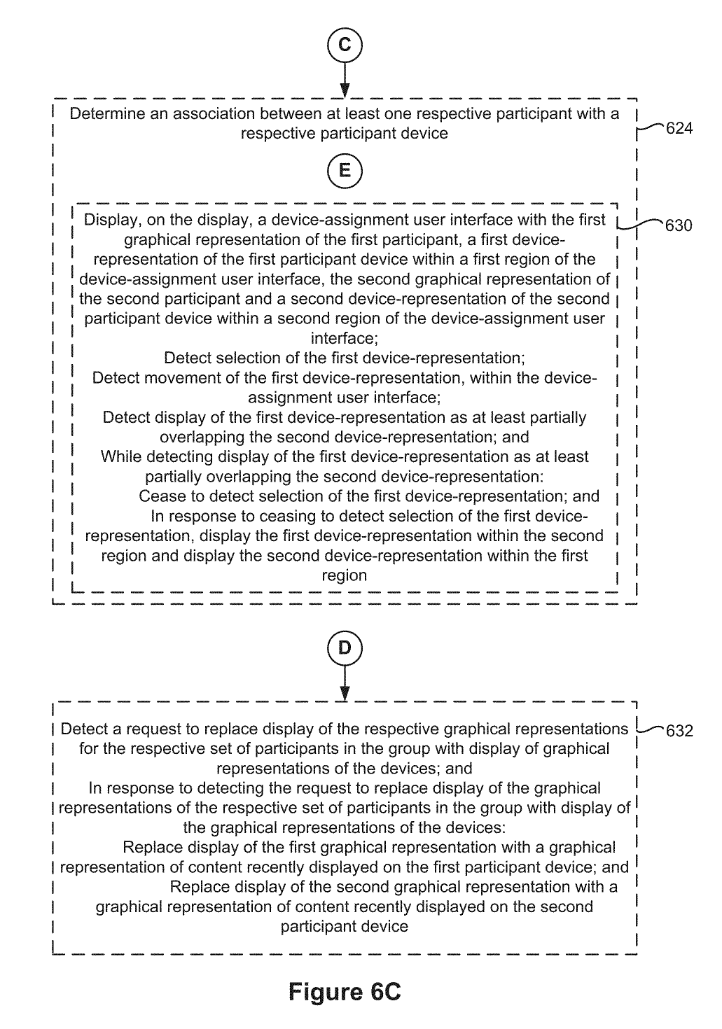

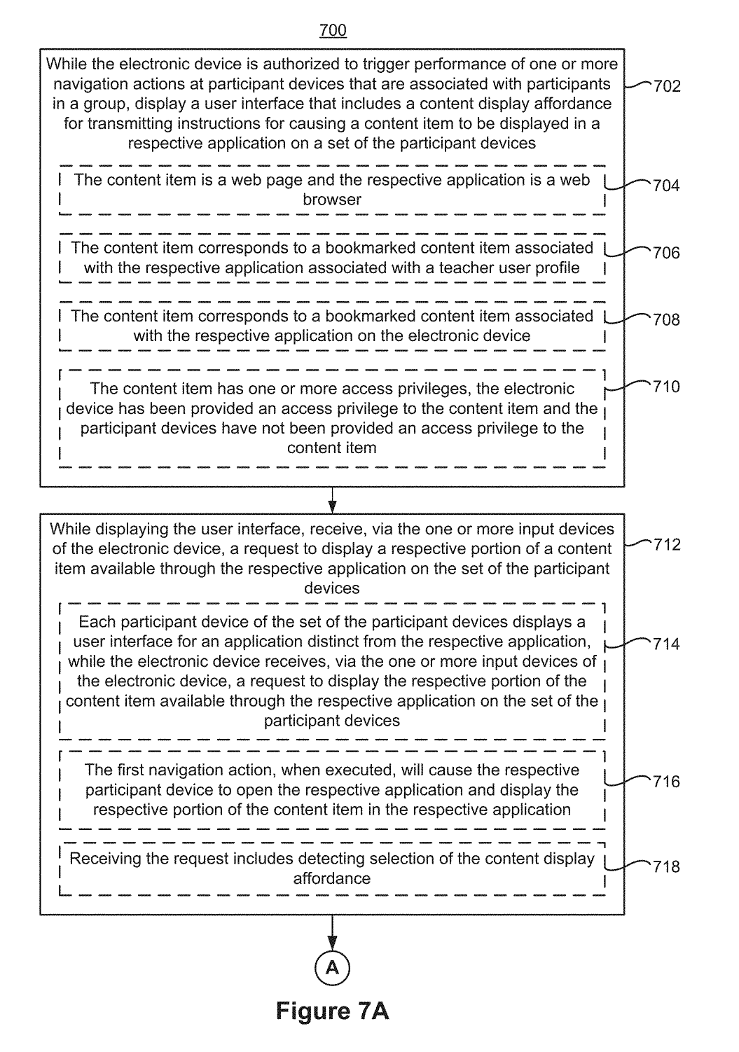

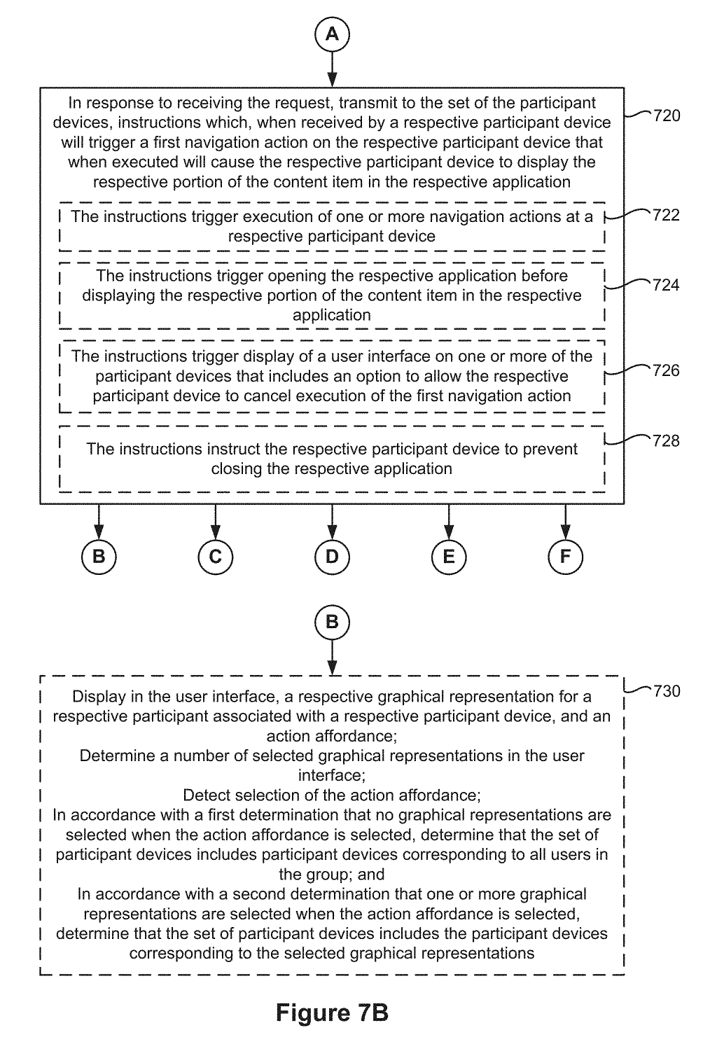

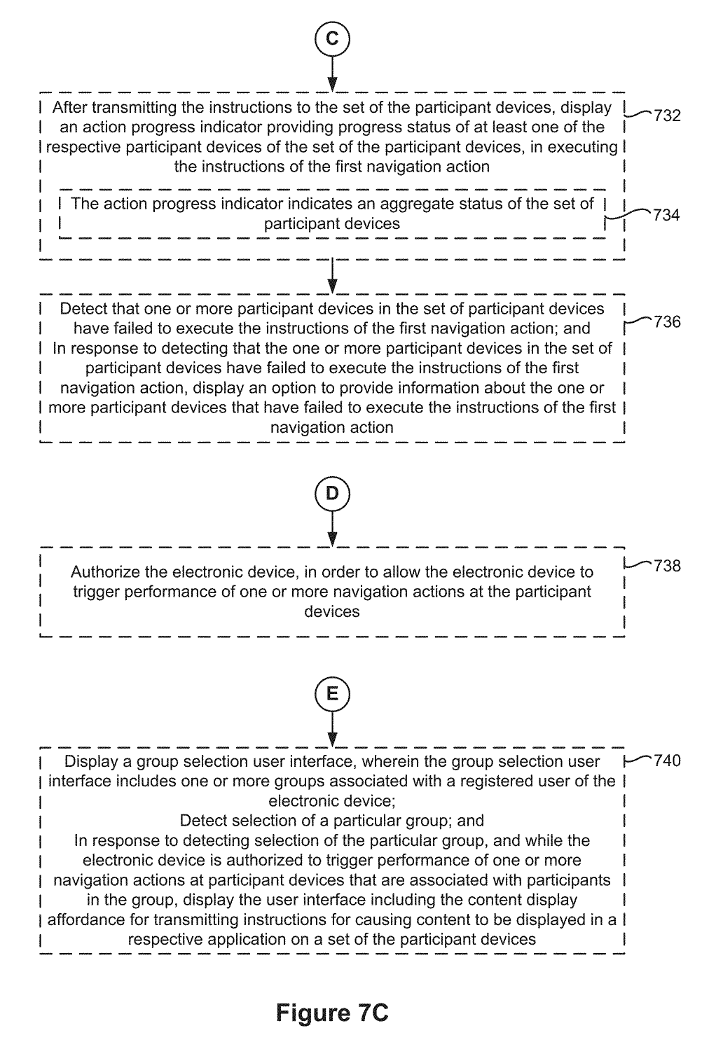

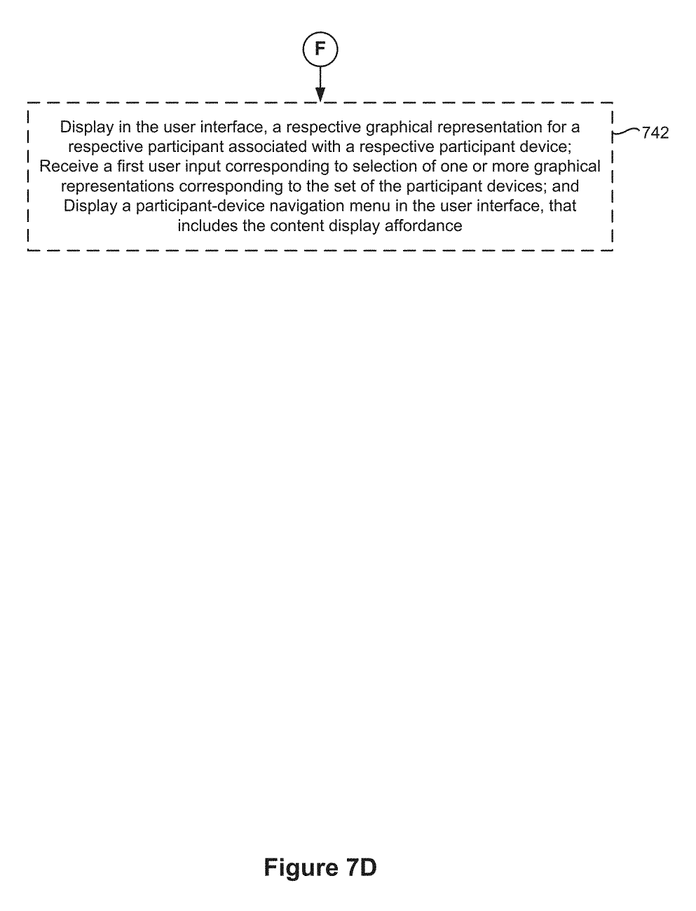

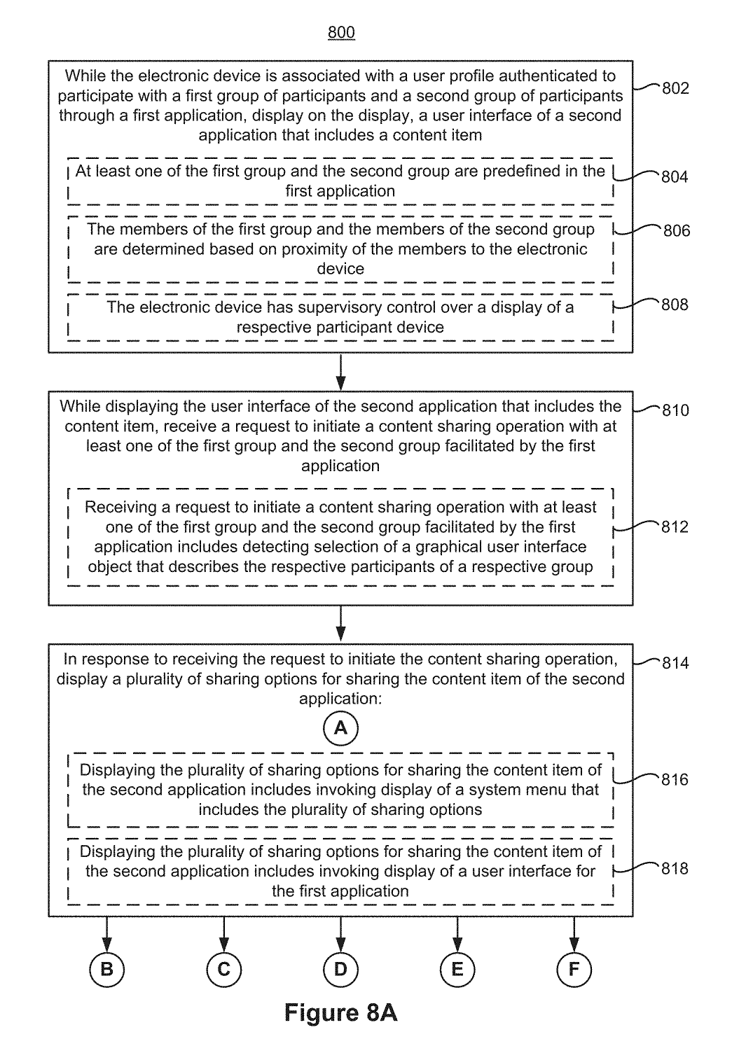

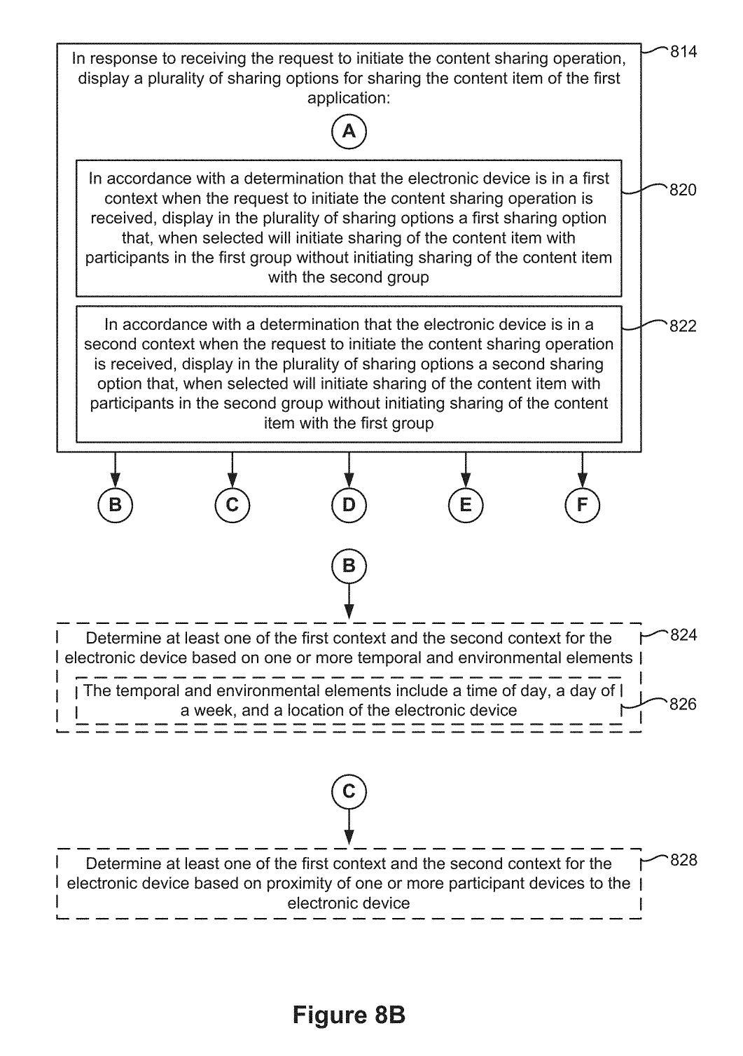

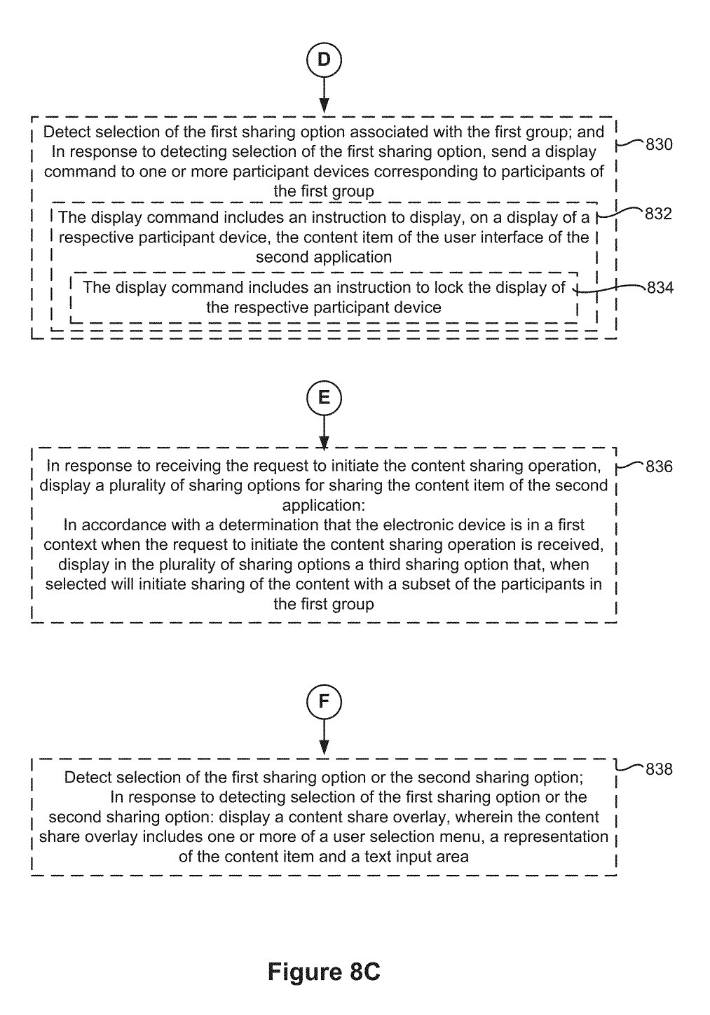

Below, FIGS. 1A-1B, 2, and 3 provide a description of example devices. FIGS. 4A-4B and 5A-5YY illustrate user interfaces for enabling management of the displays of other devices in accordance with some embodiments. FIGS. 6A-6C illustrate a flow diagram of a method of displaying graphical representations of participants and device status information for participant devices corresponding to the participants. FIGS. 7A-7D illustrate a flow diagram of a method of transmitting instructions to perform a navigation action at a participant device. FIGS. 8A-8C illustrate a flow diagram of a method of enabling sharing of a content item in one application, with participants associated with another application. The user interfaces in FIGS. 5A-5II and 5WW-5YY are used to illustrate the processes in FIGS. 6A-6C, and 7A-7D, and the user interfaces in FIGS. 5JJ-5VV are used to illustrate the processes in FIGS. 8A-8C.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller (e.g., processor(s)) 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 163 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by user movement. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

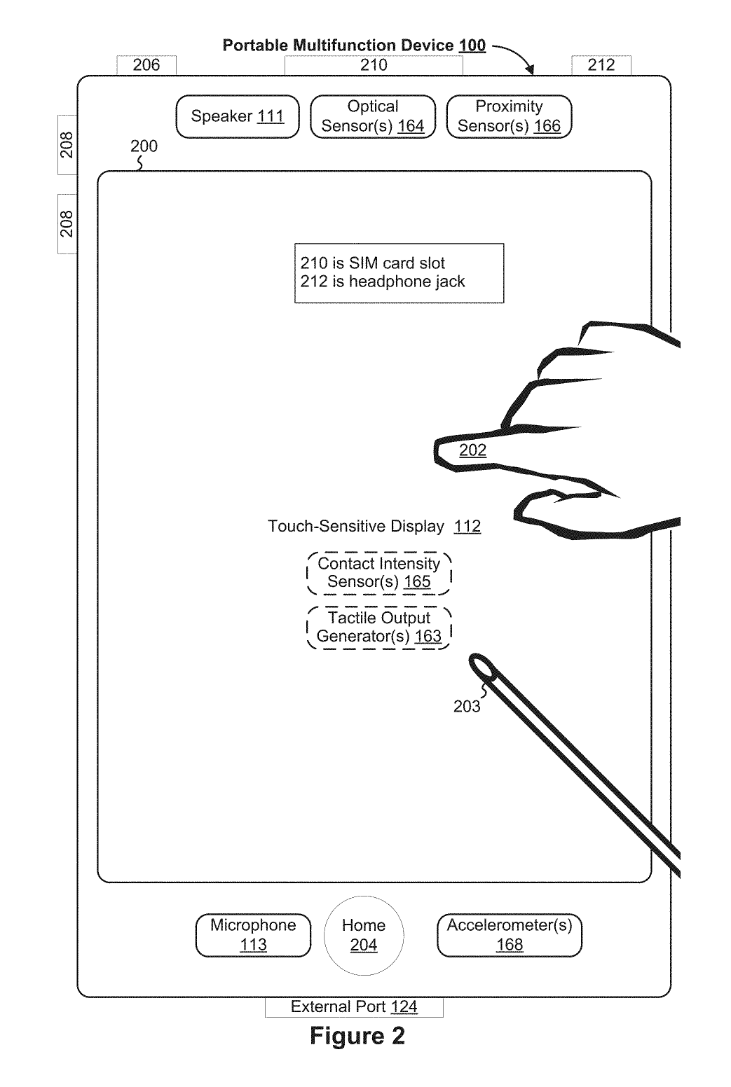

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user-interface objects.

Touch-sensitive display system 112 has a touch-sensitive surface, sensor or set of sensors that accepts input from the user based on haptic/tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, Calif.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that an image of the user is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 163. FIG. 1A shows a tactile output generator coupled with haptic feedback controller 161 in I/O subsystem 106. Tactile output generator(s) 163 optionally include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 163 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 167, gyroscopes 168, and/or magnetometers 169 (e.g., as part of an inertial measurement unit (IMU)) for obtaining information concerning the position (e.g., attitude) of the device. FIG. 1A shows sensors 167, 168, and 169 coupled with peripherals interface 118. Alternately, sensors 167, 168, and 169 are, optionally, coupled with an input controller 160 in I/O subsystem 106. In some embodiments, information is displayed on the touch-screen display in a portrait view or a landscape view based on an analysis of data received from the one or more accelerometers. Device 100 optionally includes a GPS (or GLONASS or other global navigation system) receiver (not shown) for obtaining information concerning the location of device 100.

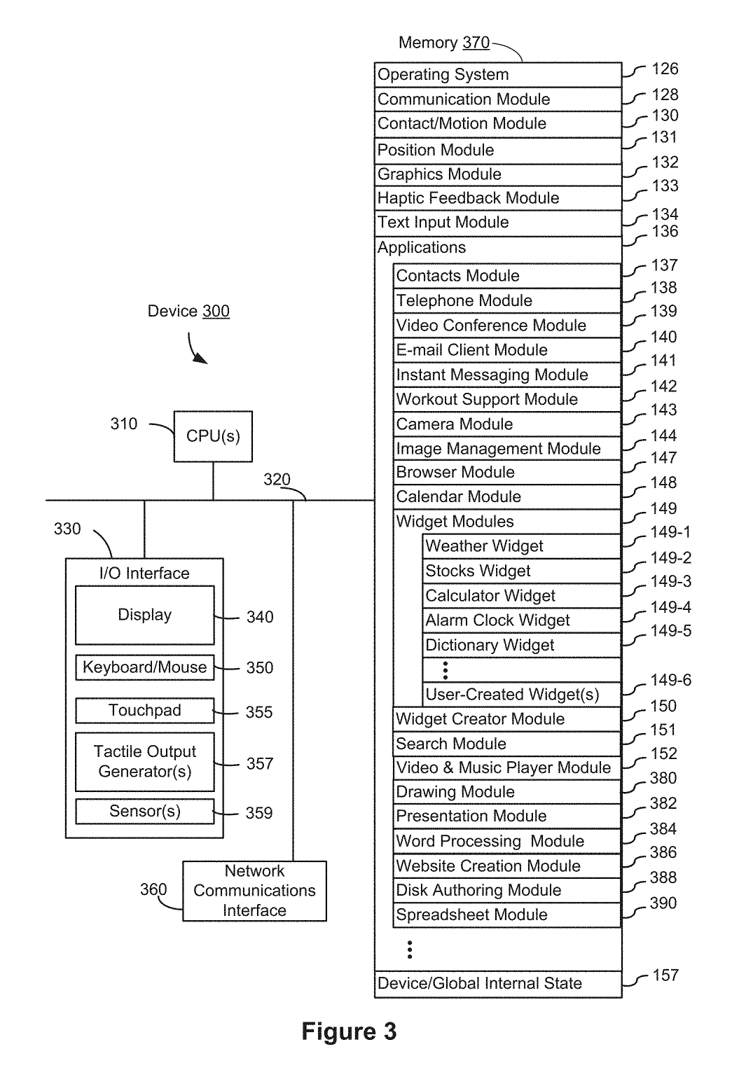

In some embodiments, the software components stored in memory 102 include operating system 126, communication module (or set of instructions) 128, contact/motion module (or set of instructions) 130, position module (or set of instructions) 131, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from various sensors and other input or control devices 116; and location and/or positional information concerning the location and/or attitude of the device.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, Calif. In some embodiments, the external port is a Lightning connector that is the same as, or similar to and/or compatible with the Lightning connector used in some iPhone®, iPod Touch®, and iPad® devices from Apple Inc. of Cupertino, Calif.

Contact/motion module 130 optionally detects contact with touch-sensitive display system 112 (in conjunction with display controller 156) and other touch-sensitive devices (e.g., a touchpad or physical click wheel). Contact/motion module 130 includes software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts and/or stylus contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

Position module 131, in conjunction with accelerometers 167, gyroscopes 168, and/or magnetometers 169, optionally detects positional information concerning the device, such as the device's attitude (roll, pitch, and/or yaw) in a particular frame of reference. Position module 130 includes software components for performing various operations related to detecting the position of the device and detecting changes to the position of the device. In some embodiments, position module 131 uses information received from a stylus being used with the device to detect positional information concerning the stylus, such as detecting the positional state of the stylus relative to the device and detecting changes to the positional state of the stylus.

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 163 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display system controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display system controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display system controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating components for event handling in accordance with some embodiments. In some embodiments, memory 102 (in FIGS. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 167, gyroscope(s) 168, magnetometer(s) 169, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensity of contacts on touch-sensitive display system 112 and/or one or more tactile output generators 163 for generating tactile outputs for a user of device 100.

FIG. 3 is a block diagram of a multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 163 described above with reference to FIG. 1A), sensors 359 (e.g., touch-sensitive, optical, contact intensity, proximity, acceleration, attitude, and/or magnetic sensors similar to sensors 112, 164, 165, 166, 167, 168, and 169 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates a user interface for a menu of applications on portable multifunction device 100 in accordance with some embodiments. Similar user interfaces are, optionally, implemented on device 300. In some embodiments, user interface 400 includes the following elements, or a subset or superset thereof:

Signal strength indicator(s) 402 for wireless communication(s), such as cellular and

Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, also referred to as iPOD (trademark of Apple Inc.) module 152, labeled “iPod”; and
Icons for other applications, such as:
   Icon 424 for IM module 141, labeled “Text;”
   Icon 426 for calendar module 148, labeled “Calendar;”
   Icon 428 for image management module 144, labeled “Photos”;
   Icon 430 for camera module 143, labeled “Camera”;
   Icon 432 for online vide
   module 155, labeled “Online Video”;
   Icon 434 for stocks widget 149-2, labeled “Stocks”;
   Icon 436 for map module 154, labeled “Map”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates a user interface on a device (e.g., device 300, FIG. 3) with a touch-sensitive surface 451 (e.g., a tablet or touchpad 355, FIG. 3) that is separate from the display 450. Device 300 also, optionally, includes one or more contact intensity sensors (e.g., one or more of sensors 359) for detecting intensity of contacts on touch-sensitive surface 451 and/or one or more tactile output generators 359 for generating tactile outputs for a user of device 300.

Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that includes a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device, such as portable multifunction device 100 or device 300, with a display, and optionally a touch-sensitive surface.

FIGS. 5A-5YY illustrate user interfaces for enabling an electronic device to manage the displays of other devices in accordance with some embodiments. The user interfaces in these figures are used to illustrate the processes described below in FIGS. 6A-6C, FIGS. 7A-7D and FIG. 8A-8C. Although some of the examples which follow will be given with reference to inputs on a touch-screen display (where the touch-sensitive surface and the display are combined), in some embodiments, the device detects inputs on a touch-sensitive surface or another input device that is separate from the display of the device.

As shown in FIGS. 5A-5YY, a supervisory device (e.g., portable multifunctional device 100 of FIG. 1A) displays one or more user interfaces with a plurality of user interface objects and/or affordances to enable management of the displays of other electronic devices, distinct from the supervisory device (e.g., portable multifunctional device 100 of FIG. 1A). For example, a teacher is associated with the supervisory device displaying the user interfaces of FIGS. 5A-5YY, and the supervisory device manages the displays of one or more participant devices being used by one or more students of the class or group. In some embodiments, the user interfaces of FIGS. 5A to 5II and FIG. 5WW-5YY are associated with a first application that facilitates the management of displays of participant devices. FIGS. 5JJ-5SS illustrate user interfaces of a second application, which enables sharing of a content item with participant devices associated with the first application. FIGS. 5TT-5VV illustrate examples of communication between a supervisory device and a plurality of participant devices.

FIG. 5A illustrates a class selection user interface 5010, used, for example, to select a class 5002. In some embodiments, a class is also, or alternatively a seminar, study session or a group that is either predefined or created ad hoc. In some embodiments, formation of an ad hoc group is done on the basis of selection by a user of a supervisory device (e.g., device 100), or proximity of participant devices to the supervisory device. In the class selection user interface 5010 of FIG. 5A, six example classes are shown, Art I 5002a, Art II 5002b, Biology 5002c, Chemistry 5002d, Geography 5002e and History 5002f. In some embodiments, a class 5002 has an associated graphical representation 5004, such as graphical representation 5004a for Art I class 5002a. In some circumstances, device 100 is associated with a user who is a teacher, and based on the identification of the teacher, the device is provisioned with information about the teacher's classes (e.g., class names, class rosters, class locations), and the list of classes displayed on the device is generated based on the classes that are associated with the teacher. In some embodiments, a respective class 5002 has an associated label 5006, such as label 5006a indicating information such as the name of class 5002a, the days of the week the class 5002a meets, the meeting time(s) of class 5002a, the size of class 5002a, the location of class 5002a and/or other relevant information about class 5002a. In some embodiments, an information affordance 5012, such as 5012a for class 5002a, provides display of additional information when selected. In some embodiments, a class selection user interface 5010 also includes a class viewing user interface object 5008, which allows switching between displaying various sets of classes 5002 in class selection user interface 5010. For example, in FIG. 5A, class viewing user interface object 5008 allows for switching between the display of all classes 5002, classes associated with a user of the device (e.g., a teacher associated with the device), and classes that are currently in session. In some embodiments, a listing of classes 5002 in user interface 5010 includes additional classes 5002 that are not currently displayed in user interface 5010. In FIG. 5A, a user input 5100 (e.g., a touch input detected on a touch-sensitive display portraying user interface 5010), is detected on label 5006b associated with Biology class 5002c.

FIGS. 5B-5G illustrate examples of user interfaces for progressively developing a roster user interface 5022. FIG. 5B illustrates an example of a roster user interface 5022, before population of the roster user interface 5022 with one or more participants, or representations of participants, displayed in response to detecting user input 5100, in FIG. 5A. In some embodiments, a participant is a student, group member or user of a device under supervisory control by a supervisory device (e.g., device 100). In some embodiments, a respective participant is associated with one or more participant devices. For example, a student in the Biology class uses a particular tablet electronic device for the entire school year. In another example, a student in a third grade class uses any participant device of a set of participant devices assigned to the class, for a given session. In some embodiments, roster user interface 5022 is associated with a particular class, group session, seminar or event. In some embodiments, roster user interface 5022 is associated with a selected class from class selection user interface 5010 in FIG. 5A.

FIG. 5B illustrates examples of user interface objects in roster user interface 5022. A class selection affordance 5014 provides display of the class selection user interface 5010, of FIG. 5A, upon detection of selection of class selection affordance 5014. A device assignment affordance 5016, provides display of a device assignment user interface, upon detection of selection of device assignment affordance 5016. The roster user interface 5022 shown in FIG. 5B includes a group selection menu 5018. The group selection menu 5018 provides display of a listing of sets of representations of corresponding participants (hereinafter referred to as “participants” for brevity) associated with a particular class associated with the roster user interface 5022. FIG. 5B illustrates a current selection of all the students of the Biology class in group selection menu 5018. A participant selection affordance 5020, allows for selection of particular participants or representations thereof, in roster user interface 5022. In some embodiments, selection of one or more participants enables management of displays of participant devices corresponding to the selected participants.

The roster user interface 5022 shown in FIG. 5B, includes an action affordance 5024. In some embodiments, action affordance 5024 launches a selection of one or more navigation actions, to perform on one or more participant devices associated with the particular class represented by roster user interface 5022. In some embodiments, a participant device connectivity indicator 5026 indicates how many participant devices, associated with roster user interface 5022 and/or the selected group of group selection menu 5018, are detected by a supervisory device (e.g., device 100). For example, in FIG. 5B, zero participant devices are detected, out of a potential sixteen participant devices associated with the roster of the Biology class. In this example, FIG. 5B illustrates a roster user interface 5022 before a supervisory device (e.g., device 100) has ever detected any participant devices associated with the roster of the Biology class (e.g., the teacher's device is aware of the students in the roster of the class before the students have been assigned devices so as to enable the teacher to easily identify students without assigned devices or students whose devices are not functioning properly).

In some embodiments, a roster of participants is obtained by a supervisory device (e.g., device 100) upon selection of a class associated with the roster. In some embodiments, a roster is obtained upon authorization of a user account associated with an application displaying roster user interface 5022. For example, a teacher logs into a participant device management application and/or logs into a supervisory device (e.g., device 100), to authorize the teacher user account and obtain one or more rosters associated with the teacher user account. In some embodiments, roster user interface 5022 includes a device-display affordance 5028, for displaying a user interface including representations of the displays of respective devices. Roster user interface 5022 includes a tips or information affordance 5030, to provide information about one or more aspects of a first application hosting roster user interface 5022 and optionally additional user interfaces. In some embodiments, roster user interface includes additional user interface objects or affordances, such as a tools affordance 5032 providing additional functionality for a user of a supervisory device and/or an application hosting roster user interface 5022.

FIG. 5B also illustrates that in some embodiments, roster user interface 5022 has one or more zones 5033, where a respective zone 5033 corresponds to an area of roster user interface 5022 reserved for the display of a respective graphical representation and/or text for a particular participant of a roster of roster user interface 5022. In some embodiments, zones 5033 are non-overlapping with each other and in some embodiments, zones 5033 overlap to some extent with one another. In some embodiments, graphical representations of participants are displayed in zones 5033 in alphabetical order. In some embodiments, zones 5033 change in size and number, depending on a selected viewing size for one or more elements displayed in zones 5033.

FIG. 5C illustrates a plurality of graphical representations 5034, of participants. In some embodiments, a respective participant (e.g., a student), of a roster corresponding to roster user interface 5022 (e.g., a student of the Biology class), has a respective graphical representation 5034. For example, a graphical representation 5034a corresponds to a first student of the roster of roster user interface 5022, and graphical representation 5034b corresponds to a second student of the roster. In some embodiments, a graphical representation 5034 is a default image, such as an empty circle, a logo, or a monogram. FIG. 5C illustrates display of default graphical representations 5034 for the plurality of participants of roster user interface 5022. In some embodiments, roster user interface 5022 includes one or more participant labels 5036, where a respective participant label corresponds to a respective participant of the roster. In some embodiments, a participant label includes information corresponding to the participant, an associated graphical representation 5034 and/or a participant device associated with the participant. For example, participant label 5036a indicates that a device corresponding to the first student, is not yet found. In some embodiments, a respective participant label includes a device status indicator, such as text (e.g., Device not found), an icon or graphic (e.g., a green dot for a device that is found) or another audio-visual element (e.g., an animation).

In some embodiments, FIG. 5C illustrates an intermediate version of roster user interface 5022, before all the participants and/or participant devices of a roster are identified and/or detected. In some embodiments, FIG. 5C illustrates an example of a roster user interface 5022 for a class, seminar, session and/or event without a predefined listing of particular participants (e.g., a seminar with students that register and/or sign into devices for the first time).

FIG. 5D illustrates an example of a roster user interface 5022 with a roster of identified participants. For example, one or more of the identified participants of roster user interface 5022 in FIG. 5D, are students from an obtained, pre-defined roster of students. In another example, one or more of the identified participants of roster user interface 5022 are obtained as a result of participants registering and/or signing into participant devices. In some embodiments, a respective participant label 5036a changes, upon identification of a respective participant of the roster. For example, label 5036a changed from “Student #1” in roster user interface 5022 in FIG. 5C to “Alex Apple” in FIG. 5D.

FIG. 5E illustrates an example of a roster user interface 5022 with a roster of identified participants, and at least one obtained and/or updated graphical representation 5034 for at least one of the identified participants. In some embodiments, a respective participant has a graphical representation 5034, associated with the respective participant and/or the corresponding participant device. For example, participant Chris Carrot has selected an image of a carrot to be his graphical representation 5034c, and participant Fannie Fig has chosen a generic silhouette as her graphical representation 5034f. In some embodiments, a graphical representation is a logo, monogram, icon, image, graphic, animation, text, photograph, audiovisual element or any combination thereof.

FIG. 5F illustrates a progression of the development of roster user interface 5022, including the addition of an updated graphical representation 5034m for Mona Mango. Additionally, FIG. 5F illustrates detection of three participant devices, and corresponding updating of device status indicators (e.g., participant labels 5036c, 5036f and 5036m and/or corresponding modified graphical representations 5034) for the three detected participant devices, and participant device connectivity indicator 5026.

In the example of FIG. 5F, the participant device for Chris Carrot has been found connected. As a result, his corresponding graphical representation 5034 has been modified so that it has a bold outline and a darkened background. In some embodiments, when a respective participant device corresponding to a respective participant of the roster is detected, the respective graphical representation 5034 and/or respective label 5036 associated with the participant is modified. In some embodiments, in order to establish connectivity with one or more participant devices, a supervisory device (e.g., device 100) sends out a communication (e.g., a transmission beacon). In such embodiments, a respective participant device detects the communication and returns a success response (e.g., an acknowledgement) to the supervisory device. In some embodiments, the communication sent by the supervisory device includes a request for identifying information, and/or includes a set of instructions. In some embodiments, the respective participant device returns identifying information with the success response, such as a name of an associated participant, a graphical representation, a device serial number and/or battery life information of the respective participant device. In some embodiments, the supervisory device uses a success response and/or identifying information obtained from a respective participant device to establish its connectivity.

FIG. 5G illustrates further progression of the development of roster user interface 5022, including detecting fifteen connected devices, as indicated by participant device connectivity indicator 5026, and fifteen updated device status indicators (e.g., modification of fifteen graphical representations 5034 and/or participant labels 5036). FIG. 5G illustrates that a graphical representation 5034b corresponding to a participant (e.g., Beth Banana), is not associated with a connected device, and that a graphical representation 5034e corresponding to a participant (e.g., Evan Endive), is a default or null representation (e.g., because a custom representation of the participant such as a photo of the participant has not been provided by the participant). In some embodiments, the default or null representation of a participant is a monogram for the participant that is composed of some or all of the participant's initials. FIG. 5H illustrates detection of user input 5102 (e.g., a touch input on a touch-sensitive display) on device assignment affordance 5016 that provides display of a device assignment user interface, upon detection of selection of device assignment affordance 5016.

FIGS. 5I-5N illustrate examples of aspects of associating participants in the group with participant devices, using a device assignment user interface 5050. FIG. 5I illustrates display of an example of a device assignment user interface 5050, for managing the assignment of participant devices to respective participants of the roster, in response to detecting user input 5102 on device assignment affordance 5016, in FIG. 5H. In some embodiments, device assignment user interface 5050 corresponds to the roster of roster user interface 5022, before detection of a user input causing display of device assignment user interface 5050. For example, in FIG. 5H, graphical representations of the roster of the entire Biology class were displayed in roster user interface 5022, therefore the user interface elements of device assignment user interface 5050 correspond to the entire Biology class as well.

In some embodiments, device assignment user interface 5050 includes one or more graphical representations 5034, where a respective graphical representation corresponds to a respective participant (e.g., student). As illustrated by graphical representations 5034a and 5034b, in some embodiments, a respective graphical representation 5034 differs in appearance if it is associated with a connected and/or recognized participant device. For example, graphical representation 5034a is associated with a connected participant device, and therefore has a darkened background and bold outline around the image. In this same example, graphical representation 5034b is displayed without a darkened background and bold outline, because there is not a currently connected participant device associated with graphical representation 5034b.

In some embodiments, a device assignment user interface 5050 includes one or more device representations 5046, where a respective device representation 5046 corresponds to a respective participant device (e.g., a student's tablet). In some embodiments, a device representation 5046 differs in appearance if its associated participant device is connected or not connected. For example, device representation 5046a corresponds to a connected device, and is represented with a solid outline, opaque image, text, and/or some other audio-visual element. In this same example, device representation 5046b corresponds to an unconnected device, and is represented with a dotted outline, semi-transparent image, text and/or some other audio-visual element, or a lack thereof. In some embodiments, a respective device representation 5046 includes a live representation of what is being displayed on the display of a respective connected device. For example, a respective device representation 5046 shows that its associated participant device is displaying a video game on the display of the associated participant device. In some embodiments, a respective device representation 5046 of device assignment user interface 5050 has one or more characteristics of device-display representations 5080, as described below with respect to FIG. 5S. In some embodiments, a respective device representation 5046 includes a default image, and in some embodiments, a respective device representation 5046 includes a default image with proportional dimensions to the display of its corresponding participant device (e.g., an image of a display of a first type of tablet differs in size from an image of a display of a second type of tablet).

In some embodiments, a device assignment user interface 5050 includes one or more device labels 5048, where a respective device label 5048 corresponds to a respective device representation 5046, and includes information about a corresponding participant device, such as a name, type, battery life, duration of connectivity and/or serial number. In some embodiments, a respective device label 5048 differs in appearance or content, depending on whether its corresponding participant device is connected or not. For example, the text of device label 5048a is black, or opaque in color, while the text of device label 5048b is gray or semi-transparent in color. In some embodiments, a device label 5046 for an unconnected device retains the device information of the most recently connected device for the associated graphical representation. For example, device label 5048b indicates the name and type of participant device previously connected and associated with graphical representation 5034b.

In some embodiments, a device assignment user interface 5050 includes additional user interface elements, such as a roster user interface affordance 5038, to display the roster user interface 5022, of FIG. 5H. In some embodiments, the roster user interface affordance 5038, is also an indicator of the particular roster that was previously displayed in roster user interface 5022 (e.g., Biology). In some embodiments, the device assignment user interface 5050 includes a title 5040, and a device selection affordance 5042. In some embodiments, a device selection affordance 5042 allows for selection of a plurality of device representations 5046, and application of one or more actions on the participant devices represented by the plurality of device representations 5046. For example, a plurality of participant devices may be disconnected and/or connected by selecting a corresponding plurality of device representations 5046 and sending instructions to the participant devices of the selected plurality of device representations 5046. In some embodiments, device assignment user interface 5050 includes a scroll bar 5044, for displaying additional graphical representations 5034 and/or device representations 5046.

FIG. 5I also illustrates detection of user input 5104 on device representation 5046b, corresponding to an unconnected participant device. FIG. 5J illustrates display of a device selection menu 5052, in response to detecting user input 5104 on device representation 5046b, in FIG. 5I. In some embodiments, device selection menu 5052 includes one or more options for participant device assignment, such as disconnecting a device, replacing a device and/or attempting to reconnect to a device. FIG. 5J illustrates detection of selection of an option to replace the device, by user input 5105.

FIG. 5K illustrates a listing of available devices within device selection menu 5052, in response to detecting user input 5105. In some embodiments, a listing of available devices includes devices that are connected to a supervisory device (e.g., device 100), but are not associated with any other graphical representation 5034 and/or participant. FIG. 5K also illustrates detection of user input 5106 on a device in the listing of available devices (e.g., Device 34-465).

FIG. 5L illustrates display of device assignment user interface 5050 without display of device selection menu 5052, in response to detecting user input 5106, selecting an available device (e.g., device selection menu 5052 ceases to be displayed). FIG. 5L illustrates that graphical representation 5034b and device representation 5046b have changed in appearance, to indicate that they are now associated with a connected participant device. Device label 5048b has also been updated, to indicate the details of the newly connected participant device (e.g., Device 34-465). FIG. 5L also illustrates detection of a user input 5108 (e.g., a drag gesture to the left), starting at position 5108a, on device representation 5046j.

FIG. 5M illustrates that device representation 5046j is moved within device assignment user interface 5050, via user input 5108 (e.g., a dragging gesture to the left), shown at position 5108b. FIG. 5M also illustrates that in some embodiments, a device representation 5046, such as device representation 5046j, changes in appearance when it is moved from a first location to a second location within device assignment user interface 5050. For example, device representation 5046j was depicted in a first location, in FIG. 5L, in vertical alignment with one or more device representations 5046, and in horizontal alignment with one or more device representations 5046. In this same example, device representation 5046j is shown in a second location in FIG. 5M, in particular, partially overlapping device representation 5046a. In some embodiments, a respective device representation 5046 changes in appearance when it moves a predefined distance beyond the boundaries of a first location. For example, device representation 5046j changed in appearance when it was moved via user input 5108, 5 mm to the left. In some embodiments, a first device representation changes in appearance when a second device representation is displayed overlapping over the first device representation.

FIG. 5N illustrates a successful swapping of devices that were assigned to participants associated with graphical representation 5034a (e.g., Alex Apple), and graphical representation 5034j (e.g., Josh Jojoba). FIG. 5N also illustrates detection of user input 5110 on roster user interface affordance 5038.

FIG. 5O illustrates display of roster user interface 5022, in response to detecting user input 5110 in FIG. 5N. FIG. 5O also illustrates that graphical representation 5034b now appears with a darkened background and bold outline, an example of a modification to the appearance of a respective graphical representation 5034, when it is associated with a respective, connected participant device. In some embodiments, a participant device connectivity indicator 5026 is updated to reflect the change in the number of connected or found participant devices.

FIG. 5O also illustrates that an updated and/or personally-selected graphical representation 5034e (e.g., corresponding to Evan Endive) has not been obtained by a supervisory device (e.g., device 100). In some embodiments, a default image is displayed for a respective graphical representation 5034, if the respective participant associated with the respective graphical representation has not selected an image, logo or other representative audio-visual element, or has not taken a profile photograph. FIG. 5O also illustrates that user input 5112 is detected on graphical representation 5034e.

FIG. 5P illustrates display of a navigation action menu 5054, in response to detecting user input 5112 in FIG. 5O. In some embodiments, a navigation action menu 5054 includes one or more navigation action affordances (e.g., affordances 5060, 5062, 5064, 5066, 5068, 5070, 5072 and 5074), where a respective navigation action affordance corresponds to a particular navigation action. In some embodiments, a navigation action menu 5054 includes additional user interface elements, such as participant information 5058, which indicates information about one or more selected participants with participant devices to which one or more navigation actions can be performed through navigation action menu 5054, and one or more participant representations 5056. In some embodiments, participant information 5058 includes information such as the names, device names, device type and/or device status, corresponding to the one or more selected participants (e.g., Evan Endive and Device 34-449). In some embodiments, a navigation action is an action or set of commands, which affect the displays of one or more participant devices. In some embodiments, a respective navigation action can only be performed by a participant device associated with a respective participant in the roster of roster user interface 5022. In some embodiments, selection of a navigation action affordance (e.g., affordance 5060) in navigation action menu 5054, retrieves a set of instructions corresponding to the navigation action of the selected affordance, and transmits the set of instructions to one or more participant devices associated with one or more participants indicated by participant information 5058.

In some embodiments, a navigation action menu 5054 is displayed in response to detecting selection of a graphical representation, such as graphical representation 5034e, an action affordance 5024, a device representation or another user interface object or affordance within roster user interface 5022. In some embodiments, a navigation action menu 5054 includes one or more navigation action affordances, where each navigation action affordance corresponds to a respective navigation action.

In some embodiments, an “open application” navigation action, corresponding to navigation action affordance 5060, causes a particular application (e.g., a web browser or an educational game) or an instance of a particular application to be opened at a respective participant device corresponding to one or more participants identified by participant information 5058. In some embodiments, a “navigate” navigation action, corresponding to navigation action affordance 5062, causes a content item or a location within a particular application (e.g., a web page in a web browser or a chapter in an ebook) or an instance of a particular application to be opened at a respective participant device corresponding to one or more participants identified by participant information 5058. In some embodiments, a “lock display” navigation action, corresponding to navigation action affordance 5064, causes the displays of one or more respective participant devices corresponding to one or more participants identified by participant information 5058. In some embodiments, an “assign device” navigation action, corresponding to navigation action affordance 5068, launches a user interface for assigning one or more participant devices to the one or more participants identified by participant information 5058. In some embodiments, a “view display” navigation action, corresponding to navigation action affordance 5070, launches a user interface or user interface element for viewing the displays of one or more participant devices to the one or more participants identified by participant information 5058. In some embodiments, a “lock device” navigation action, corresponding to navigation action affordance 5072, causes locking or blocks user access to one or more respective participant devices corresponding to one or more participants identified by participant information 5058. In some embodiments, a “request profile photo” navigation action, corresponding to navigation action affordance 5074, sends a request for a respective participant profile photo to one or more respective participant devices corresponding to one or more participants identified by participant information 5058. The navigation action menu 5054 illustrates a set of examples of navigation action affordances, but one skilled in the art will recognize that this is not an exhaustive list of possible navigation actions, or corresponding navigation action affordances. FIG. 5P illustrates detection of user input 5114 on navigation action affordance 5074.

FIG. 5Q illustrates an example of a confirmation 5076 displayed in navigation action menu 5054, in response to detecting successful transmission of instructions corresponding to a respective navigation action. In this example, user input 5114 was detected on navigation action affordance 5074, in FIG. 5P, corresponding to sending a request for a profile photo.

FIG. 5R illustrates that an updated graphical representation 5034e has been received by a supervisory device (e.g., device 100), for participant Evan Endive, and is shown in roster user interface 5022. FIG. 5R also illustrates detection of user input 5116 on device-display affordance 5028.

FIG. 58 illustrates an example of a response to detecting user input 5116 on device-display affordance 5028, in FIG. 5R. As shown in the example of FIG. 5S, graphical representations 5034 are replaced for display within roster user interface 5022, with device-display representations 5080. For example, the graphical representation of 5034a, has been replaced with device-display representation 5080a. In some embodiments, a participant label 5036 for a respective participant of the group or roster of roster user interface 5022, remains displayed. In some embodiments, a device-display representation 5080 includes a live representation of what is currently displayed on a respective participant device. In some embodiments, a device-display representation 5080 includes a static representation of what is currently displayed on a respective participant device. In some embodiments, while displaying device-display representations 5080, the device-display affordance 5028 is replaced within roster user interface 5022, with a profile-display affordance 5078, to revert back to the view of roster user interface 5022 shown in FIG. 5R. FIG. 58 illustrates detection of user input 5118 on device-display representation 5080m.

FIG. 5T illustrates display of a live representation 5082 of what is displayed on the display of the participant device selected by user input 5118, in FIG. 5S. In this particular example, the live representation 5082 corresponds to what is displayed on the participant device associated with Mona Mango. In some embodiments, a live representation 5082 is displayed in portrait mode, and in some embodiments, a live representation 5082 is displayed in landscape mode, on a supervisory device (e.g., device 100). FIG. 5T also illustrates detection of user input 5120, on live representation 5082.

FIG. 5U illustrates display of navigation action menu 5054, overlaid on live representation 5082, as an example of a response to detecting user input 5118, in FIG. 5T. In some embodiments, navigation action menu 5054 has some or all of the characteristics of navigation action menu 5054, as described above. In some embodiments, navigation action menu 5054 has one or more different, or additional navigation actions, if it is displayed in response to detecting a user input while displaying live representation 5082. For example, if a teacher is viewing a live representation 5082 of the display of a participant device associated with a particular student, navigation action menu 5054 includes a navigation action to display a message on the display of the participant device, such as a warning to cease an activity. FIG. 5U illustrates detection of user input 5122 on profile-display affordance 5078.

FIG. 5V illustrates display of roster user interface 5022, in response to detecting user input 5122 on profile-display affordance 5078. FIG. 5V also illustrates detection of user input 5124 on participant selection affordance 5020.

FIG. 5W illustrates that in response to detecting selection of participant selection affordance 5020, in FIG. 5V, roster user interface 5022 changes to display participant selection affordances 5086, such as participant selection affordance 5086h associated with graphical representation 5034h, of participant Hanna Huckleberry. In some embodiments, detection of participant selection affordance 5020 allows for selection of a plurality of graphical representations 5034. FIG. 5W illustrates detection of user input 5126 on participant selection affordance 5086h.

FIG. 5X illustrates that participant selection affordance 5086h has changed in appearance, in response to selection by user input 5126 in FIG. 5W. FIG. 5X also illustrates detection of user input 5128 on participant selection affordance 50861.

FIG. 5Y illustrates that participant selection affordance 50861 has changed in appearance, in response to selection by user input 5128 in FIG. 5X. FIG. 5Y also illustrates detection of user input 5130 on participant selection affordance 5086k.

FIG. 5Z illustrates that participant selection affordance 5086k has changed in appearance, in response to selection by user input 5130 in FIG. 5Y. FIG. 5Z also illustrates detection of user input 5132 on completion affordance 5084. In this example, the three participants associated with the selected participant selection affordances, 5086h, 50861 and 5086k, have been selected to form a single group.

FIG. 5AA illustrates a navigation action menu 5054, displayed in response to detecting user input 5132 on completion affordance 5084, in FIG. 5Z, and formation of a new group of participants out of the participants associated with roster user interface 5022. Participant information 5058 illustrates a default name for the new group (e.g., New Group), and optionally additional information such as the names of the participants of the new group, and the number of participant devices. In some embodiments, a default name for the new group of participants can be changed. For example, as shown in FIG. 5AA, a user input 5134 is detected on a group rename affordance 5059.

FIG. 5BB illustrates an updated participant representation 5056 and participant information 5058, in response to a renaming action for the newly created group of participants from the participants associated with the roster of roster user interface 5022. FIG. 5BB also illustrates detection of user input 5136 on navigation action affordance 5062, corresponding to the “navigate” navigation action, which sends a set of instructions to three respective participant devices corresponding to the three members of the group to navigate to a particular location (e.g., a URL), or content item (e.g., a webpage, a chapter of an ebook), within a respective application (e.g., a web browser or e-reader application).

FIG. 5CC illustrates a listing of applications, such as web browsers, e-reader applications and mapping applications, for navigating a respective participant device to a particular location or content item within a respective application. In some embodiments, the listing of applications is displayed in response to detecting a “navigate” navigation action affordance. In the example shown in FIG. 5CC, a user input 5138 is detected on the entry corresponding to “Web Browser A”.

FIG. 5DD illustrates a location category sub-menu associated with the selected “Web Browser A” application, with one or more categories of locations or content items, such as bookmarks, open tabs within the respective application, historical items associated with the respective application and an option to manually type or select a location or content item. In some embodiments, the one or more categories of locations or content items are associated with an instance of the respective application residing on a supervisory device (e.g., device 100). For example, a category of content items includes bookmarks stored on an electronic device associated with a teacher, and/or associated with a teacher user profile. In FIG. 5DD, a user input 5140 is detected on the entry corresponding to bookmarks of “Web Browser A.”

FIG. 5EE illustrates a listing of bookmarks associated with the selected “Web Browser A” application, in response to detection of user input 5140 in FIG. 5DD. FIG. 5EE illustrates selection of a first entry 5057 within the listing, by detecting user input 5142. In some embodiments, entry 5057 is also referred to as a content display affordance.

FIG. 5FF illustrates display of a progress status page and at least one progress indicator 5061, corresponding to the status of sending instructions for performing one or more navigation actions, to the respective participant devices of the new group (e.g., Study Group 1). In some embodiments, a respective progress indicator 5061, corresponds to the execution of the instructions of a respective navigation action. For example, a progress indicator for one or more participant devices indicates completion upon receipt of confirmation that the one or more participant devices have successfully completed executing the navigation action corresponding to the sent instructions. In some embodiments, a progress indicator 5061 corresponds to progress of one participant device, and in some embodiments, a progress indicator 5061 corresponds to progress of more than one participant device.

FIG. 5GG illustrates navigation action menu 5054 ceasing to be displayed after all the respective devices of the new group (e.g., Study Group 1), have successfully received instructions from a supervisory device (e.g., device 100), and/or successfully performed one or more navigations actions associated with the instructions. In some embodiments, navigation action menu 5054 ceases to be displayed in response to detecting a user input outside of navigation action menu 5054, or after a predetermined duration of time. FIG. 5GG also illustrates detection of user input 5144 on group selection menu 5018.

FIG. 5HH illustrates expansion of group selection menu 5018 to show an entry 5088 for Study Group 1, and a group-creation affordance 5090 to create a new group. In some embodiments, creation of a new group of participants associated with the roster of roster user interface 5022, through one technique (e.g., as shown in FIGS. 5V to 5BB, using participant selection affordance 5020), updates information about the new group in other menus, listings or sets of groups (e.g., as shown in updated group selection menu 5018). FIG. 5HH also illustrates detection of user input 5146 on action affordance 5024.

FIG. 5II illustrates display of navigation action menu 5054, in response to detecting user input 5146 on action affordance 5024. In this example, the navigation actions of navigation action menu 5054 correspond to the entire group of participants associated with the roster of roster user interface 5022, as indicated by participant information 5058. In some embodiments, if all the graphical representations and/or other representations corresponding to respective participants are selected, or none are selected, when selection is detected of action affordance 5024, the navigation actions of navigation action menu 5054 correspond to all the participants associated with the roster of roster user interface 5022. In some embodiments, if one or more, but fewer than all the participants of the roster associated with roster user interface 5022 are selected before detecting selection of action affordance 5024, the navigation actions of navigation action menu 5054 correspond to the one or more, but fewer than all the participants of the roster.

FIGS. 5JJ-5SS illustrate examples of how some or all of the features of the first application described with respect to FIGS. 5A to 5II, interact with a second application distinct from the first application. FIG. 5JJ illustrates display of a content item 5092 (e.g., a web page about a Cell Nucleus), displayed in a second application (e.g., a web browser), distinct from a first, device-display management application. In some embodiments, instances of the first application and/or the second application are stored on a supervisory device (e.g., device 100). In some embodiments, instances of the first application and/or the second application are not stored on a supervisory device (e.g., device 100). FIG. 5JJ also illustrates detection of user input 5148 on item share affordance 5094.

FIG. 5KK illustrates display of a content share menu 5096, and an optional cancellation affordance 5200, in response to detecting user input 5148 on item share affordance 5094, in FIG. 5JJ. In some embodiments, content share menu 5096 includes one or more techniques for sharing content item 5092 of the second application, with one or more participant devices, or performing one or more other navigation actions on one or more participant devices. For example, content share menu 5096 includes one or more proximity-based sharing options 5202, 5204 and 5206, where each proximity-based sharing option is associated with the first application. For example, proximity-based sharing option 5202 provides an option for sharing content item 5092 with participant devices corresponding to participants (e.g., students) of the Biology class, in close proximity to a supervisory device (e.g., device 100).

In FIG. 5KK, proximity-based sharing option 5204 provides an option to share content item 5092 with participant devices associated with members of Study Group 1, a subset of members of the Biology group, created in the first application. In FIG. 5KK, proximity-based sharing option 5206 provides an option for sharing content item 5092 with participant devices associated with one or more science teachers, a group of participants completely distinct from any participants of sharing option 5202 or 5204.

FIG. 5KK also illustrates detection of user input 5150, on first application sharing affordance 5098, another sharing option for content item 5092.

FIG. 5LL illustrates an example of a content-sharing page 5208, displayed in response to detecting user input 5150 on first application sharing affordance 5098. In some embodiments, content-sharing page 5208 is displayed in response to detecting selection of another content-sharing user interface element, such as an affordance or user interface object corresponding to the first application. The example of a content-sharing page 5208 includes various affordances and user interface elements, including a title corresponding to the first application, a request-cancellation affordance, a content-posting affordance 5209, a text input area, a content item representation 5210 and a group selection affordance 5212. In some embodiments, content item representation 5210 includes a live representation (e.g., a live thumbnail) of content item 5092, and in some embodiments, content item representation 5210 includes a static representation of content of content item 5092. Group selection affordance 5212 currently indicates selection of a Biology group. In some embodiments, group selection affordance 5212 is a selection affordance as well as a selection indicator. In some embodiments, the first time content-sharing page 5208 is displayed, a default selected group is indicated by group selection affordance 5212. FIG. 5LL illustrates detection of user input 5152 on group selection affordance 5212.

FIG. 5MM illustrates display of a listing of context-determined group entries (e.g., group entries 5216, 5218 and 5220) within content-sharing page 5208, in response to detecting user input 5152 on group selection affordance 5212, in FIG. 5LL. In some embodiments, each group in the listing of group entries includes participants associated with the first application (e.g., a participant-device display management application). In some embodiments, the listing of context-determined groups includes an entry 5214 for creating a new group of participants, where a respective participant is associated with the first application (e.g., a student or teacher). In some embodiments, a context-determined group, such as group 5220, consists of a single participant. In some embodiments, a respective participant of a group is associated with a respective participant device (e.g., Alex Apple is associated with Device 34-455, as shown in FIG. 5I).

In some embodiments, context-determined groups correspond to groups of participants determined to be relevant to the sharing of content item 5092. For example, at a particular time of a particular day of the week, when the Biology class is in session, the listing of context-determined groups includes an entry for all the participant devices of participants (e.g., students) of the Biology class, and optionally additional entries for groups of participants from the full set of participants of the Biology class. In this same example, at another time on the same day of the week when the Chemistry class is in session, the listing of context-determined groups includes an entry for all the participant devices of students of the Chemistry class. In this example, a supervisory device (e.g., device 100) is associated with a user (e.g., a teacher), with a participatory relationship with both the Biology class and the Chemistry class. In some embodiments, an authorized user profile of the first application is associated with one or more rosters, and a context-determined group listed in content-sharing page 5208 corresponds to the one or more rosters.

In some embodiments, the listing includes all the groups of participants that an authorized user of the first application on a supervisory device (e.g., device 100), is associated with. For example, as described in the previous example, a teacher teaches a Biology class and a Chemistry class, therefore, in some embodiments, at any given time, the listing of groups includes an entry corresponding to the Biology class and an entry corresponding to the Chemistry class. In this same example, selection of the entry corresponding to the Chemistry class sends a set of instructions corresponding to a particular navigation action to the participant devices of participants of the Chemistry class, without sending those instructions to participant devices of participants of the Biology class.

In some embodiments, context is determined on the basis of proximity of participant devices to a supervisory device (e.g., device 100). For example, if more than a predefined threshold number of participant devices of a particular class that a teacher teaches are within close proximity to the teacher device, the listing of context-determined groups includes an entry corresponding to the particular class. In some embodiments, a group of participant devices is formed and listed in the listing of groups, based on proximity to a supervisory device (e.g., device 100). For example, a small group of students on a field trip, each having a respective participant device, are assigned a teaching assistant with a supervisory device that determines this group of students is a context-determined group for listing in content-sharing page 5208.

In some embodiments, context is determined on the basis of a particular status of the first application. For example, if a particular roster of participants was most recently represented in roster user interface 5022 (e.g., in FIG. 5II), context-determined groups in the listing of entries in content-sharing page 5208 include groups corresponding to that particular roster (e.g., groups having one or more students of the Biology class).

In some embodiments, a listing of context-determined groups in content-sharing page 5208 is updated in real-time. For example, if participant Alex Apple, represented by entry 5220, leaves the Biology classroom with his participant device, entry 5220 ceases to be displayed in the listing of context-determined groups in content-sharing page 5208. Similarly, in some embodiments, the listing of context-determined groups changes in real-time to account for newly created or determined relevant groups of participants.

FIG. 5MM also illustrates detection of user input 5154 on group 5218, namely Study Group 1, from the first application. As shown and described with respect to FIGS. 5W-5BB, Study Group 1 was created in the first application. In some embodiments, one or more content-sharing actions in the second application include obtaining group information, particularly context-determined group information, with respect to the first application (e.g., receiving and/or retrieving group information from the first application). In some embodiments, a respective group entry (e.g., entry 5216), includes a group graphical representation 5222 (e.g., a logo, a picture, a monogram or audio-visual element).

FIG. 5NN illustrates a change in group selection affordance 5212, from the Biology group, as shown in FIG. 5LL, to Study Group 1, in response to detecting selection of Study Group 1 by user input 5154 in FIG. 5MM. FIG. 5NN also illustrates an example entry of text to be included in a set of instructions sent to participant devices of Study Group 1, to open content item 5092 in a respective instance of the second application, at a respective participant device. FIG. 5NN also illustrates detection of user input 5156 on content-posting affordance 5209.

FIG. 5OO illustrates a response to detecting user input 5156 on content-posting affordance 5209, in FIG. 5NN. In some embodiments, in response to transmitting a set of instructions to perform one or more navigation actions at a respective participant device, one or more progress status entries are displayed in content-sharing page 5208, such as progress status entry 5224 corresponding to a set of instructions to a participant device associated with Hanna Huckleberry. In some embodiments, a respective progress status entry has any combination of text, graphics, audio-visual elements and a progress indicator. In some embodiments, a progress status entry indicates the aggregated progress of sending a set of instructions to a group of participant devices.

FIG. 5PP illustrates detection of a user input 5158 (e.g., a dragging or swiping motion in an upward direction), starting at an initial position 5158a (e.g., at or near a bottom edge of user interface 400) and ending at final position 5158b, while displaying content item 5092 in the second application.

FIG. 5QQ illustrates display of a control center panel 5226, displayed over content item 5092, in response to detecting user input 5158. In some embodiments, a control center panel 5226 includes another first application sharing affordance 5228, with some or all of the properties described above with respect to first application sharing affordance 5098, of content share menu 5096 (e.g., in FIG. 5KK). FIG. 5QQ also illustrates detection of user input 5160 within user interface 400, but outside of control center panel 5226.

FIG. 5RR illustrates an example of a response to detecting user input 5160 is to cease to display control center panel 5226. FIG. 5RR also illustrates detection of user input 5162 (e.g., a dragging or swiping gesture toward the center of the user interface 400), starting at an initial position 5162a (e.g., at or near a right or left edge of user interface 400), and ending at final position 5162b, while displaying content item 5092 in the second application.

FIG. 5SS illustrates display of a slide-over user interface 5229, in response to detecting user input 5162, in FIG. 5RR. In some embodiments, a slide-over user interface 5229 includes one or more user interface elements, such as a title 5230, group selection menu 5232, first application sharing affordances such as 5234 and 5236 and navigation action affordances such as 5238. In some embodiments, first application sharing affordances 5234 and 5236 have one or more characteristics of first application sharing affordance 5228 and/or first application sharing affordance 5098, as described above.

FIGS. 5TT-5VV illustrate a communication relationship between a supervisory device (e.g., device 100), and two participant devices (e.g., participant device 5300 and participant device 5400). FIG. 5TT illustrates examples of content displayed on a supervisory device (e.g., content item 5092 on device 100), a first participant device (e.g., content item 5240 on participant device 5300) and a second participant device (e.g., content item 5242 on participant device 5400). In some embodiments, a respective participant device has one or more characteristics of a supervisory device (e.g., device 300, FIG. 3, or portable multifunction device 100, FIG. 1A). FIG. 5TT also illustrates detection of user input 5164 on first application sharing affordance 5098, for sharing content item 5092 with all the participants (e.g., students) of the Biology class, as shown in group selection menu 5232.

FIG. 5UU illustrates transmission from the supervisory device (e.g., device 100) of a set of instructions 5244a to a first participant device (e.g., participant device 5300), and a set of instructions 5244b to a second participant device (e.g., participant device 5400). In this example, each transmitted set of instructions will cause display of content item 5092 on the display of a respective participant device receiving a set of these instructions, upon execution at the respective participant device. FIG. 5UU also illustrates an example of a response at the supervisory device (e.g., device 100), to transmitting the sets of instructions to the participant devices of a selected context-determined group, by displaying one or more progress status entries such as progress status entry 5246.

FIG. 5VV illustrates successful execution of display of content item 5092 on the displays of the first participant device (e.g., participant device 5300), and a second participant device (e.g., participant device 5400). In some embodiments, upon successful receipt of a set of instructions and/or successful execution of a navigation action associated with a received set of instructions, a success response 5248 is sent from a respective participant device (e.g., success response 5248a from participant device 5300) to a supervisory device (e.g., device 100). In some embodiments, a respective participant device was displaying information from a third application distinct from the first application and the second application before receiving the set of instructions to display a content item in the second application. In these embodiments, executing the received set of instructions from a supervisory device includes launching the second application. For example, as shown in FIG. 5UU, a participant using participant device 5300 was viewing a video using a video player application, distinct from the first application and the second application (e.g., a web browser). As shown in FIG. 5VV, participant device 5300 is displaying the content of content item 5092 within the same web browser application (or an instance thereof). FIG. 5VV also illustrates that in some embodiments, in response to receipt of one or more success responses 5248 from respective participant devices, one or more progress status entries such as progress status entry 5246 are modified to indicate successful transmission and/or execution of sent instructions.

FIG. 5WW illustrates an alternative appearance to roster user interface 5022, with some or all of the characteristics of roster user interface 5022, as described with respect to FIGS. 5B-5II. In some embodiments, display of a roster user interface 5022 includes display of a set of one or more navigation action affordances, such as navigation action affordances 5250, 5252, 5254, 5256, 5258 and 5260, where a respective, displayed navigation action affordance corresponds to a navigation action performed on a group of participant devices. For example, detecting selection of the “log out” navigation action affordance 5258, while all the graphical representations 5034 of the Biology class are displayed, corresponds to sending a set of instructions to each participant device associated with a respective graphical representation 5034 displayed in roster user interface 5022, to perform a logging out operation on the participant device.

In some embodiments, a respective, displayed navigation action affordance (e.g., “lock” navigation action affordance 5256) is a content display affordance. That is to say, that the respective, displayed navigation action affordance, when selected, causes transmission of instructions for allowing a supervisory device (e.g., device 100) to passively or actively manage the displays on a set of the participant devices. In some embodiments, detecting selection of a respective, displayed navigation action affordance causes one or more user interface elements to be displayed, at least one of which includes a content display affordance (e.g., a navigation action menu).

In some embodiments, display of roster user interface 5022 includes display of one or more groups of participant devices, represented by group affordances 5262, 5264, 5266 and 5268. In some embodiments, a respective group affordance is also an indicator (e.g., group affordance “All” 5262 indicates inclusion of sixteen participant devices). In some embodiments, a group of all participant devices (e.g., represented by group affordance 5262) is included in the one or more groups. In some embodiments, a group selection indicator 5270 indicates which group of the one or more groups is currently represented in roster user interface 5022. In some embodiments, visual elements of a respective group affordance (e.g., color, size, monograms or images) are determined on a random basis, and in some embodiments are determined on the basis of an algorithm.

In the example of FIG. 5WW, some groups are formed on the basis of open and/or active applications at respective participant devices. For example, group affordance 5264 corresponds to participant devices displaying and/or operating Web Browser A, while group affordance 5266 corresponds to participant devices displaying and/or operating an application called Science Game. In some embodiments, a respective participant device is displaying and/or operating more than one application (e.g., using a slide over, multitasking or window tile feature) and is associated with more than one group (e.g., with “Web Browser A” group affordance 5264 and “Science Game” group affordance 5266), in roster user interface 5022.

In some embodiments, a group is formed on another basis, such as the group represented by “Others” group affordance 5268 corresponding to participant devices not displaying and/or operating one of the applications of group affordances 5264 and 5266, and/or participant devices that are not displaying anything, such as the participant device corresponding to graphical representation 50341 (e.g., a participant device of Lucy Lychee). In some embodiments, a group is formed on the basis of participant device statuses. For example, a group is formed and a corresponding group affordance is displayed in roster user interface 5022, for all participant devices with a low battery life, such as the participant device corresponding to graphical representation 5034h (e.g., a participant device of Hanna Huckleberry). This example would provide a user of a supervisory device (e.g., device 100), a convenient way to view graphical representations corresponding to all participant devices with a low battery life, and replace those participant device assignments by selecting the “assign” navigation action affordance 5250.

In some embodiments, formation of a group is performed on the basis of one or more formation criteria, such as, but not limited to, the number of participant devices displaying a respective application, the number of participant devices with a status problem (e.g., low battery life), the number of connected/disconnected participant devices, the existence of any predefined or user-defined groups, the proximity of participant devices to the supervisory device and historical user preferences (e.g., frequent selection of five particular graphical representations 5034). For example, if every participant device corresponding to a respective graphical representation 5034 is connected and detected to have a full battery life, the “Others” group affordance 5268 ceases to be displayed in roster user interface 5022. In some embodiments, group formation and display of corresponding group affordances are performed on an on-going basis, as the one or more formation criteria change. For example, if a participant device is detected to have a low battery life, the “Others” group is formed to include that participant device, and a corresponding “Others” group affordance 5268 is displayed in roster user interface 5022. In some embodiments, text (e.g., a label) associated with a respective group affordance changes as one or more formation criteria change. For example, the label for “Science Game” group affordance 5266 changes from “Science Game (6)” to “Science Game (5)” to indicate that one less participant device is displaying and/or operating that corresponding application. In some embodiments, the group affordances displayed in roster user interface 5022 include one or more group affordances corresponding to user-defined and/or predefined groups (e.g., Study Group 1, as described above with respect to FIG. 5V-5OO).

In some embodiments, a respective graphical representation 5034 (e.g., graphical representation 5034a ) is displayed with one or more application badges 5272, corresponding to applications displayed and/or operated at the associated participant device. For example, the graphical representation 5034a corresponding to participant Alex Apple, includes application badge 5272 indicating that the participant device associated with Alex Apple is displaying and/or operating Web Browser A. In some embodiments, an application badge includes one or more of logos, images, clip art, text, colors, audio-visual elements and animations. In some embodiments, labels 5036 indicate device and/or application status at a respective participant device. For example, label 5036a associated with graphical representation 5034a indicates that the corresponding participant device is displaying and/or operating Web Browser A, while label 5036b indicates display and/or operation of Science Game at a participant device associated with graphical representation 5034b. Label 5036h illustrates an example of a device status indication (e.g., “Battery low”), as does label 5036I (e.g., “Display off'). In some embodiments, a particular device status for a respective participant device includes a modification to an associated label and graphical representation. For example, label 5036k indicates that the display of the associated participant device is being projected onto another, distinct display (e.g., AirPlay), and graphical representation 5034k is modified to visually distinguish this graphical representation 5034k within roster user interface 5022.

FIG. 5WW also illustrates detection of user input 5166 on group affordance 5264. FIG. 5XX illustrates display of a modification to the contents of roster user interface 5022, in response to detecting user input 5166 on group affordance 5264 in FIG. 5WW. FIG. 5XX illustrates display of nine graphical representations 5034, each corresponding to a respective participant device displaying and/or operating the Web Browser A application. The example group selection indicator 5270 has moved to indicate current selection of the “Web Browser A” group represented by group affordance 5264. FIG. 5XX also illustrates detection of user input 5168 on navigation action affordance 5250.

FIG. 5YY illustrates display of a device cart selection menu 5274, in response to detecting selection of navigation action affordance 5250. In some embodiments, participant devices are predefined to be part of a device collection (e.g., a “cart”). The example device cart selection menu 5274 illustrates display of one or more device collection affordances (e.g., device collection affordance 5276), for performing a bulk assignment or reassignment of participant devices to a currently selected group of participants and/or participant devices (e.g., the nine participant devices displaying Web Browser A). In this example, device collection affordance 5278 illustrates that in some embodiments, a collection with fewer available participant devices than the required number of unassigned participant devices for assignment, is displayed in a modified fashion (e.g., with a distinguished label). In some embodiments, detecting selection of a respective device collection affordance causes a set of instructions to be transmitted to one or more participant devices involved in the assignment operation (e.g., previously assigned participant devices with withdrawn assignments and newly assigned participant devices). In some embodiments, detecting selection of a respective device collection affordance causes display of one or more user interface objects (e.g., a device assignment menu) to facilitate assignment of participant devices in a selected device collection to participants of the selected group.

FIGS. 6A-6C are flow diagrams illustrating a method of displaying graphical representations of participants and device status information for participant devices corresponding to the participants in accordance with some embodiments. The method 600 is performed at an electronic device (e.g., device 300, FIG. 3, or portable multifunction device 100, FIG. 1A) with a display, one or more processors and a non-transitory memory. In some embodiments, the electronic device includes a touch-sensitive surface. In some embodiments, the display is a touch-screen display and the touch-sensitive surface is on or integrated with the display. In some embodiments, the display is separate from the touch-sensitive surface. Some operations in method 600 are, optionally, combined and/or the order of some operations is, optionally, changed.

As described below, the method 600 provides an intuitive way to display graphical representations of participants and device status information for participant devices corresponding to the participants. The method 600 reduces the cognitive burden on a user when displaying graphical representations of participants and device status information for corresponding participant devices, thereby creating a more efficient human-machine interface. For battery-operated electronic devices, enabling a user to display graphical representations of participants and device status information for corresponding participant devices faster and more efficiently conserves power and increases the time between battery charges.

The device receives (602), a request to display device status information for participant devices corresponding to participants in a group included on a roster, wherein a participant in the group is associated with a participant device. For example, in FIG. 5A, a user input 5100 is detected on label 5006b, which is one example of a received request to display device status information for participant devices corresponding to participants in a group included on a roster. In some embodiments, the group is a class (604), the electronic device is a device associated with a teacher of the class, and the participants are students in the class.

In some embodiments, prior to displaying, based on the roster, respective graphical representations that include respective device status indicators for the respective set of the participants in the group, the electronic device obtains (606) a roster of participants in a group, wherein a respective participant in the group is associated with a respective participant device. In some embodiments, a respective roster (e.g., a roster of students in a sixth grade Biology class), is associated with one or more authorized teacher user profiles (e.g., with a teacher user profile for a regular lecturer and a teacher user profile for a substitute teacher).

In some embodiments, the electronic device detects (608) entry of authentication information on the electronic device, and obtains the roster in response to detecting entry of authentication information on the electronic device. For example, a class roster is obtained from an administrative server after a teacher logs into the electronic device, or logs into an application associated with the roster, on the electronic device.

In some embodiments, the electronic device determines (610) satisfaction of one or more group-selection criteria, and obtains the roster based on the satisfaction of the one or more group-selection criteria. In some embodiments, the one or more group selection criteria include at least one of a time of day, a day of the week, a geographic location of the electronic device, and a user selection of a graphical representation of the group.

Additionally, in response to receiving the request to display the device status information for the participant devices, the electronic device displays (612), based on the roster, respective graphical representations that include respective device status indicators for a respective set of the participants in the group. In some embodiments, a graphical representation includes one or more of profile photos, logos, images, clip art, text, audio-visual elements and animations, and a device status indicator includes one or more of images, text, animations or modification to a graphical representation. For example, FIG. 5C illustrates display of graphical representations 5034, where each graphical representation 5034 corresponds to a respective student of the Biology class. Each graphical representation 5034 includes a device status indicator, portrayed as a visual modification of a respective graphical representation 5034. For example, in FIG. 5G, several graphical representations 5034 have a darkened background and bold outline, indicating an association with a connected device.

The electronic device also displays (614) a first graphical representation of a first participant in the group including a first device status indicator providing a status of a first participant device of the participant devices, associated with the first participant. The device also displays (616) a second graphical representation of a second participant in the group including a second device status indicator providing a status of a second participant device of the participant devices, associated with the second participant, that is different from the first device status indicator. For example, FIG. 5G illustrates display of a graphical representation 5034a for Alex Apple, and graphical representation 5034b, distinct from graphical representation 5034a, for Beth Banana. In this example, graphical representation 5034a has a darkened background, bold outline and text in label 5036a indicating connectivity with a device (e.g., three different device status indicators), while graphical representation 5034b displays none of these modifications, indicating lack of connectivity with a participant device.

In some embodiments, a respective device status indicator indicates (618) if a respective participant device is at least one of detected, undetected, assigned to one or more particular participants in the group and unassigned. In some embodiments, as described with respect to FIG. 5G, a respective device status indicator includes modifying the display of a corresponding graphical profile identifier (e.g., the device status indicator is a grayed out profile photo). In some embodiments, the device status indicator indicates information about the device assigned to a user (e.g., the name of the device, the battery status of the device, and/or the current application running on the device).

In some embodiments, the electronic device also detects (620) that the electronic device does not have a representative image of the first participant, and sends a request to obtain a representative image of the first participant, to a first participant device associated with the first participant. For example, in FIG. 5O-5R, a navigation action affordance 5074 associated with a request to obtain an updated graphical representation is selected, and corresponding instructions are sent to the participant device associated with Evan Endive. In some embodiments, in response to detecting that the electronic device does not have a representative image of the first participant, the electronic device obtains one or more graphical representations wherein a respective graphical representation corresponds to a respective participant (e.g., a profile photo, student-selected graphic, tag, nick name, proper name, generic monogram or logo, other human-centric characteristics). For example, FIG. 5R illustrates an updated graphical representation 5034e for the student, Evan Endive. In some embodiments, obtaining includes receiving the one or more graphical representations, and in some embodiments, obtaining includes retrieving the one or more graphical representations. In some embodiments, the electronic device is enabled to send a request for a replacement representative image of the first participant even where there is already a representative image of the first participant (e.g., where the existing image of the first participant is inappropriate, unclear, or an otherwise unacceptable representation of the participant).

In some embodiments, the device transmits (622), from the electronic device, a communication signal (e.g., an intermittent short-range communication signal such as a Bluetooth beacon), receives an acknowledgement message from a respective participant device of the participant devices, and determines a respective device status indicator for the respective participant device in response to receiving the acknowledgement message. In some embodiments, the communication signal uses one of Bluetooth, Wi-Fi, NFC, or cellular data.

In some embodiments, the device determines (624) an association between at least one respective participant with a respective participant device. In some embodiments, determining this association includes detecting that a respective participant has logged into a user account at a respective participant device. In some embodiments, determining this association includes manually linking or pairing devices and participant profiles. In some embodiments, determining this association includes retrieving a predetermined one-to-one pairing of participant devices and participants from local memory and/or from a source external to the electronic device.

In some embodiments, determining the association includes (626) at least one of receiving and retrieving participant-device pairing information from one or more participant devices. In some embodiments, participant devices are assigned on a preferential basis for those most recently used by particular participants, to reduce the need to import data (e.g., data associated with a particular participant may still be on the participant device).

In some embodiments, the electronic device displays (628), on the display, a device-assignment user interface with the first graphical representation of the first participant and a first device-representation of the first participant device (e.g., a device-assignment page that is entered from the main roster UI). The electronic device also detects selection of the first device-representation, and in response to detecting selection of the first device-representation, displays a device-selection menu with one or more unassigned participant devices not associated with participants of the group, detects selection of a first unassigned participant device, and associates the first unassigned participant device with the first participant.

In some embodiments, the electronic device displays (630), on the display, a device-assignment user interface with the first graphical representation of the first participant, a first device-representation of the first participant device within a first region of the device-assignment user interface, the second graphical representation of the second participant and a second device-representation of the second participant device within a second region of the device-assignment user interface. (e.g., a device-assignment page that is entered from the main roster UI) In some embodiments, the electronic device detects selection of the first device-representation, detects movement of the first device-representation, within the device-assignment user interface, and detects display of the first device-representation as at least partially overlapping the second device-representation. Additionally, in such embodiments, while detecting display of the first device-representation as at least partially overlapping the second device-representation, the electronic device ceases to detect selection of the first device-representation, and in response to ceasing to detect selection of the first device-representation, displays the first device-representation within the second region and displays the second device-representation within the first region.

In some embodiments, the electronic device detects (632) a request to replace display of the respective graphical representations for the respective set of participants in the group with display of graphical representations of the devices (e.g., selection of device-display affordance 5028, in FIG. 5R). In such embodiments, in response to detecting the request to replace display of the graphical representations of the respective set of participants in the group with display of the graphical representations of the devices, the device replaces display of the first graphical representation (e.g., graphical representation 5034a in FIG. 5R) with a graphical representation of content recently displayed on the first participant device (e.g., device-display representation 5080a), and replaces display of the second graphical representation with a graphical representation of content recently displayed on the second participant device. In some embodiments, the graphical representations of content recently displayed on the first or second participant devices, are static representations (e.g., a screenshot), and in some embodiments they are live representations of content currently being displayed.

It should be understood that the particular order in which the operations in FIGS. 6A-6C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 800) are also applicable in an analogous manner to method 600 described above with respect to FIGS. 6A-6C. For example, the graphical representations, user inputs, user interface objects, participants, participant devices, user interfaces, and device status indicators described above with reference to method 600 optionally have one or more of the characteristics of the graphical representations, user inputs, user interface objects, participants, participant devices, user interfaces, and device status indicators described herein with reference to other methods described herein (e.g., methods 700 and 800). For brevity, these details are not repeated here.

FIGS. 7A-7D illustrate a flow diagram of a method 700 of transmitting instructions to perform a navigation action at a participant device in accordance with some embodiments. The method 700 is performed at an electronic device (e.g., device 300, FIG. 3, or portable multifunction device 100, FIG. 1A) with a display, one or more processors, one or more input devices and a non-transitory memory. In some embodiments, the electronic device includes a touch-sensitive surface. In some embodiments, the display is a touch-screen display and the touch-sensitive surface is on or integrated with the display. In some embodiments, the display is separate from the touch-sensitive surface. Some operations in method 700 are, optionally, combined and/or the order of some operations is, optionally, changed.

As described below, the method 700 provides an intuitive way to transmit instructions to perform a navigation action at a participant device. The method 700 reduces the cognitive burden on a user when transmitting instructions to perform a navigation action at a participant device, thereby creating a more efficient human-machine interface. For battery-operated electronic devices, enabling a user to transmit instructions to perform a navigation action at a participant device faster and more efficiently conserves power and increases the time between battery charges.

While the electronic device is authorized to trigger performance of one or more navigation actions at participant devices that are associated with participants in a group, the electronic device displays (702) a user interface that includes a content display affordance for transmitting instructions for causing a content item to be displayed in a respective application on a set of the participant devices. For example, as shown in FIG. 5EE, roster user interface 5022 includes navigation action menu 5054, which includes entry 5057. In this example, entry 5057 is a content display affordance that when selected, causes a web page to be opened within a web browser application and displayed on the displays of three participant devices (e.g., those of Hanna, Kevin and Lucy). In some embodiments, the set of participant devices is one participant device, a plurality less than all the participant devices, or all the participant devices associated with participants of the group (e.g., participants of a particular roster). In some embodiments, the electronic device has a supervisory role over the set of participant devices that are assigned to participants in a group.

In some embodiments, the content item is (704) a web page and the respective application is a web browser. In some embodiments, the content item corresponds to a link associated with the web browser application (e.g., a URL or internal directory structure link). In some embodiments, the content item corresponds to (706) a bookmarked content item associated with the respective application associated with a teacher user profile (e.g., a URL or internal directory structure link in teacher device's Safari app). For example, as shown in FIG. 5DD and 5EE, the content item (e.g., a web page on fetal pig anatomy) corresponds to a bookmarked content item associated with the Web Browser A application on the supervisory device (e.g., device 100). In some embodiments, the content item corresponds to a historical element associated with the respective application (e.g., recent locations in a mapping app, or recent URLs visited). In some embodiments, the content item corresponds to (708) a bookmarked content item associated with the respective application on the first device.

In some embodiments, the content item has (710) one or more access privileges, the first device has been provided an access privilege to the content item and the participant devices have not been provided an access privilege to the content item. For example a teacher using a supervisory device (e.g., device 100) has content from a teacher copy of a digital textbook that students do not have access to read, write or modify from participant devices, however a teacher may allow students to view content from the teacher copy through one or more navigation actions.

While displaying the user interface, the electronic device receives (712), via the one or more input devices of the electronic device, a request to display a respective portion of a content item available through the respective application on the set of the participant devices. For example, in FIG. 5EE, user input 5142 corresponds to a request to display the web page of entry 5057 on the set of three participant devices corresponding to participants Hanna, Kevin and Lucy.

In some embodiments, each participant device (714) of the set of the participant devices displays a user interface for an application distinct from the respective application, while the electronic device receives, via the one or more input devices of the electronic device, a request to display the respective portion of the content item available through the respective application on the set of the participant devices. For example, the participant device associated with Hanna was displaying a user interface for a video player application, when user input 5142 is detected on entry 5057, as shown and described with respect to FIG. 5EE.

In some embodiments, the first navigation action (716), when executed, will cause the respective participant device to open the respective application and display the respective portion of the content item in the respective application. In some embodiments, receiving the request includes (718) detecting selection of the content display affordance.

In response to receiving the request, the device transmits (720) to the set of the participant devices, instructions which, when received by a respective participant device will trigger a first navigation action on the respective participant device that when executed will cause the respective participant device to display the respective portion of the content item in the respective application.

In some embodiments, the instructions trigger (722) execution of one or more navigation actions at a respective participant device. For example, navigation actions include passive and active activities, such as passively viewing a display of a participant device, or actively changing the content being displayed on one or more participant device displays. In some embodiments, a navigation action includes locking and/or unlocking one or more participant device displays. In some embodiments, one navigation action includes displaying, on the display of the electronic device (e.g., device 100), information displayed on a display of a respective participant device. In some embodiments, one navigation action includes projecting information displayed on a display of a respective participant device, to a display of a projection device.

In some embodiments, the instructions trigger (724) opening the respective application before displaying the respective portion of the content item in the respective application. In some embodiments, the instructions do not trigger an option to allow the respective participant device to cancel execution of the first navigation action. For example, the instructions trigger opening the respective application (e.g., Web Browser A) without providing an option to cancel opening of the respective application and/or displaying the content item. In some embodiments, execution of the first navigation action occurs after a time delay and a displayed warning on the participant device.

In some embodiments, the instructions trigger (726) display of a user interface on one or more of the participant devices that includes an option to allow the respective participant device to cancel execution of the first navigation action. In some embodiments, if the option to cancel execution of the first navigation option is not selected within a predetermined time period, the first navigation action is performed.

In some embodiments, the instructions instruct (728) the respective participant device to prevent closing the respective application. For example, a display of a respective participant device is locked to the application. In some embodiments, the instructions instruct the respective participant device to allow closing the respective application after successful execution of the first navigation action.

In some embodiments, the electronic device displays (730) in the user interface, a respective graphical representation for a respective participant associated with a respective participant device, and an action affordance. In such embodiments, the electronic device determines a number of selected graphical representations in the user interface, and detects selection of the action affordance. In accordance with a first determination that no graphical representations are selected when the action affordance is selected, the electronic device determines that the set of participant devices includes participant devices corresponding to all users in the group. In accordance with a second determination that one or more graphical representations are selected when the action affordance is selected, the electronic device determines that the set of participant devices includes the participant devices corresponding to the selected graphical representations. For example, in FIG. 5HH, user input 5146 is detected on action affordance 5024. FIG. 5HH illustrates that none of the sixteen graphical representations of participants are selected when user input 5146 is detected. FIG. 5II illustrates display of navigation action menu 5054, with participant information 5058 indicating that the set of participant devices includes participant devices corresponding to all users in the Biology class.

In some embodiments, after transmitting the instructions to the set of the participant devices, the electronic device displays (732) an action progress indicator providing progress status of at least one of the respective participant devices of the set of the participant devices, in executing the instructions of the first navigation action. For example, as shown in FIG. 5FF, navigation action menu 5054 includes a progress status page and a progress indicator 5061, corresponding to the status of sending instructions for performing a navigation action, to the respective participant devices of Study Group 1. In some embodiments, the action progress indicator indicates (734) an aggregate status of the set of participant devices (e.g., an indication all devices have executed the instructions, or 8 of 10 devices have executed the instructions).

In some embodiments, the device detects (736) that one or more participant devices in the set of participant devices have failed to execute the instructions of the first navigation action, and in response to detecting that the one or more participant devices in the set of participant devices have failed to execute the instructions of the first navigation action, displays an option to provide information about the one or more participant devices that have failed to execute the instructions of the first navigation action. For example, the electronic device displays screen shots of the displays of the one or more participant devices that have failed to execute the instructions, displays an option to allow remote control, displays an option to play a sound at the one or more participant devices, and/or displays information about the participants to whom the one or more participant devices are assigned.

In some embodiments, the electronic device is authorized (738), in order to allow the electronic device to trigger performance of one or more navigation actions at the participant devices. In some embodiments, authorizing the electronic device is performed before displaying the user interface. For example, a supervisory device is authorized by receiving authorization information from another computing device (e.g., an administrative server), by installing an application on the device (e.g., the first application), and/or by detecting a successful log-in attempt by one or more user profiles.

In some embodiments, the electronic device displays (740) a group selection user interface, wherein the group selection user interface includes one or more groups associated with a registered user of the first device, the electronic device detects selection of a particular group, and in response to detecting selection of the particular group, and while the electronic device is authorized to trigger performance of one or more navigation actions at participant devices that are associated with participants in the group, the electronic device displays the user interface including the content display affordance for transmitting instructions for causing content to be displayed in a respective application on a set of the participant devices. For example, FIG. 5A displays a class selection user interface 5010, including six classes that a particular teacher of a supervisory device (e.g., device 100), is associated with. FIG. 5A also illustrates detection of user input 5100 on label 5006b associated with Biology class 5002c, and FIGS. 5B-5G illustrate display of the roster user interface 5022 corresponding to the Biology class, in response to detecting user input 5100.

In some embodiments, the electronic device displays (742) in the user interface, a respective graphical representation for a respective participant associated with a respective participant device, the electronic device receives a first user input corresponding to selection of one or more graphical representations corresponding to the set of the participant devices, and the electronic device displays a participant-device navigation menu in the user interface, that includes the content display affordance. For example, FIGS. 5V-5AA illustrate display of various graphical representations 5034, user selection of three graphical representations (e.g., corresponding to Hanna, Kevin and Lucy), and display of navigation action menu 5054. In this example, navigation action menu 5054 includes a plurality of navigation action affordances. In some embodiments, a navigation action affordance is a content display affordance.

It should be understood that the particular order in which the operations in FIGS. 7A-7D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600 and 800) are also applicable in an analogous manner to method 600 described above with respect to FIGS. 7A-7D. For example, the graphical representations, user inputs, user interface objects, participants, participant devices, user interfaces, and device status indicators described above with reference to method 700 optionally have one or more of the characteristics of the graphical representations, user inputs, user interface objects, participants, participant devices, user interfaces, and device status indicators described herein with reference to other methods described herein (e.g., methods 600 and 800). For brevity, these details are not repeated here.

FIGS. 8A-8C illustrate a flow diagram of a method 800 of enabling sharing of a content item in one application, with participants associated with another application in accordance with some embodiments. The method 800 is performed at an electronic device (e.g., device 300, FIG. 3, or portable multifunction device 100, FIG. 1A) with a display, one or more processors and a non-transitory memory. In some embodiments, the electronic device includes a touch-sensitive surface. In some embodiments, the display is a touch-screen display and the touch-sensitive surface is on or integrated with the display. In some embodiments, the display is separate from the touch-sensitive surface. Some operations in method 800 are, optionally, combined and/or the order of some operations is, optionally, changed.

As described below, the method 800 provides an intuitive way to enable sharing of a content item in one application, with participants associated with another application. The method 800 reduces the cognitive burden on a user when enabling sharing of a content item in one application, with participants associated with another application, thereby creating a more efficient human-machine interface. For battery-operated electronic devices, enabling a user to share a content item in one application, with participants associated with another application faster and more efficiently conserves power and increases the time between battery charges.

While the electronic device is associated with a user profile (e.g., a teacher profile) authenticated to participate with a first group of participants and a second group of participants through a first application (e.g., authentication through the application shown in FIG. 5A-5II), the electronic device displays (802) on the display, a user interface of a second application (e.g., a Safari window) that includes a content item. For example, as shown in FIG. 5JJ, content item 5092 is displayed in a user interface of a web browsing application.

In some embodiments, at least one of the first group and the second group are predefined (804) in the first application. For example, FIG. 5MM illustrates a listing of group entries, including entries 5216 and 5218 which are predefined in the first application (e.g., the application shown and described with respect to FIGS. 5A-5II). In some embodiments, one of the first group, the second group or a third group, distinct from the first and second groups, is not predefined in the first application (e.g., is determined through the second application).

In some embodiments, the members of the first group and the members of the second group are determined (806) based on proximity of the members to the electronic device. For example, devices assigned to students who are presently attending a class receive a shared content item, while devices for enrolled but presently absent students do not receive the shared content item.

In some embodiments, the first application and second application are members of a set of applications supporting a shared set of application privileges. For example, both applications support a variety of content-sharing menus and user interface objects. In another example, FIG. 5JJ illustrates an item share affordance 5094, which is only available to applications which are members of a set of applications supporting a shared set of application privileges.

In some embodiments, the electronic device has supervisory control (808) over a display of a respective participant device. For example, the electronic device has privileges/permissions to passively/actively supervise a participant device display by viewing it or pushing content to it. In some embodiments, this control is temporary, and in some embodiments this control is time-limited and/or proximity-limited. For example, a supervisory device of a Biology teacher can only have supervisory control over a participant device of a particular Biology student while the Biology class is in session, and/or the participant device is detected to be within 20 meters of the supervisory device. In some embodiments, the electronic device is one of a plurality of electronic devices with supervisory control over the display of the respective participant device (e.g., two supervisory devices, one associated with a Biology teacher and the other associated with a Chemistry teacher, can transmit instructions to perform a navigation action at a particular student's participant device, when the respective teacher has a class in session). In some embodiments, the electronic device is one of a plurality of electronic devices with supervisory control over the display of the respective participant device within the same context (e.g., two supervisory devices, each associated with a science teacher, can transmit instructions to perform a navigation action at a particular student's participant device, when any science class is in session).

While displaying the user interface of the second application that includes the content item, the electronic device receives (810) a request to initiate a content sharing operation with at least one of the first group and the second group facilitated by the first application. For example, FIG. 5KK illustrates detection of user input 5150 on first application sharing affordance 5098, which corresponds to a request to share content item 5092 with one or more groups of participants associated with the first application (e.g., the application shown and described with respect to FIGS. 5A-5II).

In some embodiments, receiving a request to initiate a content sharing operation with at least one of the first group and the second group facilitated by the first application includes detecting (812) selection of a graphical user interface object that describes the respective participants of a respective group (e.g., “students” or “teachers” or “Bio 101 Class” or “Study Group 1,”). For example, FIG. 5MM illustrates display of group entry 5218 describing Study Group 1, and entry 5220 describing the single participant, Alex Apple. FIG. 5MM also illustrates detection of user input 5154, selecting entry 5218 (e.g., Study Group 1).

In response to receiving the request to initiate the content sharing operation, the electronic displays (814) a plurality of sharing options for sharing the content item of the second application. In some embodiments, displaying (816) the plurality of sharing options for sharing the content item of the second application includes invoking display of a system menu that includes the plurality of sharing options. For example, FIG. 5PP and 5QQ illustrate display of a control center panel 5226, in response to detecting user input 5158 (e.g., an upward swipe). In some embodiments, displaying (818) the plurality of sharing options for sharing the content item of the second application includes invoking display of a user interface for the first application. For example, FIGS. 5RR and 5SS illustrate the invocation of a slide-over user interface 5229 corresponding to the first application. In some embodiments, the user interface for the first application is concurrently displayed with the user interface for the second application (e.g., side-by-side, or partially overlapping).

In accordance with a determination that the electronic device is in a first context when the request to initiate the content sharing operation is received, the electronic device displays (820) in the plurality of sharing options a first sharing option that, when selected will initiate sharing of the content item with participants in the first group without initiating sharing of the content item with the second group. For example, FIG. 5MM illustrates display of a listing of group entries, where each group entry corresponds to the Biology class currently in session. In this example, the first group is Biology, represented by entry 5216, and the second group corresponds to a roster of students in a Chemistry class (not shown in content-sharing page 5208). In this example, the Biology class is currently in session, so the supervisory device (e.g., device 100) determines that it is in a context corresponding to a current session of the Biology class and accordingly displays entries in content-sharing page 5208 corresponding to the Biology class. In this example, initiating sharing of content item 5092 with the Biology class will not initiate sharing of content item 5092 with the Chemistry class.

In accordance with a determination that the electronic device is in a second context when the request to initiate the content sharing operation is received, the electronic device displays (822) in the plurality of sharing options a second sharing option that, when selected will initiate sharing of the content item with participants in the second group without initiating sharing of the content item with the first group. In some embodiments, the first sharing option is displayed without the second sharing option. In some embodiments, the second sharing option is displayed without the first sharing option (e.g., the first sharing option corresponds to a class that is scheduled at a different time from a class that corresponds to the second sharing option). In some embodiments, the first sharing option and the second sharing option are displayed concurrently when the first context and the second context occur concurrently. For example, when the electronic device is in a class currently in session, an affordance for sharing with the whole class is displayed concurrently with an affordance for sharing with a particular subset of the class such as a study group or lab group within the class.

In some embodiments, the electronic device determines (824) at least one of the first context and the second context for the electronic device based on one or more temporal and environmental elements. In some embodiments, the temporal and environmental elements include a time of day, a day of a week, and a location of the electronic device (e.g., factors that determine that a particular class is in session).

In some embodiments, the electronic device determines (828) at least one of the first context and the second context for the electronic device based on proximity of one or more participant devices to the electronic device. (e.g., detecting that at least some of the students of Biology 101 are nearby, but that the combination of detected students does not exist in the roster for Chemistry). In some embodiments, the participants are determined based on a roster for a class and information about which class is in session.

In some embodiments, the electronic device detects (830) selection of the first sharing option associated with the first group, and in response to detecting selection of the first sharing option, sends a display command to one or more participant devices corresponding to participants of the first group.

In some embodiments, the display command includes (832) an instruction to display, on a display of a respective participant device, the content item of the user interface of the second application. In some embodiments, the display command includes (834) an instruction to lock the display of the respective participant device (e.g., display the content and lock the student device screen).

In some embodiments, in response to receiving the request to initiate the content sharing operation, the electronic device displays (836) a plurality of sharing options for sharing the content item of the second application. In accordance with a determination that the electronic device is in a first context when the request to initiate the content sharing operation is received, the device displays in the plurality of sharing options a third sharing option that, when selected will initiate sharing of the content with a subset of the participants in the first group (e.g., a study group or individually selected participants, as shown in FIG. 5MM).

In some embodiments, the electronic device detects (838) selection of the first sharing option or the second sharing option, and in response to detecting selection of the first sharing option or the second sharing option, the electronic device displays a content share overlay, wherein the content share overlay includes one or more of a user selection menu, a representation of the content item (e.g. a live or static thumbnail) and a text input area. For example, FIG. 5NN illustrates display of a content-sharing page 5208 (e.g., content share overlay), with a group selection affordance 5212 (e.g., user selection menu), representation 5210 and a text input area.

In some embodiments, the device displays on the display, a user interface of a second application (e.g., a Safari window) that includes a content item, while the electronic device is associated with a user profile (e.g., teacher profile) authenticated to participate with at least a first group of participants associated with a first group of participant devices through a first application (e.g., authentication through the application shown and described with respect to FIGS. 5A-5II). In some embodiments, while displaying the user interface of the second application that includes the content item, the electronic device receives a request to initiate a content sharing operation. In response to receiving the request to initiate the content sharing operation, the electronic device displays a set of sharing options for sharing the content item of the second application. In accordance with a determination that the electronic device has a temporary display-control relationship with a set (e.g., one or more) of participant devices of at least the first group of participant devices when the request to initiate the content sharing operation is received, the electronic device displays in the plurality of sharing options a first sharing option that, when selected will initiate sharing of the content item with the set of participant devices.

It should be understood that the particular order in which the operations in FIGS. 8A-8C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600 and 700) are also applicable in an analogous manner to method 600 described above with respect to FIGS. 8A-8C. For example, the graphical representations, user inputs, user interface objects, participants, participant devices, user interfaces, and device status indicators described above with reference to method 800 optionally have one or more of the characteristics of the graphical representations, user inputs, user interface objects, participants, participant devices, user interfaces, and device status indicators described herein with reference to other methods described herein (e.g., methods 600 and 700). For brevity, these details are not repeated here.

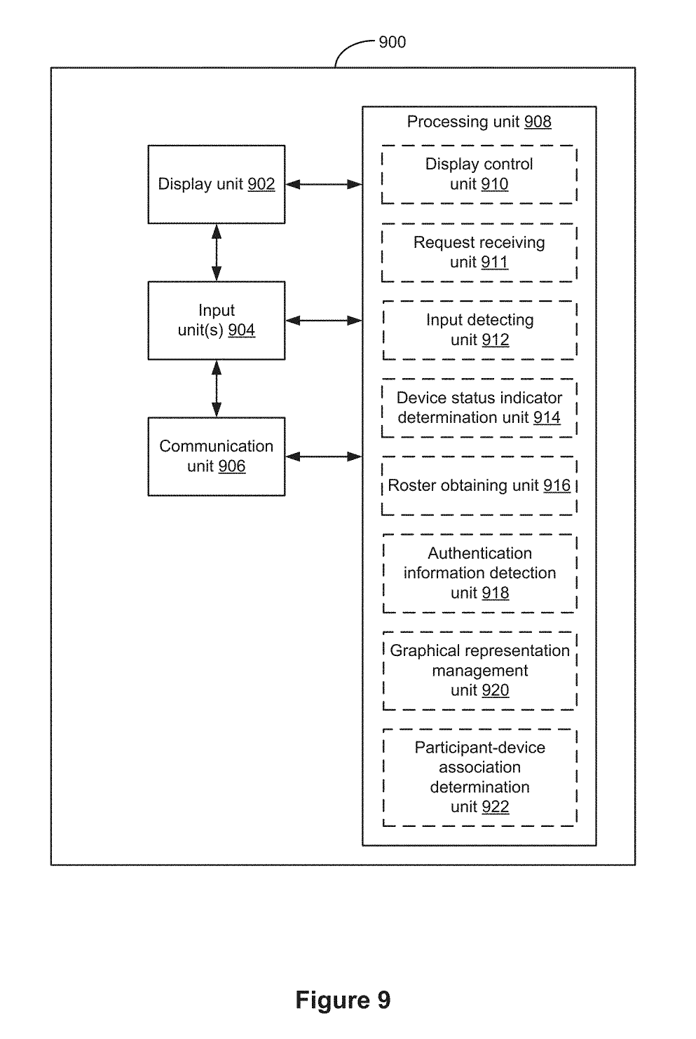

In accordance with some embodiments, FIG. 9 shows a functional block diagram of an electronic device 900 configured in accordance with the principles of the various described embodiments. The functional blocks of the device are, optionally, implemented by hardware, software, firmware, or a combination thereof to carry out the principles of the various described embodiments. It is understood by persons of skill in the art that the functional blocks described in FIG. 9 are, optionally, combined or separated into sub-blocks to implement the principles of the various described embodiments. Therefore, the description herein optionally supports any possible combination or separation or further definition of the functional blocks described herein.

As shown in FIG. 9, an electronic device 900 includes a display unit 902 configured to display a user interface and/or user interface objects, optionally one or more input units 904 configured to receive user inputs, a communication unit 906 configured to transmit and/or receive communications; and a processing unit 908 coupled with the display unit 902, the one or more optional input units 904 and the communication unit 906. In some embodiments, the processing unit 908 includes: a display control unit 910, a request receiving unit 911, an input detecting unit 912, a device status indicator determination unit 914, a roster obtaining unit 916, an authentication information detection unit 918, a graphical representation management unit 920, and a participant-device association determination unit 922.

In some embodiments, the processing unit 908 is configured to receive (e.g., with the request receiving unit 911) a request to display device status information for participant devices corresponding to participants in a group included on a roster, wherein a participant in the group is associated with a participant device. In response to receiving the request to display the device status information for the participant devices, the processing unit 908 is configured to provide for display (e.g., with the display control unit 910), based on the roster, respective graphical representations that include respective device status indicators for a respective set of the participants in the group. The processing unit 908 is also configured to concurrently provide for display (e.g., with the display control unit 910), a first graphical representation of a first participant in the group including a first device status indicator providing a status of a first participant device of the participant devices, associated with the first participant, and a second graphical representation of a second participant in the group including a second device status indicator providing a status of a second participant device of the participant devices, associated with the second participant, that is different from the first device status indicator.

In some embodiments, a respective device status indicator indicates if a respective participant device is at least one of detected, undetected, assigned to one or more particular participants in the group and unassigned. In some embodiments, the processing unit 908 is further configured to, prior to providing for display, based on the roster, respective graphical representations that include respective device status indicators for the respective set of the participants in the group, obtain a roster of participants in a group (e.g., with the roster obtaining unit 916), wherein a respective participant in the group is associated with a respective participant device.

In some embodiments, the processing unit 908 is further configured to detect entry of authentication information on the electronic device (e.g., with the authentication information detection unit 918), and obtain the roster (e.g., with the roster obtaining unit 916) in response to detecting entry of authentication information on the electronic device.

In some embodiments, the processing unit 908 is further configured to determine satisfaction of one or more group-selection criteria (e.g., with roster obtaining unit 916), and obtain the roster (e.g., with roster obtaining unit 916) based on the satisfaction of the one or more group-selection criteria, wherein the one or more group-selection criteria include at least one of a time of day, a day of the week, a geographic location of the electronic device, and a user selection of a graphical representation of the group. In some embodiments, the group is a class, the electronic device is a device associated with a teacher of the class, and the participants are students in the class.

In some embodiments, the processing unit 908 is further configured to detect that the electronic device does not have a representative image of the first participant (e.g., with graphical representation management unit 920) and send a request to obtain a representative image of the first participant, to a first participant device associated with the first participant (e.g., with graphical representation management unit 920).

In some embodiments, the processing unit 908 is further configured to transmit, from the electronic device, a communication signal (e.g., with device status indicator determination unit 914), receive an acknowledgement message from a respective participant device of the participant devices (e.g., with device status indicator determination unit 914), and determine a respective device status indicator for the respective participant device in response to receiving the acknowledgement message (e.g., with device status indicator determination unit 914).

In some embodiments, the processing unit 908 is further configured to determine an association between at least one respective participant with a respective participant device (e.g., with participant-device association determination unit 920). In some embodiments, determining the association includes at least one of receiving and retrieving participant-device pairing information from one or more participant devices.

In some embodiments, the processing unit 908 is further configured to provide for display, on the display, a device-assignment user interface with the first graphical representation of the first participant and a first device-representation of the first participant device (e.g., with display control unit 910). In such embodiments, the processing unit 908 is further configured to detect selection of the first device-representation, and in response to detecting selection of the first device-representation (e.g., with input detection unit 912), provide for display a device-selection menu with one or more unassigned participant devices not associated with participants of the group (e.g., with display control unit 910). In such embodiments, the processing unit 908 is configured to detect selection of a first unassigned participant device (e.g., with input detecting unit 912), and associate the first unassigned participant device with the first participant (e.g., with participant-device association determination unit 922).

In some embodiments, the processing unit 908 is further configured to provide for display (e.g., with display control unit 910), a device-assignment user interface with the first graphical representation of the first participant, a first device-representation of the first participant device within a first region of the device-assignment user interface, the second graphical representation of the second participant and a second device-representation of the second participant device within a second region of the device-assignment user interface. In such embodiments, the processing unit 908 is further configured to detect selection of the first device-representation (e.g., with input detecting unit 912), detect movement of the first device-representation, within the device-assignment user interface (e.g., with input detecting unit 912), detect display of the first device-representation as at least partially overlapping the second device-representation (e.g., with input detecting unit 912), and while detecting display of the first device-representation as at least partially overlapping the second device-representation, cease to detect selection of the first device-representation (e.g., with input detecting unit 912), and in response to ceasing to detect selection of the first device-representation, provide for display the first device-representation within the second region and provide for display the second device-representation within the first region (e.g., with display control unit 910).

In some embodiments, the processing unit 908 is further configured to detect a request to replace display of the respective graphical representations for the respective set of participants in the group with display of graphical representations of the devices (e.g., with request receiving unit 911), and in response to detecting the request to replace display of the graphical representations of the respective set of participants in the group with display of the graphical representations of the devices, replace display of the first graphical representation with a graphical representation of content recently displayed on the first participant device (e.g., with display control unit 910), and replace display of the second graphical representation with a graphical representation of content recently displayed on the second participant device (e.g., with display control unit 910).

The operations in the information processing methods described above are, optionally implemented by running one or more functional modules in information processing apparatus such as general purpose processors (e.g., as described above with respect to FIGS. 1A and 3) or application specific chips.

The operations described above with reference to FIGS. 6A-6C are, optionally, implemented by components depicted in FIGS. 1A-1B or FIG. 9. For example, request-receiving operation 602, detection operation 606 and display operation 612 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

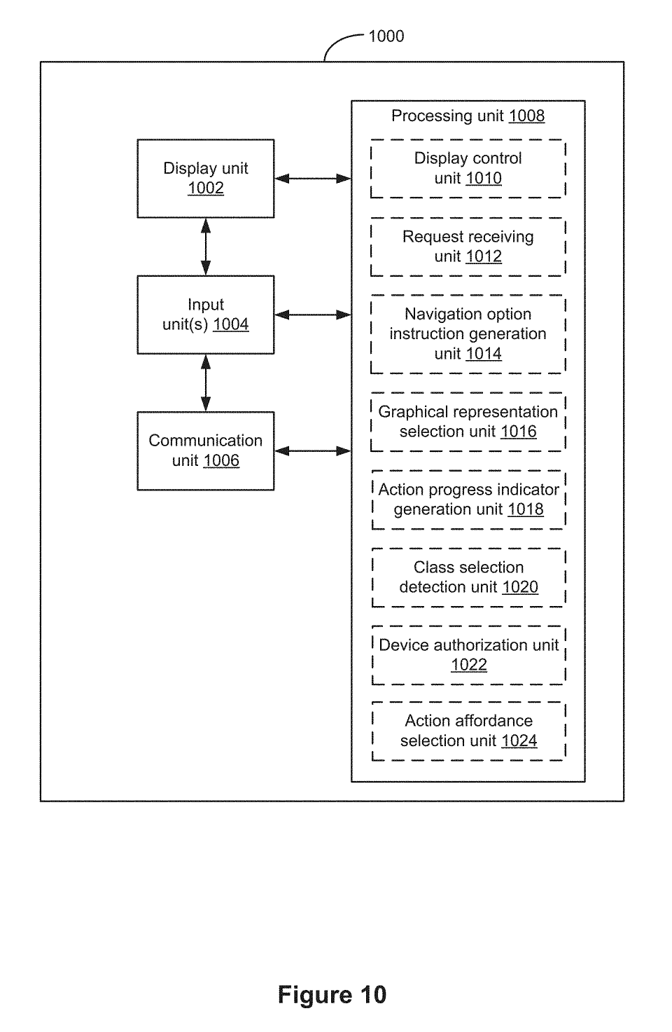

In accordance with some embodiments, FIG. 10 shows a functional block diagram of an electronic device 1000 configured in accordance with the principles of the various described embodiments. The functional blocks of the device are, optionally, implemented by hardware, software, firmware, or a combination thereof to carry out the principles of the various described embodiments. It is understood by persons of skill in the art that the functional blocks described in FIG. 10 are, optionally, combined or separated into sub-blocks to implement the principles of the various described embodiments. Therefore, the description herein optionally supports any possible combination or separation or further definition of the functional blocks described herein.

As shown in FIG. 10, an electronic device 1000 includes a display unit 1002 configured to display a user interface and/or user interface objects, one or more input units 1004 configured to receive user inputs, a communication unit 1006 configured to transmit and/or receive communications; and a processing unit 1008 coupled with the display unit 1002, the one or more input units 1004 and the communication unit 1006. In some embodiments, the processing unit 1008 includes: a display control unit 1010, a request receiving unit 1012, a navigation option instruction generation unit 1014, a graphical representation selection unit 1016, an action progress indicator generation unit 1018, a class selection detection unit 1020, and a device authorization unit 1022.

In some embodiments, while the electronic device is authorized to trigger performance of one or more navigation actions at participant devices that are associated with participants in a group, the processing unit 1008 is configured to provide for display a user interface (e.g., with display control unit 1010) that includes a content display affordance for transmitting instructions for causing content to be displayed in a respective application on a set of the participant devices. In some embodiments, while providing for display the user interface, the processing unit 1008 is further configured to receive, via the one or more input units of the electronic device (e.g., with request receiving unit 1012), a request to display a respective portion of a content item available through the respective application on the set of the participant devices, and in response to receiving the request, the processing unit 1008 is further configured to transmit to the set of the participant devices (e.g., with navigation option instruction generation unit 1014), instructions which, when received by a respective participant device will trigger a first navigation action on the respective participant device that when executed will cause the respective participant device to display the respective portion of the content item in the respective application.

In some embodiments, each participant device of the set of the participant devices displays a user interface for an application distinct from the respective application, while the processing unit is configured to receive, via the one or more input units of the electronic device, a request to display the respective portion of the content item available through the respective application on the set of the participant devices.

In some embodiments, the first navigation action, when executed, will cause the respective participant device to open the respective application and display the respective portion of the content item in the respective application.

In some embodiments, after transmitting the instructions to the set of the participant devices, the processing unit 1008 is further configured to provide for display (e.g., with display control unit 1010), an action progress indicator providing progress status (e.g., with action progress indicator generation unit 1018) of at least one of the respective participant devices of the set of the participant devices, in executing the instructions of the first navigation action. In some embodiments, the action progress indicator indicates an aggregate status of the set of participant devices.

In some embodiments, the processing unit is further configured to detect that one or more participant devices in the set of participant devices have failed to execute the instructions of the first navigation action (e.g., with action progress indicator generation unit 1018) and in response to detecting that the one or more participant devices in the set of participant devices have failed to execute the instructions of the first navigation action, provide for display an option to provide information about the one or more participant devices that have failed to execute the instructions of the first navigation action (e.g., with display control unit 1010).

In some embodiments, the processing unit 1008 is further configured to authorize the electronic device, in order to allow the electronic device to trigger performance of one or more navigation actions at the participant devices (e.g., with device authorization unit 1022). In some embodiments, receiving the request includes detecting selection of the content display affordance (e.g., with request receiving unit 1012).

In some embodiments, the instructions trigger execution of one or more navigation actions at a respective participant device. In some embodiments, the instructions trigger opening the respective application before displaying the respective portion of the content item in the respective application. In some embodiments, the instructions trigger display of a user interface on one or more of the participant devices that includes an option to allow the respective participant device to cancel execution of the first navigation action. In some embodiments, the instructions instruct the respective participant device to prevent closing the respective application.

In some embodiments, the content item is a web page and the respective application is a web browser. In some embodiments, the content item corresponds to a bookmarked content item associated with the respective application associated with teacher user profile. In some embodiments, the content item corresponds to a bookmarked content item associated with the respective application on the electronic device. In some embodiments, the content item has one or more access privileges, the electronic device has been provided an access privilege to the content item and the participant devices have not been provided an access privilege to the content item.

In some embodiments, the processing unit 1008 is further configured to provide for display a class selection user interface, wherein the class selection user interface includes one or more classes associated with a registered user of the electronic device (e.g., with a display control unit 1010). In such embodiments, the processing unit 1008 is further configured to detect selection of a particular class (e.g., with class selection detection unit 1020) and in response to detecting selection of the particular class, and while the electronic device is authorized to trigger performance of one or more navigation actions at participant devices that are associated with participants in the group, provide for display (e.g., with the display control unit 1010) the user interface including the content display affordance for transmitting instructions for causing a content item to be displayed in a respective application on a set of the participant devices.

In some embodiments, the processing unit 1008 is further configured to provide for display in the user interface (e.g., with display control unit 1010), a respective graphical representation for a respective participant associated with a respective participant device, receive a first user input corresponding to selection of one or more graphical representations corresponding to the set of the participant devices (e.g., with graphical representation selection unit 1016), and provide for display (e.g., with a display control unit 1010) a participant-device navigation menu in the user interface, that includes the content display affordance.

In some embodiments, the processing unit 1008 is further configured to provide for display (e.g., with display control unit 1010) in the user interface, a respective graphical representation for a respective participant associated with a respective participant device, and an action affordance, and determine a number of selected graphical representations in the user interface (e.g., with graphical representation selection unit 1016). In such embodiments, the processing unit 1008 is further configured to detect selection of the action affordance (e.g., with action affordance selection unit 1024). In such embodiments, in accordance with a first determination that no graphical representations are selected when the action affordance is selected, the processing unit 1008 is further configured to determine that the set of participant devices includes participant devices corresponding to all users in the class, and in accordance with a second determination that one or more graphical representations are selected when the action affordance is selected, determine that the set of participant devices includes the participant devices corresponding to the selected graphical representations (e.g., with the action affordance selection unit 1024).

The operations in the information processing methods described above are, optionally implemented by running one or more functional modules in information processing apparatus such as general purpose processors (e.g., as described above with respect to FIGS. 1A and 3) or application specific chips.

The operations described above with reference to FIGS. 7A-7D are, optionally, implemented by components depicted in FIGS. 1A-1B or FIG. 10. For example, display operation 702, request-receiving operation 712 and transmission operation 720 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

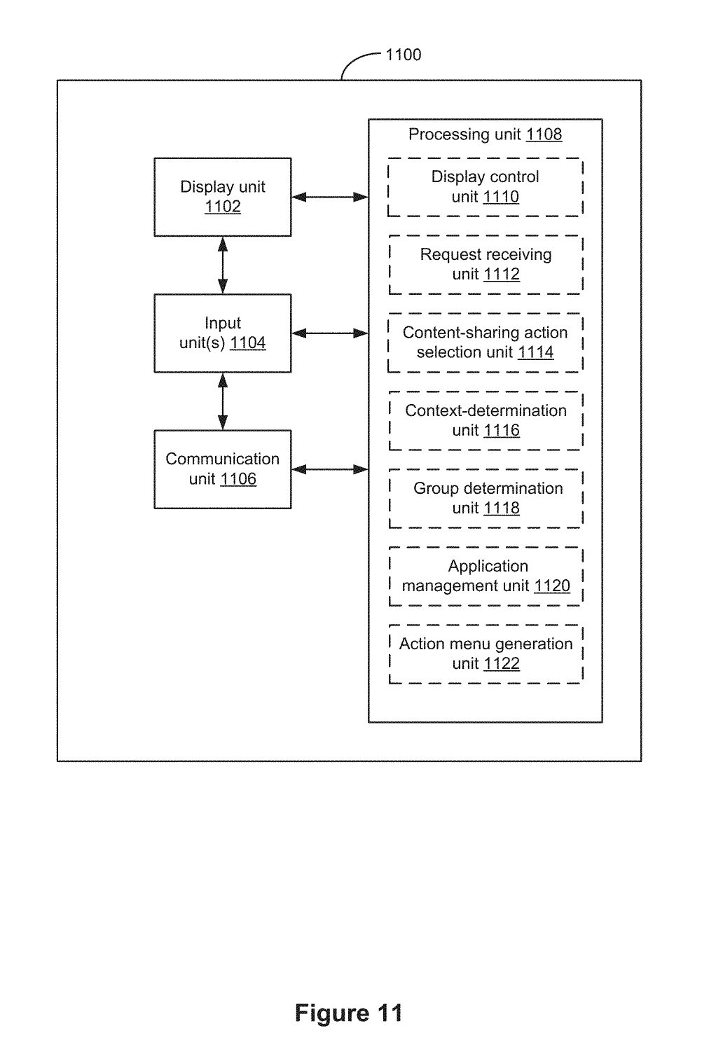

In accordance with some embodiments, FIG. 11 shows a functional block diagram of an electronic device 1100 configured in accordance with the principles of the various described embodiments. The functional blocks of the device are, optionally, implemented by hardware, software, firmware, or a combination thereof to carry out the principles of the various described embodiments. It is understood by persons of skill in the art that the functional blocks described in FIG. 11 are, optionally, combined or separated into sub-blocks to implement the principles of the various described embodiments. Therefore, the description herein optionally supports any possible combination or separation or further definition of the functional blocks described herein.

As shown in FIG. 11, an electronic device 1100 includes a display unit 1102 configured to display a user interface and/or user interface objects, optionally one or more input units 1104 configured to receive user inputs, a communication unit 1106 configured to transmit and/or receive communications; and a processing unit 1108 coupled with the display unit 1102, the optional one or more input units 1104 and the communication unit 1106. In some embodiments, the processing unit 1108 includes: a display control unit 1110, a request receiving unit 1112, a content-sharing action selection unit 1114, a context-determination unit 1116, a group determination unit 1118, an application management unit 1120, and an action menu generation unit 1122.

In some embodiments, while the electronic device is authorized to trigger performance of one or more navigation actions at participant devices that are associated with participants in a group, the processing unit 1108 is configured to provide for display (e.g., with display control unit 1110), a user interface of a second application that includes a content item, while the electronic device is associated with a user profile authenticated to participate with a first group of participants and a second group of participants through a first application, and while providing for display the user interface of the second application that includes the content item, receive a request (e.g., with request receiving unit 1112) to initiate a content sharing operation with at least one of the first group and the second group facilitated by the first application. In such embodiments, in response to receiving the request to initiate the content sharing operation, the processing unit 1108 is further configured to provide for display a plurality of sharing options for sharing the content item of the second application, wherein, in accordance with a determination that the electronic device is in a first context when the request to initiate the content sharing operation is received, provide for display (e.g., with display control unit 1110) in the plurality of sharing options a first sharing option that, when selected will initiate sharing of the content item with participants in the first group without initiating sharing of the content item with the second group, and in accordance with a determination that the electronic device is in a second context when the request to initiate the content sharing operation is received, provide for display (e.g., with display control unit 1110) in the plurality of sharing options a second sharing option that, when selected will initiate sharing of the content item with participants in the second group without initiating sharing of the content item with the first group.

In some embodiments, the processing unit 1108 is further configured to determine at least one of the first context and the second context for the electronic device based on one or more temporal and environmental elements (e.g., with context-determination unit 1116). In some embodiments, the temporal and environmental elements include a time of day, a day of a week, and a location of the electronic device.

In some embodiments, the processing unit 1108 is further configured to determine at least one of the first context and the second context for the electronic device based on proximity of one or more participant devices to the electronic device (e.g., with context-determination unit 1116). In some embodiments, at least one of the first group and the second group are predefined in the first application. In some embodiments, the members of the first group and the members of the second group are determined based on proximity of the members to the electronic device.

In some embodiments, the processing unit 1108 is further configured to detect selection of the first sharing option associated with the first group (e.g., with content-sharing action selection unit 1114), and in response to detecting selection of the first sharing option, send a display command (e.g., with display control unit 1110) to one or more participant devices corresponding to participants of the first group.

In some embodiments, the display command includes an instruction to display, on a display of a respective participant device, the content item of the user interface of the second application. In some embodiments, the display command includes an instruction to lock the display of the respective participant device. In some embodiments, the electronic device has supervisory control over a display of a respective participant device.

In some embodiments, the processing unit 1108 is further configured to, in response to receiving the request to initiate the content sharing operation, provide for display (e.g., with display control unit 1110) a plurality of sharing options for sharing the content item of the second application, and in accordance with a determination that the electronic device is in a first context when the request to initiate the content sharing operation is received, provide for display (e.g., with display control unit 1110) in the plurality of sharing options a third sharing option that, when selected will initiate sharing of the content with a subset of the participants in the first group.

In some embodiments, the processing unit 1108 is configured to provide for display (e.g., with display control unit 1110) the plurality of sharing options for sharing the content item of the second application including being configured to invoke display of a system menu that includes the plurality of sharing options. In some embodiments, the processing unit 1108 is configured to provide for display (e.g., with display control unit 1110) the plurality of sharing options for sharing the content item of the second application including being configured to invoke display of a user interface for the first application.

In some embodiments, the processing unit 1108 is configured to receive a request (e.g., with request receiving unit 1112) to initiate a content sharing operation with at least one of the first group and the second group facilitated by the first application including being configured to detect selection of a graphical user interface object that describes the respective participants of a respective group.

In some embodiments, the processing unit 1108 is configured to detect selection of the first sharing option or the second sharing option (e.g., with content-sharing action selection unit 1114), and in response to detecting selection of the first sharing option or the second sharing option provide for display a content share overlay (e.g., with display control unit 1110), wherein the content share overlay includes one or more of a user selection menu, a representation of the content item and a text input area.

The operations in the information processing methods described above are, optionally implemented by running one or more functional modules in information processing apparatus such as general purpose processors (e.g., as described above with respect to FIGS. 1A and 3) or application specific chips.

The operations described above with reference to FIGS. 8A-8C are, optionally, implemented by components depicted in FIGS. 1A-1B or FIG. 11. For example, displaying operation 802, receiving operation 804, and determining operation 824 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device with a display, one or more input devices, one or more processors and non-transitory memory:
while the electronic device is authorized to trigger performance of one or more navigation actions at participant devices that are associated with participants in a group, displaying a user interface that includes a content display affordance for transmitting instructions for causing a content item to be displayed in a respective application on a set of the participant devices;
while displaying the user interface, receiving, via the one or more input devices of the electronic device, a request to display a respective portion of a content item available through the respective application on the set of the participant devices; and
in response to receiving the request, transmitting to the set of the participant devices, instructions which, when received by a respective participant device will trigger a first navigation action on the respective participant device that when executed will cause the respective participant device to display the respective portion of the content item in the respective application.

2. The method of claim 1, wherein each participant device of the set of the participant devices displays a user interface for an application distinct from the respective application, while the electronic device receives, via the one or more input devices of the electronic device, a request to display the respective portion of the content item available through the respective application on the set of the participant devices.

3. The method of claim 2, wherein the first navigation action, when executed, will cause the respective participant device to open the respective application and display the respective portion of the content item in the respective application.

4. The method of claim 1, further comprising:
after transmitting the instructions to the set of the participant devices, displaying an action progress indicator providing progress status of at least one of the respective participant devices of the set of the participant devices, in executing the instructions of the first navigation action.

5. The method of claim 4, wherein the action progress indicator indicates an aggregate status of the set of participant devices.

6. The method of claim 4, further comprising:
detecting that one or more participant devices in the set of participant devices have failed to execute the instructions of the first navigation action; and
in response to detecting that the one or more participant devices in the set of participant devices have failed to execute the instructions of the first navigation action, displaying an option to provide information about the one or more participant devices that have failed to execute the instructions of the first navigation action.

7. The method of claim 1, further comprising:
authorizing the electronic device, in order to allow the electronic device to trigger performance of one or more navigation actions at the participant devices.

8. The method of claim 1, wherein receiving the request includes detecting selection of the content display affordance.

9. The method of claim 1, wherein the instructions trigger execution of one or more navigation actions at a respective participant device.

10. The method of claim 1, wherein the instructions trigger opening the respective application before displaying the respective portion of the content item in the respective application.

11. The method of claim 1, wherein the instructions trigger display of a user interface on one or more of the participant devices that includes an option to allow the respective participant device to cancel execution of the first navigation action.

12. The method of claim 1, wherein the instructions instruct the respective participant device to prevent closing the respective application.

13. The method of claim 1, wherein the content item is a web page and the respective application is a web browser.

14. The method of claim 1, wherein the content item corresponds to a bookmarked content item associated with the respective application associated with a teacher user profile.

15. The method of claim 1, wherein the content item corresponds to a bookmarked content item associated with the respective application on the electronic device.

16. The method of claim 1, wherein the content item has one or more access privileges, the electronic device has been provided an access privilege to the content item and the participant devices have not been provided an access privilege to the content item.

17. The method of claim 1, further comprising:
displaying a class selection user interface, wherein the class selection user interface includes one or more classes associated with a registered user of the electronic device;
detecting selection of a particular class; and
in response to detecting selection of the particular class, and while the electronic device is authorized to trigger performance of one or more navigation actions at participant devices that are associated with participants in the group, displaying the user interface including the content display affordance for transmitting instructions for causing a content item to be displayed in a respective application on a set of the participant devices.

18. The method of claim 1, further comprising:
displaying in the user interface, a respective graphical representation for a respective participant associated with a respective participant device;
receiving a first user input corresponding to selection of one or more graphical representations corresponding to the set of the participant devices; and
displaying a participant-device navigation menu in the user interface, that includes the content display affordance.

19. The method of claim 1, further comprising:
displaying in the user interface, a respective graphical representation for a respective participant associated with a respective participant device, and an action affordance;
determining a number of selected graphical representations in the user interface;
detecting selection of the action affordance;
in accordance with a first determination that no graphical representations are selected when the action affordance is selected, determining that the set of participant devices includes participant devices corresponding to all users in the class; and
in accordance with a second determination that one or more graphical representations are selected when the action affordance is selected, determining that the set of participant devices includes the participant devices corresponding to the selected graphical representations.

20. A computer readable storage medium storing one or more programs, the one or more programs comprising instructions, which when executed by an electronic device with a display and one or more input devices, cause the device to:
while the electronic device is authorized to trigger performance of one or more navigation actions at participant devices that are associated with participants in a group, display a user interface that includes a content display affordance for transmitting instructions for causing a content item to be displayed in a respective application on a set of the participant devices;
while displaying the user interface, receive, via the one or more input devices of the electronic device, a request to display a respective portion of a content item available through the respective application on the set of the participant devices; and
in response to receiving the request, transmit to the set of the participant devices, instructions which, when received by a respective participant device will trigger a first navigation action on the respective participant device that when executed will cause the respective participant device to display the respective portion of the content item in the respective application.

21. An electronic device comprising:
a display;
one or more input devices;
means for displaying a user interface that includes a content display affordance for transmitting instructions for causing a content item to be displayed in a respective application on a set of the participant devices, while the electronic device is authorized to trigger performance of one or more navigation actions at participant devices that are associated with participants in a group;
means for receiving, via the one or more input devices of the electronic device, a request to display a respective portion of a content item available through the respective application on the set of the participant devices, while displaying the user interface; and
means, responsive to receiving the request, for transmitting to the set of the participant devices, instructions which, when received by a respective participant device will trigger a first navigation action on the respective participant device that when executed will cause the respective participant device to display the respective portion of the content item in the respective application.

22. An electronic device comprising:
a display unit configured to display one or more user interface objects;
one or more input devices configured to receive user inputs; and
a processing unit coupled with the display unit, and the one or more input devices, the processing unit configured to:
while the electronic device is authorized to trigger performance of one or more navigation actions at participant devices that are associated with participants in a group, provide for display a user interface that includes a content display affordance for transmitting instructions for causing a content item to be displayed in a respective application on a set of the participant devices;
while providing for display the user interface, receive, via the one or more input devices of the electronic device, a request to display a respective portion of a content item available through the respective application on the set of the participant devices; and
in response to receiving the request, transmit to the set of the participant devices, instructions which, when received by a respective participant device will trigger a first navigation action on the respective participant device that when executed will cause the respective participant device to display the respective portion of the content item in the respective application.

23. The electronic device of claim 22, wherein each participant device of the set of the participant devices displays a user interface for an application distinct from the respective application, while the processing unit is configured to receive, via the one or more input devices of the electronic device, a request to display the respective portion of the content item available through the respective application on the set of the participant devices.

24. The electronic device of claim 23, wherein the first navigation action, when executed, will cause the respective participant device to open the respective application and display the respective portion of the content item in the respective application.

25. The electronic device of claim 22, wherein the processing unit is further configured to:
authorize the electronic device, in order to allow the electronic device to trigger performance of one or more navigation actions at the participant devices.

26. The electronic device of claim 22, wherein receiving the request includes detecting selection of the content display affordance.

27. The electronic device of claim 22, wherein the instructions trigger display of a user interface on one or more of the participant devices that includes an option to allow the respective participant device to cancel execution of the first navigation action.

28. The electronic device of claim 22, wherein the instructions instruct the respective participant device to prevent closing the respective application.

29. The electronic device of claim 22, wherein the content item corresponds to a bookmarked content item associated with the respective application associated with a teacher user profile.

30. The electronic device of claim 22, wherein the content item has one or more access privileges, the electronic device has been provided an access privilege to the content item and the participant devices have not been provided an access privilege to the content item.
